(19) United States
(12) Patent Application Publication
(10) Pub. No.: US 2007/0180490 A1
(43) Pub. Date: Aug. 2, 2007

(54) System and method for policy management

(76) Inventors: Silvio J. Renzi, Gaithersburg, MD (US); Mauricio G. Renzi, Bethesda, MD (US); Adrian H. Prezioso, Bethesda, MD (US); Jeffrey L. Caro, Dover, NH (US); Dennis A. Van Dusen, Chevy Chase, MD (US)

Correspondence Address: Cooley Godward LLP;ATTN: Patent Group, One Freedom Square, Reston Town Center, 11951 Freedom Drive, Reston, VA, 20190-5656, US

(21) Appl. No.: 10/882,153

(22) Filed: Jul. 1, 2004

(30) Foreign Application Priority Data
May 20, 2004 (US) PCT/US04/16084

(51) Int. Cl. H04L 9/00

(52) U.S. Cl. 726/1

(57) ABSTRACT

The invention provides a system and method for providing policy-based protection services. As a new threat is understood, one or more protection techniques are considered for protecting the asset, the organization assigns responsibilities to carry out or protect the asset, and a policy is constructed. After the policy is developed a plan is put into action to protect the asset, and a policy implementer is developed and/or purchased, distributed, configured, and managed. Finally, the policy, its enforcement, and its effectiveness, are reviewed to determine any changes needed, and new requirements are discovered, closing the lifecycle.

### CROSS-REFERENCE TO RELATED APPLICATIONS

This application is a Continuation-In-Part (CIP) of international application No. PCT/US2004/016084, filed May 20, 2004, which claims the benefit of U.S. Provisional Application No. 60/471,763, filed May 20, 2003. PCT/US2004/016084 is hereby incorporated by reference in its entirety.

### FIELD OF INVENTION

The invention relates generally to the field of operations management. More specifically, but not by way of limitation, the invention relates to a system and method for policy-based management of protection services.

### BACKGROUND

Protection services may include, for instance, asset management, configuration management, network management, security, quality of service, service level management, and duty of care management and other policy-based or contract-based enforcement structures. Known systems and method for management of protection services have many disadvantages, however.

For example, known methods provide inadequate business models for procuring and installing protection services. In one respect, known methods for procuring protection services provide little or no traceability between higher level-policy objectives and enforcement components of protection services. Thus, it falls to the buyer of such services to ensure that the purchased components are both necessary and sufficient to meet higher-level policy objectives.

Further, known systems for providing protection services are lacking. For instance, they may be configured to distribute protection components, or collect events (data related to the protection services), but not both. Moreover, where systems are configured to collect events, they may only be configured to report the collected events, without capability to timely process the collected events or react to them, or to assist in enforcement.

In addition, known systems and methods fail to take into account the full lifecycle of protection services or to coordinate the information needed for process improvement. For example, known systems do not sufficiently provide a cost-effective way to update protection based on changing threats or vulnerabilities.

What is needed a more robust system and method for managing protection services, including the business methods, functional architecture, and lifecycle management processes associated with such management.

### SUMMARY OF THE INVENTION

The invention provides a system and method for providing policy-based protection services. As a new threat is understood, one or more protection techniques are considered for protecting the asset, the organization assigns responsibilities to carry out or protect the asset, and a policy is constructed. After the policy is developed a plan is put into action to protect the asset, and a policy implementer is developed and/or purchased, distributed, configured, and managed. Finally, the policy, its enforcement, and its effectiveness, are reviewed to determine any changes needed, and new requirements are discovered, closing the lifecycle.

An embodiment of the invention provides a method for implementing policy objectives, including: developing a policy implementer; registering at least one system component; and selling the policy implementer, the policy implementer enabling the policy objectives to be instantiated in the network.

An embodiment of the invention provides a method for rapid development of a policy implementer, including: planning an implementation of a policy; describing the implementation; coding the implementation into a policy implementer; and certifying the policy implementer.

An embodiment of the invention provides a method for coding a policy implementer, including: registering as a user on a developer Web site; coding the policy implementer; and accessing a code submission tool from the developer Web site, the code submission tool enabling the user to submit the code to a repository.

An embodiment of the invention provides a system configured to instantiate policy objectives in a network, the system including a framework, the framework configured to distribute a policy implementer and to collect data from the network.

An embodiment of the invention provides a method for managing a policy management lifecycle, including: storing information content; implementing a policy associated with the content; and distributing the content.

An embodiment of the invention provides a system for providing protection services, the system including a framework, wherein the framework is configured to perform at least one of analysis of data, collection of data, distribution, administration, and display of data based on a policy implementer construct.

An embodiment of the invention provides a method for developing policy-based protection services, including: describing a policy requirement; defining a generic policy implementer to address the policy requirement; representing at least one of an asset, network, system, procedure, and a component with a named abstraction; defining a required scope of protection for the named abstraction target; and developing a specific policy implementer to collect a metric regarding the named abstraction.

An embodiment of the invention provides a method for providing policy-based protection services to a customer, including: providing a framework; and providing at least one policy implementer, the at least one policy implementer associated with security policy, the framework configured to distribute and manage the at least one policy implementer.

An embodiment of the invention provides a method for sharing policy-based analysis, including: identifying at least one of a threat, a vulnerability, and a deficiency in a policy to produce a policy requirement; analyzing the policy requirement to produce at least one of a new policy element and revised policy element; and sharing the at least one of a new policy element and revised policy element.

An embodiment of the invention provides a system configured to share policy-based analysis, including: a policy library configured to contain policy descriptions and policy element descriptions; and a policy implementer catalog linked to the policy library, the policy implementer catalog containing protections for the policy elements described in the policy library.

An embodiment of the invention provides a method for managing a collaborative development process, including: providing a developer exchange Website; registering a developer on the exchange Website; and providing a policy implementer submission tool via the exchange Website.

An embodiment of the invention provides a developer exchange Website, including: a registration module configured to register at least one of a policy implementer planner, a policy implementer describer, a policy implementer developer, and a policy implementer certifier; a policy implementer submission module; and a workflow module configured to manage the development of a policy implementer.

An embodiment of the invention provides a method for protection procurement, including: viewing a list of policy implementers for a selected policy element; and selecting for purchase at least one policy implementer from the list of policy implementers.

An embodiment of the invention provides a system configured to manage a procurement process, including: a procurement module configured to present a list of policy implementers to a buyer, the procurement module further configured to receive from a buyer a selection of a policy implementer from the list of policy implementers; a distribution module coupled to the procurement module, the distribution module configured to install the selected policy implementer.

An embodiment of the invention provides a method for maintaining protection components, including: providing an incentive program for developing a new policy implementer; providing a rapid development process to produce the new policy implementer; and distributing the new policy implementer to a target system.

An embodiment of the invention provides a method for managing an assurance process, comprising: for each component of a target system, automatically preparing a report of status, a level of protection, and a currency metric by policy element and by policy in response to a user request.

An embodiment of the invention provides a method for improving a policy, including: providing a community-based incentive program for improving the policy; providing a policy description system providing a policy element description system; providing a policy implementer requirement description system; and providing community access to the policy description system and the policy element description system, and the policy implementer requirement description system.

An embodiment of the invention provides a system configured to provide policy-based protection services to a customer, including: a distribution engine; an event manager coupled to the distribution engine; and an interface to a customer system, the interface coupled to the distribution engine and the event manager, the distribution engine configured to distribute a framework component and a policy implementer component, the interface configured to collect data from the customer system, the event manager configured to store and aggregate the collected data.

An embodiment of the invention provides a method for implementing policy-based objectives in a target system, including: distributing a first policy implementer in the target system; and later distributing a second policy implementer in the target system.

An embodiment of the invention provides a method for alerting in a protection system, including: receiving data indicating a breach of policy from at least one of a first target system, a first protection system, and a third-party; and reporting the breach of policy according to a predetermined role-based responsibility associated with at least one of the first target system, a second target system, the first protection system, and a second protection system.

An embodiment of the invention provides a method for alerting in a protection system, including: receiving results from one of a certification review, an audit review, and an accreditation review; and assigning the results according to a predetermined role-based responsibility associated with at least one of the target system, the protection system, and a developer community.

An embodiment of the invention provides a method for policy-based certification of a system, comprising: registering a certifier as a user on a Web site; certifying a policy implementer to produce a certification report; and accessing a certification submission tool from the Web site, the certification submission tool enabling the user to submit the certification report to a repository.

An embodiment of the invention provides a method for providing policy-based protection, comprising: receiving data; categorizing the data to associate the data with one of a predetermined plurality of categories; responding to the data based on the one of the predetermined plurality of categories, the data including at least one of event data and policy breach data; and reporting based on the categorizing.

The features and advantages of the invention will become apparent from the following drawings and detailed description.

### BRIEF DESCRIPTION OF THE DRAWINGS

Embodiments of the invention are described with reference to the following drawings, wherein:

FIG. 1 is a block diagram of a functional architecture, according to an embodiment of the invention;

FIG. 2 is a block diagram of the client system components and the external IT sources shown in FIG. 1, according to an embodiment of the invention;

FIG. 3 is a block diagram of the distribution components shown in FIG. 1, according to an embodiment of the invention;

FIG. 4 is a block diagram of the event management components shown in FIG. 1, according to an embodiment of the invention.

FIG. 5 is a block diagram of the management console servers shown in FIG. 1, according to an embodiment of the invention;

FIG. 6 is a block diagram of the primary administrative console shown in FIG. 1, according to an embodiment of the invention;

FIG. 7 is a block diagram of the subordinate administrative console shown in FIG. 1, according to an embodiment of the invention;

FIG. 8 is a block diagram of controllers, which are distributed throughout the functional architecture shown in FIG. 1, according to an embodiment of the invention;

FIG. 9 is a block diagram of the policy implementer development kit shown in FIG. 1, according to an embodiment of the invention;

FIG. 10 is a block diagram of the agent developer kit shown in FIG. 1, according to an embodiment of the invention;

FIG. 11 is a block diagram of the plug-in developer kit shown in FIG. 1, according to an embodiment of the invention;

FIG. 12 is a process flow chart for an e-commerce transaction from the perspective of a customer, according to an embodiment of the invention;

FIG. 13 is a process flow chart for supplying enterprise services from the perspective of a service provider, according to an embodiment of the invention.

FIG. 14 is a process flow chart for the product development process shown in FIG. 13, according to an embodiment of the invention;

FIG. 15 is a process flow chart for the warehousing process shown in FIG. 13, according to an embodiment of the invention;

FIG. 16A is a process flow chart for the user registration process according to an embodiment of the invention;

FIG. 16B is a process flow chart for the device registration process according to an embodiment of the invention;

FIG. 17 is a process flow chart for the e-commerce transaction shown in FIG. 13, according to an embodiment of the invention;

FIG. 18 is a process flow chart for the framework component distribution process shown in FIG. 17, according to an embodiment of the invention;

FIG. 19 is a process flow chart for the e-commerce transaction shown in FIG. 13, according to an embodiment of the invention;

FIGS. 20A-H are illustrations of a table mapping policy choices to policy implementers, according to an embodiment of the invention;

FIG. 21 is a process flow chart for the distribution process shown in FIG. 19, according to an embodiment of the invention;

FIG. 22 is a block diagram of the distribution process shown in FIG. 19, according to an embodiment of the invention.

FIG. 23 is a messaging diagram for agent start-up, according to an embodiment of the invention;

FIG. 24 is a process flow chart showing a distribution hierarchy, according to an embodiment of the invention;

FIG. 25 is a process flow chart for the operations process shown in FIG. 13, according to an embodiment of the invention;

FIG. 26 is a block diagram showing functional components of event management, according to an embodiment of the invention.

FIG. 27 is a block diagram showing functional components of event management according to an embodiment of the invention;

FIG. 28 is a block diagram showing functional components of event management according to an embodiment of the invention;

FIG. 29 is a process flow chart showing an event management hierarchy, according to an embodiment of the invention;

FIG. 30 is a process flow chart showing command propagation, according to an embodiment of the invention;

FIGS. 31-33 are process flow charts for the operations process shown in FIG. 13, according to an embodiment of the invention;

FIGS. 34-36 are flow diagrams of a policy-based management lifecycle process, according to an embodiment of the invention;

FIG. 37 is a block diagram of the data structure associated with policy implementation, according to an embodiment of the invention;

FIG. 38 is a block diagram of the data structure associated with the E-Commerce component, according to an embodiment of the invention;

FIG. 39 is a block diagram of the data structure associated with the Deployment component, according to an embodiment of the invention;

FIG. 40 is a block diagram of the data structure associated with the Breaches and Methods component, according to an embodiment of the invention;

FIG. 41 is a block diagram of the data structure associated with the Event infrastructure, according to an embodiment of the invention;

FIG. 42 is a block diagram of the data structure associated with the METRICS, according to an embodiment of the invention;

FIG. 43 is a block diagram of the data structure associated with the Inventory infrastructure, according to an embodiment of the invention;

FIG. 44 is a block diagram of the data structure associated with the Security Oriented infrastructure, according to an embodiment of the invention;

FIG. 45 is an illustration of business models, according to an embodiment of the invention;

FIG. 46 is a process flow chart of policy flow-down, according to an embodiment of the invention;

FIG. 47 is a process flow chart of an analysis process, according to an embodiment of the invention; and

FIG. 48 is a process flow chart illustrating an example of the process in FIG. 47, according to an embodiment of the invention.

### DETAILED DESCRIPTION

The invention is directed to an improved information security lifecycle, a functional architecture (also described hereinafter as a framework), and improved methods for providing network-based security. Embodiments of the invention provide an electronic connection among an organization's policy objectives, procedures, people, and technical security controls.

Sub-headings are used below for organizational convenience, but do not necessarily limit the disclosure of any particular feature to any particular section of this specification. An improved information security management lifecycle including the process flows involved is presented first. The Functional Architecture is presented after the lifecycle and its process flows.

Observations

One use of policy management is in network security.

In the past, policy-based information security meant installing a few firewalls between network access points and implementing anti-virus on desktops and mail servers. Managing the operation, performance, and reliability of this type of security environment was relatively straightforward. It normally fell to the Information Technology (IT) or network administrator and his or her staff to manage the handful of firewall configurations and keep the anti-virus signatures up to date.

Recently however, threats have evolved in their complexity and numbers, and so too has the stable of security products and appliances used to combat these threats. Attacks are automated, and so should the defenses against them now be. The protection paradigms now must be enforced in real-time and an automated forensics process should be put into place to determine culpability because the amount of data available should be processed quickly enough to shut down the attack.

Structure in the protection and configuration of networks is needed. This structure should provide for the full-cycle of policy definition, policy enforcement, policy deployment, policy breach detection (problems: faults, conditions, issues, or events), problem isolation, problem reporting, problem response, and system reconfiguration or repair. IT security has quickly become a process of constant monitoring and updating of firewalls, intrusion detection systems (IDS), VPNs, and gateways. Currently a great deal of vigilance is required in both the types of products used and the attention that must be paid to these products to ensure they are all performing optimally to minimize the chances of a successful security policy breach. It should be possible to deploy security as just another well-understood, well-behaved application which is purchased one part, or one policy, or one policy element, or one policy implementation at a time.

A way is needed to incrementally build a workable network of defenses and a policy enforcement structure, but it is too much for any one company to build, and the cost is too great and not easily shared. The complexity of the policies today is broad. Additionally, it is not well understood how to tell developers that only certain parts of a policy need to be automated, and what those parts are, or how to phase their implementation.

What is needed is a way to get defenses out onto networks. The configurability of that task is huge. There is no easy way to replicate the task when the versions and types of devices are only ‘almost’ the same on different segments of a corporate network, and different managers have their own spreadsheets for configuration management.

There is no easy way to buy a set of defenses that really protect a network. There is typically no mapping between an enterprise's policies and the actual deployed defenses or the protections afforded by the defenses. There is typically no catalog of protections to choose from and certainly no manager can confidently construct a realistic policy based upon the protections he can afford from a list of those available.

Additionally, developers cannot afford to build big solutions all at once for a needed defense. They do not have any easy way of offering their often great defenses to customers because of the ‘noise’ in security systems, and because of the risks an enterprise would have to take to accept a developer's solution.

Enterprises are not simple hierarchies. Many functional elements comprise the infrastructure for any given organizational component, so security policies which affect any functional element type may not be appropriate for all of the various elements in the organizational. The security policies are relevant across organizational components with minor parametric changes.

This structure has lead to several emerging and serious problems, which are placing excessive demands on security administrators and Chief Security Officers (CSOs) alike. Their inability to effectively manage increasingly complex security infrastructures has resulted in inefficient use of resources, excessive and unnecessary security expenditures, and in many cases an increase in vulnerability levels. Attempting to manage multi-vendor firewall, intrusion detection system (IDS), VPN, and gateway environments requires individual expertise and the depth of resources to manually manage these products using individual proprietary management tools and expertise. Many companies that do not have these resources are forced to make security purchasing decisions based on the overall lack of effective management that would otherwise allow for best-in-class security purchases. Likewise, companies are being forced to forego operational advantages simply because they are unable to manage the infrastructure required to safely, securely, and efficiently implement these initiatives.

A missing element from traditional security point product solutions is the equivalent of a universal command and control system with a consistent management system and database. The command and control system would connect the point solution results to appropriate people and policy oriented standard and custom procedures to implement the enterprise's security and privacy policies with consistency and traceability.

What is also needed is an improved policy-based security management paradigm to deal with a multi-vendor environment with no standards, providing streamlined methods for the installation and configuration management of networked devices, collection and analysis of important security event data from different device types, and the ability to quickly and efficiently respond to security events when necessary. The security management paradigm must make it easier for non-specialized security personnel to manage an enterprise's security procedures.

Definitions

As used herein, the term ‘billet’ refers to the responsibility, function, execution location, purpose, and configuration of a deployed policy implementer or a policy implementer component. It is the role that the deployed policy implementer fulfills.

As used herein, the term “deployment” refers to the process of determining the specific device to send a component or configuration manifests to, to inform that device that it needs the component, to manage the process of sending the component, to receive confirmation that the component is received, and to persist the status of the delivery.

As used herein, the term “distributed” refers to a computational task or function that is broken into sub-functions or processes to execute on more than one distinct computing device so that all of the devices act harmoniously to deliver the desired result or overall function.

As used herein, the term “distribution” refers to the overall process of determining what components or configuration manifests should be sent to ‘child’ or ‘client’ systems, to deploy the components to those systems, and to then set the component into execution by invoking it.

As used herein, the term ‘Duty of Care’ refers to the area of various laws of negligence which impose a duty of care upon a person to take reasonable care to avoid causing foreseeable harm to another person or to their property. ‘Reasonable Care’ and the legal term ‘Reasonably practicable’ mean that the requirements of the law vary with the degree of risk in a particular activity or environment which must be balanced against the time, trouble and cost of taking measures to control the risk. It allows the duty holder to choose the most efficient means for controlling a particular risk from the range of feasible possibilities preferably in accordance with the ‘hierarchy of control’. The concept includes the assignment and delegation of the responsibility.

As used herein, the term ‘Incentive Programs’ refers to a management tool that business uses to desire achieved results by offering a tangible reward based upon the completion of a specific achievement. In addition, the term ‘Incentive Programs’ also includes the convincing showing that a tangible or intangible result will be received by the participant based upon the completion of a specific achievement, even if a specific reward is not offered. Incentive programs here are directed towards employees, customers, developers, and others. An incentive program can motivate people to participate in a specific community of interest, to develop a tangible result, achieve specific goals, reward performance or encourage customers to purchase a product.

As used herein, the term ‘Insurance Component’ refers to the legally binding contract between an insurance provider and the person who buys a certain coverage (an insurance policy), called the ‘insured’. Herein the term ‘insurance policy’ is not used due to the general use of policy which has a different meaning. A coverage is the contract for a specific compensation to be paid in exchange for payment of a specified sum of money, called the ‘premium,’ for a specific type of loss or damage as specified by the contract. When a loss occurs which meets all of the requirements described by the terms of a coverage, the loss is said to be “covered” by the insurance policy.

The use of the term ‘Insurance Component’ describes the addition of insurance coverage, with the addition of the premium, to the purchase of a policy implementer such that if the policy element that is ‘protected’ or ‘enforced’ by the policy implementer is breached where the policy implementer is in place and active, then the coverage compensation is due. An “exclusion” is a statement in an insurance policy which describes a condition or type of loss that is not covered by the policy. An exclusion is an exception to the general statement of coverage contained in the policy. If the policy implementer is not in place and active, an exclusion is triggered automatically for the coverage. A ‘limitation’ also is an exception to the general statement of coverage but is applicable only under certain circumstances or for a specified period of time. For example, if the subscription for the policy implementer lapses but the policy implementer is still in place and active, specific limitations will apply and decreased coverage will occur.

As used herein, the term “policy element” refers generally to specific requirements or rules or guidelines or objective or ‘detailed policies’ or ‘specific policies’ that are included in a policy document, agreement, or contract. Taken together, all of the policy elements in a document form the policy, agreement, or contract.

As used herein, the term ‘Policy Implementer’ refers generally to a package of all of the automation structures that are put into place to effect automation of protection paradigms required by a single policy element and that are not already a part of the infrastructure. The policy implementer may consist of, for example, a series of:
programmed components such as agents and plug-ins,
build scripts,
deployment and provision rules,
templates,
descriptions,
analysis, workflow, response and reaction rules,
reports,
naming and definitions of components, device types, device/network asset-groups, etc.,
low-level policy directives,
schedules,
plans,
analysis queries and metrics,
workflow process definitions,
configuration rules for various connections or installations,
information and analysis displays,
data structures,
audit criteria,
evaluation criteria,
accreditation criteria, and
other programmed objects
   that together are sufficient, for example, to perform some automation of the automated configuration management, breach detection, data collection, data reporting, and/or enforcement actions within a planned context within a customer system. If a protection is to be implemented by automation or if it is to be a part of the manual question/answer structure of auditing or accreditation for a policy element, or if it is to be a part of the policy description library system as an implementation discussion, its included functionality will be named and referred to as a Policy Implementer. Policy Implementers, when deployed to the various components of the framework, customize and configure the framework to operate to enforce the policies the implementer was developed for. Furthermore, various components of the policy implementer will be programmed to operate of framework elements which themselves will be version controlled and be executing on specific versions of computing equipment. As policies are implemented, and policy implementer function is developed, often one policy implementer will contain protection function that applies to more than one policy. This causes the reuse of the policy implementer, or may cause a reuse in other policy implementers of the code originally used in the policy implementer.

As used herein, the term ‘Protection System’ refers to the apparatus put in place to detect breaches of policies and related vulnerabilities, track assets, collect metrics, and to manage protection in a customer system.

As used herein, the term “rapid development” refers to a more efficient pattern of producing computer coding in answer to a requirement (specifically a new requirement based upon a policy objective) where the efficiency stems, in part, from a specific purpose, in part from a methodology which enables an incremental approach, in part due to a methodology providing well stated purposes and requirements, and in part due to a development environment offering strong facilities and opportunities for reuse of prior coding.

As used herein, the term “software” refers generally to programming, documentation, rules, configuration settings and configuration policies, and more specifically to either framework components or policy implementer components. Framework components in combination enable the operation of the system apparatus as defined below. Policy Implementers (components), when deployed to the various components of the framework, customize and configure the framework to operate to enforce the policies the implementer was developed for.

As used herein, the term ‘Target System’ refers to the customer system being protected by the Protection System.

Security Management Lifecycle with Top Level Process Flows

To achieve a level of protection on assets, the protection lifecycle must include a facility to discover a need, to establish a policy doctrine, implement automated protections that are enforceable, and assure the policy with oversight and an improvement program.

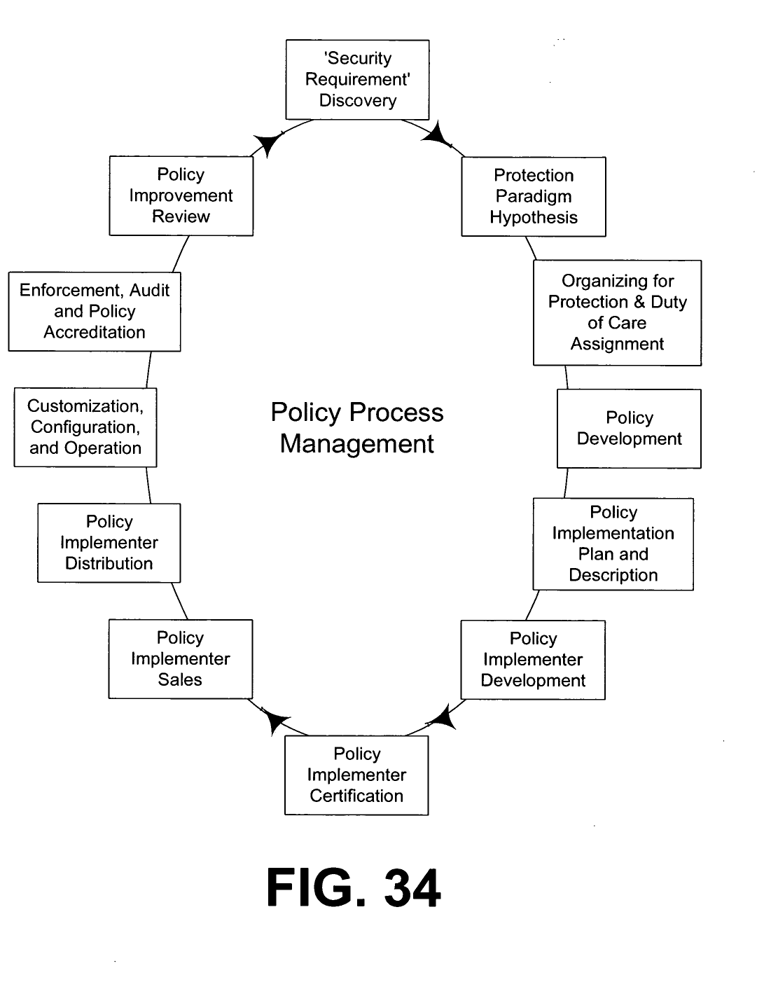

FIGS. 34-36 are flow diagrams of a policy-based security management lifecycle process, according to an embodiment of the invention. As shown in FIGS. 34-36, the process includes: Security Requirement Discovery; Protection Paradigm Hypothesis; Organizing for Protection & Duty of Care Assignment; Policy Development; Policy Implementation Plan and Description; Policy Implementer Development; Policy Implementer Certification; Policy Implementer Sales; Policy Implementer Distribution; Customization and Configuration; Enforcement, Audit and Policy Accreditation; and Policy Improvement Review. Not all steps are required in other embodiments.

The steps in this lifecycle can provide, for example:
Electronically developed, maintained, and published policy objectives;
Security training and measurement applications;
Electronically linked policy objectives with technical security controls;
Automated incident-response mechanisms and procedures;
Audit, Accreditation and other reporting;
Continuous Policy Improvement; and
Continuous Policy Implementation Improvement.

The Infrastructure makes it easier for non-specialized security personnel to manage the enterprise's security procedures. It also provides a facility for enlisting a cadre of developers to rapidly solve security issues and to rapidly deploy those solutions.

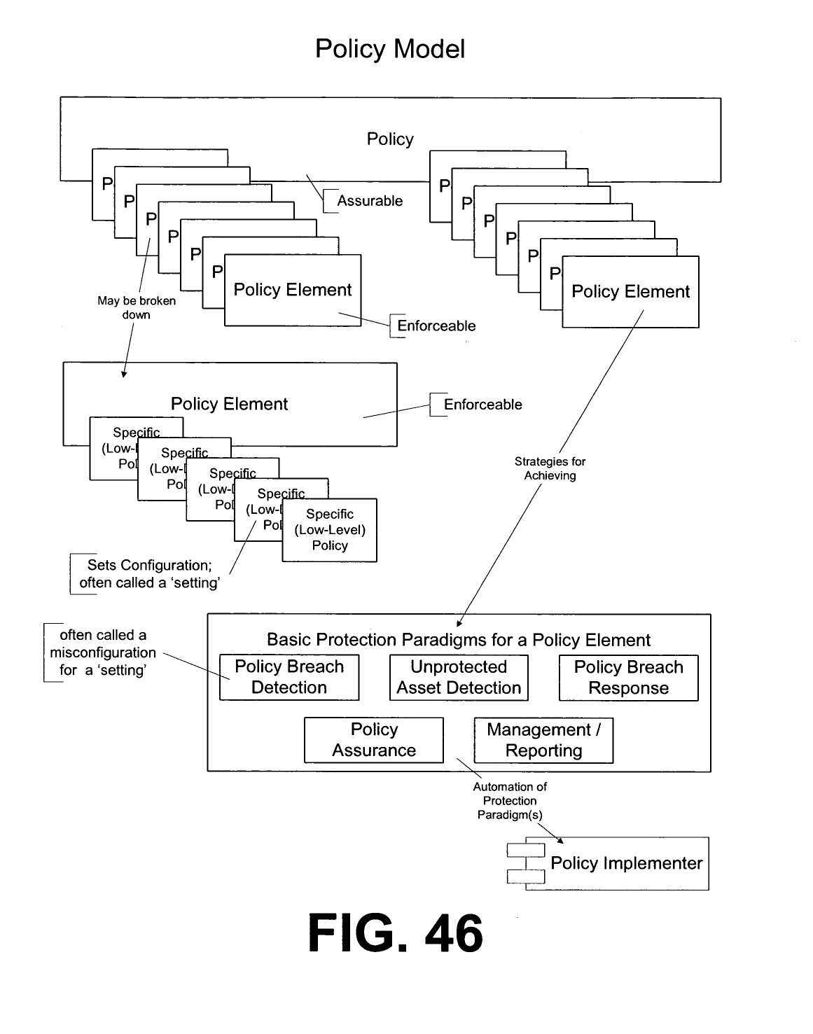

Policies set rules for operations in each of the disciplines of, for example: asset management, configuration management, network management, security, quality of service management, contracting and service level management, and duty of care management. Without the policies (and contract terms in the case of service level management), a definite basis for enforcement would be unavailable. In general, management can use the policies to show their board that they are indeed managing the organization, and the policies, when assured (enforced, audited and accredited) can be used as evidence of their management legally. Enforcement of policies without narrower definitions—rules or elements—can become complex and unenforceable. Policy elements, by themselves, are not wide enough in scope to provide for auditing and accreditation. FIG. 46 describes the relationship between policies and policy elements. (Some policy elements are effected by using very detailed ‘configuration rules’ which are called detailed policies. FIG. 46 also illustrates how a protection can be achieved through various paradigms. Policy Implementers are the automation structures that are put into place to effect those paradigms.

Just as policy elements are used in combination to fill in the details of a policy on an additive basis, the policy implementers which effect the elements are also additive. The policy elements and policy implementers have narrow definitions and are more easily put into practice because of the narrowed scope.

Policy elements may be re-used in different versions of a policy, and even in different policies. Likewise, policy implementers may be used toward achieving multiple policies, improving code re-use.

Policy implementers, when put into service, may cause conflicting configurations, but if they do so according to the policy element definitions, then the policy elements and the policy in general are the source of the conflicts.

The use of policy directed control, tying the policy to all implementation parts by the Policy Implementer, is new to this market. This fundamental change of adding higher level management policies and controls to lower level technology policies and enforcement engines makes it possible to deploy policy-based security as a well-understood, well-behaved application which is purchased one implementation at a time.

The Infrastructure adds higher level management controls to local devices by deploying the basic Controller, turning these into distributed agents that then carry out the instructions imposed by higher level policy applications which are packaged as Policy Implementer.

The separation of policy from specific versions of specific implementation function is fundamental, because it more consistently allows for the management of change and controlled implementation of updates to security, privacy, and configuration management, and thus the automatic enforcement of policies across the network from centralized locations, using a minimum number of appropriately authorized people.

Security Requirement Discovery

The lifecycle step of Requirement Discovery occurs when an organization becomes aware that a threat or vulnerability exists in their environment, that an asset is at risk, that use of assets is at risk or is impaired, or when legislation forces action on their part. This step includes the understanding of the security, asset management, configuration management, quality management, service level, or network problem. The step is used to clarify and to narrow the scope of the problem defined as a threat or vulnerability to loss.

Security-related requirements may be categorized by integrity, availability, and confidentiality. These concepts can form the basis of the security goals established for an organization. Integrity is the metric for the process of assuring that information is kept intact, and not lost, damaged, or modified in an authorized manner, or that the network is not compromised. Availability is the metric for the process of assuring that assets or information is accessible to authorized users when needed and that, to the extent possible, the systems are safe from accidental or intentional disablement. Confidentiality is the metric for the process of assuring that information is accessible only as authorized and that it cannot be acquired by unauthorized personnel and/or via unauthorized avenue.

The Threat/Vulnerability Assessment includes, for example, the sub-processes of: identifying assumptions, constraints, and dependencies involved; determining assessment methodology; gathering and reviewing information; identifying and prioritizing threats; identifying and prioritizing risks; matching threats with vulnerabilities; determining likelihood of occurrence; identifying existing or planned countermeasures; and completing a threat/vulnerability assessment report. Requirements will provide a degree and a characterization (type) for each threat or breach.

Protection Paradigm Hypothesis

Organizations rely on computer and network resources to handle many application requirements and vast amounts of information. Because the protected assets can vary widely in type and in degree of sensitivity, flexibility is needed in handling and protecting them. It would not be practical or cost-effective to require that all assets be handled in the same manner or be subject to the same protection requirements. Without some degree of standardization, however, inconsistencies can develop that introduce new risks. This breadth of configuration, coupled with the rapid changes in the technology and the complexity of the networks in use make it difficult to protect systems and still meet the requirements for their use.

This lifecycle step includes the construction of a conceptual approach to a defense to the threat, a limiting of the vulnerability, or a reaction and remedy for the breach or potential loss. Various tools and analysis techniques can be used to frame a protection paradigm concept. This concept will be used to further understand and categorize the detailed scope of protections needed to protect against or respond to the problem and their relationship to other protections the organization uses. The protections for one threat may differ greatly based upon the value of the assets protected, for instance.

How and where the protections will be most effective will determine the nature of policies that will be needed to structure the actual enforcement structure that will maintain the defense. Protections might be manual or automated, but in all cases a management structure will be effective to maintain the effectiveness of the protections put in place and to improve them over time as the threat evolves.

This step identifies potential control areas for protection and its implementation, such as, for example: security policy or management practice changes; organizational security; asset classification; personnel security; physical and environmental security; communications and operations management; access control; asset management; network management; policy-based security management infrastructure; systems development and maintenance; business continuity planning; service level agreements; and/or compliance with laws establishing duties of care.

Organizing for Protection & Duty of Care Assignment

To prepare for enforcement, threat isolation, or for attack/breach analysis based upon pre-categorizations, it is important to construct a taxonomy mapping (a framework for analysis) by characteristic of the targets and/or sources for which data is to be collected for analysis.

Once the threat, risk, vulnerability, or loss scenario (collectively called threats) is well defined and a satisfactorily limited context is described, the next step is to construct a taxonomy of the logical entities (a logical framework) and a taxonomy of the physical (real) entities for the detection of threat and the defense against the threat. An organizational map for the management of the defense team and a management structure for retaining the discipline of the defense are also needed.

When an analysis is needed of the data collected regarding a threat, it is much more effective to focus the collection effort's ‘field-of-view’ geographically, functionally, by network topology or by threat information category. A narrow ‘search focus’ (constrained taxonomy) reduces the volume of data to be analyzed and the load on the collection infrastructure. To make such a focus possible, the taxonomy for the geography, function, topology, or category must be established and utilized in the data collection scheme.

The ‘What’ to search for and the ‘Where’ to search are insufficient though under the compartmentalized security approaches needed in most organizations. The information collected must be segmented and marked with the organizational component and role that requested the information and that has the right to analyze it or review it—the ‘Who’.

The next step is to construct a taxonomy of the logical entities taxonomy for naming has to be, itself, enforced by a policy-based security management system infrastructure. The management structure for the process must make use of the naming and the assignments of roles to actual individuals.

The Who and Where must be generally stated. The ‘What’ to search for is the threat/policy element being addressed by the development. The Who is generalized to a role, and the Where is generalized to a context. This step provides the naming structure for the objects above and the team roles and security responsibilities for all stakeholders.

Even before the policy regarding a new requirement is defined, the responsible party to develop it and the approving authority would be identified in real terms. Those responsible for compliance would also be named. The points of contact for further information should also be established.

Other naming that occurs includes the identity of the policy and any sub-parts to the policy that are defined and assured. These would include any applicable standards or guidelines. Employees need to know whether the point of contact for questions and procedural information by policy or policy sub-part as the policy is in development, especially if the policy might not be completed before the protection mechanism has to be put in place.

Policy Development

Policies help establish standards for resource protection by assigning program management responsibilities and providing basic rules, guidelines, and definitions for everyone in the organization. Policy thus helps prevent inconsistencies that can introduce risks, and policy serves as a basis for the enforcement of more detailed rules and procedures.

Policy formulation is an important step toward standardization of security activities. Policy is generally formulated from the input of many members of an organization, including security officials, line managers, and resource specialists. However, policy is ultimately approved and issued by the organization's senior management.

The term ‘policy’ has many meanings. The meanings are differentiated by the type of object for which the policy is to be enforced. A network routing policy has a scope appropriate to a network router and is usually explained in a short ‘rule’ in the router's configuration stating that messages from a certain input interface should be output on another interface. A health care provider's information policy requires much more explanation and a management structure for maintaining the discipline needed to effect it. For the purposes of this application, a low-level or implementation-level policy is a policy which can be stated effectively with a short rule, and a high-level or organizational policy is a policy where more information must be provided to make the policy understandable.

An organizational systems security policy provides a consolidated statement of the security requirements for the systems of an organization. The policy documents the basic information regarding system security from the requirements, paradigm, and organization steps above, and it identifies the relevant organizational mandate and legal doctrine containing security directions and context. It provides an indication of the level of security assurance required and assigns organizational roles and responsibilities for managing the defenses.

A system security policy discusses topics such as: basic facts, security domains, security functionality, security assurance, and configuration management.

Assurance defines how strong and how correct security functions need to be, and is directly related to the level of threat under which the system will operate. As the requirement for strength and correctness in a security function increases, so does the effort required to evaluate that function and therefore the cost of products at that level of assurance. Selecting the assurance level therefore involves balancing cost against security needs. While accreditation provides a statement of the status of computer system relative to the stated policy at the time of the accreditation, configuration management provides the control process for maintaining the required level of security throughout the life of the operational system. Configuration Management defines change approval procedures, sets the management structure, and provides a reference to baseline configuration documentation.

The missing element from traditional security point product solutions is provided by the Infrastructure described here—the equivalent of a universal command and control system. The Policy Implementers link the point products across a standard network connection to a consistent management system and database. The Infrastructure connects security's point solution results to appropriate people and policy oriented standard and custom procedures to implement the enterprise's security and privacy policies with consistency and traceability. The business process provides for a developer community and for evolving standards, but it also is based on the best of breed open source and several vendor solutions to allow for other's standard setting roles. The Infrastructure makes it easier for non-specialized security personnel to manage the enterprise's security procedures.

Because policy is written at a broad level, organizations also develop standards, guidelines, and procedures which offer users, managers, and others a clearer approach to implementing policy and meeting organizational goals. Standards and guidelines specify technologies and methodologies to be used to secure systems. Procedures are yet more detailed steps to be followed to accomplish particular security-related tasks. As technology has advanced, automation has assisted, then supplanted these static methods. Though standards, guidelines, and procedures may still be disseminated throughout an organization, they are now commonly used to structure computer-based business rules, network security and routing rules, and other automated enforcement mechanisms. These narrow implementations are often called low-level policies.

Types of Computer Oriented Policy

Program-level policy is typically issued by the head of the organization or another senior official, such as the top management officer to establish the security program, assign program management responsibilities, state organization-wide computer security goals, purpose and objectives, and provide a basis for compliance and enforcement.

Program-framework policies provide organization-wide direction on broad areas of program implementation. For example, they may be issued to assure that all components of an organization address contingency planning or risk analysis. Program-level policy is usually broad enough that it does not require much modification over time.

The program-level policy firmly establishes individual employee accountability. Program-level policy serves as the basis for enforcement by describing penalties and disciplinary actions that can result from failure to comply with the organization's security requirements. Discipline is set commensurate with levels and types of security infractions. Without the proper level, visibility, and education of these policies, nonconformance to policy can be claimed as unintentional on the part of employees.

Issue-specific policies identify and define specific areas of concern and state the organization's position. Issue-specific policies are likely to require revision and updating from time to time, as changes in technology and related activities take place. This is largely because as new technologies develop, some issues diminish in importance while new ones continually appear. These policies do not often disappear, since technologies or functions do not often die but are instead transformed. The broad categories for issue-specific policies are, for example: Physical Security; Personnel Security; Network Configuration and Security; Communications Security; Administrative Security; Asset Management, Maintenance and Protection; Risk Management; Contingency Planning.

System-specific policies state the security objectives of a specific system, define how the system should be operated to achieve the security objectives, and specify how the protections and features of the technology will be used to support or enforce the security objectives. A system refers to the entire collection of processes, both automated and manual. System-specific policy is normally issued by the manager or owner of the system (which could be a network or application), but may originate from a high official, particularly if all impacted organizational elements do not agree with the new policy.

Many policy decisions apply only at the system level. Some examples include: Who is allowed to read or modify data in the system? Under what conditions can data be read or modified? Which users are allowed to use the network and for what type of traffic? What foreign devices may be used internally, and what internal devices may be taken home or away on travel? When does data archiving take place for personal information on employee computers, or when do database backups take place for mission critical systems? What purchases of computer assets or network connections may be made by users?

Low-level policies are detailed rules for the operation of specific devices or network connections. These rules are automatic in their impact and are implementations of the higher level policies above. Without them, automation of policy enforcement would be impossible, yet the higher level policies are rarely made traceable to the lower level rules, especially when a proper security automation infrastructure as is described in this application is unavailable.

Sample Policies will be written and made available on the Assurance Component of the Infrastructure. These Policies will be used as the basis for implementation and traceability. The policies will range from legislated mandates to simpler, suggested templates for internal policies. The policy elements associated with the policies will be described in further detail. The library of policies and policy elements will be made available for use by registered users. For each policy and policy element, templates for audits and accreditation applications, and links for further information will be provided. The Implementation Plans and Descriptions developed according to this methodology will be cataloged and linked to the Policies and policy elements in the policy library, and the catalog element of the E-commerce Component of the Infrastructure will be integrated for common access to these Policy descriptions. Recommendations will be provided to assist in customer's continuous improvement programs, in this methodology.

Policy Implementation Plan and Description—The Plan

Policy implementation is a process and must be planned. Policy cannot merely be pronounced by upper management in a one-time statement or directive with high expectations of its being readily accepted and acted upon. Rather, just as formulating and drafting policy involves a process, implementation similarly involves a process, which begins with the formal issuance of policy that should be digested and addressed.

This step determines the role technology will play in enforcing or supporting the policy. Security is normally enforced through a combination of technical and traditional management procedures. Those aspects that can be assisted by technology are considered for development, and the functionality that must be developed is divided into Policy Implementers in this plan.

Policies identify the required security functions, but the Implementation Plan details the specific security measures and the approaches selected to satisfy those functions. It provides a description of each of the security functionality requirements (generally known as SFRs), and identifies the security procedure or countermeasure response approach to satisfy the requirement. Examples are:
Communications Security: provides details of how to meet the link encryption and routing or other networking related requirements of the system.
Computer Security: gives details of the approaches selected to meet the security requirements such as virus protection, intrusion detection, service configuration, physical security, communication encryption facilities, etc.

The information regarding the implementation approach should be tied automatically into the policy addressed and be made available to relevant individuals. Applicability of and visibility of policy documentation is demanded for due process and for duty of care demonstration. No individual can be culpable if they are not informed properly; no organization may claim that they are not responsible if they themselves have not properly assured the effectiveness of the policy by informing those with responsibility under it.

Policies are often not specific to single sites. Policy Implementation must be accomplished in stages, and the starting point for the development is a context rather than a site. A context is a described environment (collections of business locations, networks, organizational elements, etc.) devoid of any real geographic or identifying information. The use of the context creates a generality for the implementation and focuses the implementation to the generalized threat. It also focuses the later deployment phases on the localization of the implementation rather than on the functionality.

Security rules cannot often be applied universally, even at the goal level. Security must often be integrated into many existing activities and practices throughout many levels of the organization, and different functional elements may have widely differing systems and needs to accommodate. Organizational elements tailor their implementations of policy to meet their unique needs. Also, news of the degree to which implementation has occurred and enforcement of compliance is a reality in any sub-organization should be available, along with detailed implementation information. Appropriate visibility should be afforded the policy through all applicable documentation, but with the complexity existing, and the need for enforcement, only a dynamic, automated system has any hope of providing the visibility of the specifically applicable detail needed or implemented in any specific organizational element or on any specific device.

While technical solutions are likely to include the use of access control technology, network configuration rules, virus checking, and asset tracking, there are other automated mechanisms of enforcing or supporting policy. For example, intrusion detection software can alert system administrators to suspicious activity or take action to stop the activity. Portable computers can be configured to report in from wherever they are located when not on the corporate network. Databases can report when they need backup or archiving. Traditional management procedures are used for disciplining employees or for process assurance and improvement.

Each of these technical solutions should be coordinated to be fully effective. Though they often are used separately, having all of the various tools collecting data that is not used coherently may cause misconfigurations or gaps in defenses. The collection burden (network bandwidth, computing resources, and manpower) on a network may also be immense and a scattershot approach will only increase the burden.

Implementation generality should be balanced against need. Elements of computer systems vary in purpose, function, age, location, organizational purpose, etc. Deviations from a policy may sometimes be necessary and appropriate. It is not that the situation occurs frequently if the policy is too rigid, but that the policy should accommodate realities, and that the tuning needed should be manageable and repeatable when reconfiguration is needed.

Not all of an Implementation Plan may be executed in one short period or in all divisions of an organization or on all equipment or networks at once. The staged roll-out across the organization and the phased development and deployment of the function should be controlled by a Plan.

Also, make/buy decisions will be required, and the reuse of prior developments could save significant resources. An inventory of function represented by the collected developments should be available for without one no easy reuse and no easy comparison can be made. Also, the ownership or licensing status of the function may not be known without an inventory, and various portions of the function might be outdated and no longer effective if the inventory cannot be used for configuration management.

An implementation of a policy should be sufficient to meet duty of care requirements for each specific policy detection, reporting, analysis, or enforcement element. An organization's insurance may be ineffective or their director's legal or contractual liability may be increased if duty of care is not met. To show that the duty of care is met, an organization must show that a specific threat was being protected against at the time of any actual incident of loss or when an audit or inspection takes place.

All of these factors come together to require a plan of attack for implementing a policy and for measuring the progress of the implementation and the status of the implementation within any part of the organization's network at any specific time.

No organization could possibly implement all of the required policy implementation functionality in a single development effort. The complexity of the requirements coupled with the complexity of the development process and the speed needed for development to respond to the real threats existing demands a coordinated, incremental approach. This application presents a methodology of development which is incremental and controlled in just this manner. The result of the methodology is the embodiment of the functionality called the Policy Implementer.

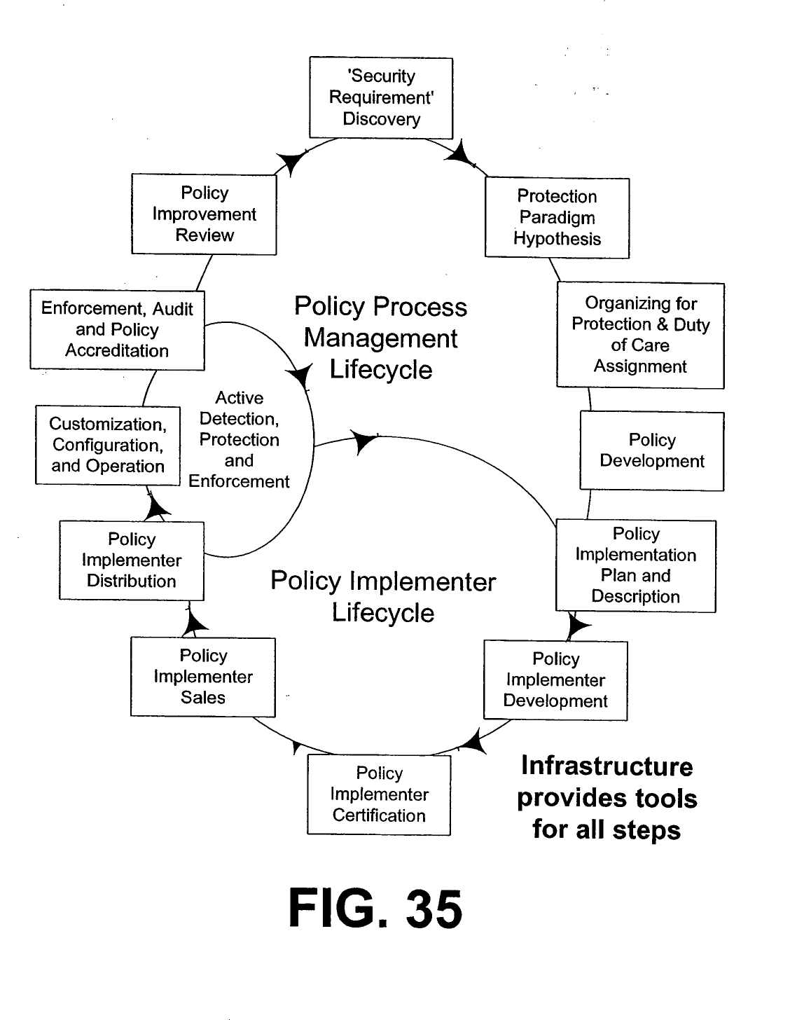

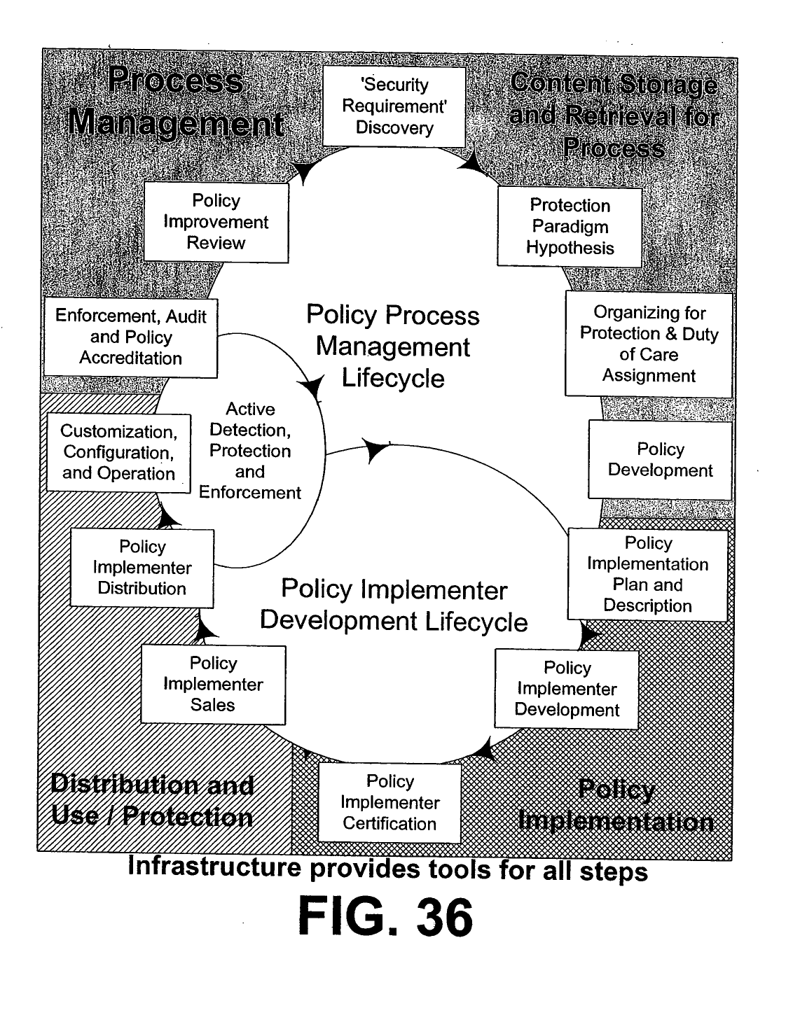

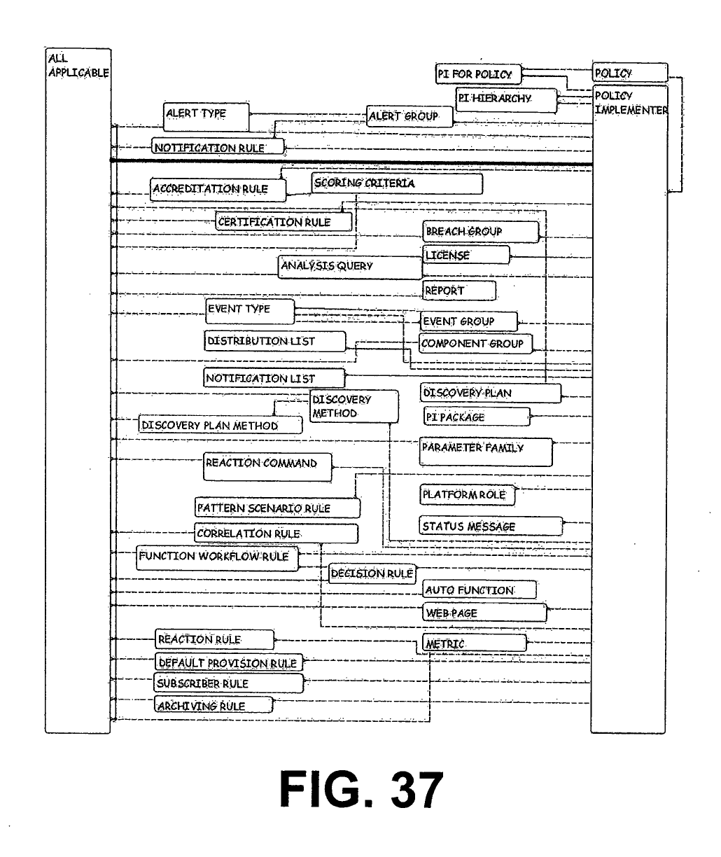

The utility of the Policy Implementer is shown in FIGS. 35 and 36—without this function and methodology, there is no easy way to effectively make these decisions or to incrementally but cohesively develop or to purchase the technology for implementing policies.

In this methodology, a business process is described wherein Policy Implementers are submitted for inclusion in the online catalog for sales through the described Infrastructure. Policy Implementation Plans are used to describe detailed requirements and approaches for the development of Policy Implementers. By separating the requirement description process from the development process, we ease the development of the Policy Implementers and divide the effort required into multiple tasks. This also broadens the community of available development cadre, and allows a vehicle to drive development in appropriate directions of need.

In this methodology, each approach addressed will be identified separately. If it is to be implemented by automation or if it is to be a part of the manual question/answer structure of auditing or accreditation, or if it is to be a part of the policy explanation employee/user information system, its included functionality will be named and referred to as a Policy Implementer.

Templates for the Plan will be available in the Developer and Assurance Component of the Infrastructure and will be integrated to allow for entry of Plan and rapid viewing of the Plan's effect on Assurance. Completion level and status metrics will be calculated automatically in the Assurance component of the Infrastructure. A degree of flexibility will be provided by the Infrastructure templates, different templates will be available for each major category of policy and type of mechanism, and templates will be organized to allow for rapid, but high quality development of Plans in that they will generally allow for a structured question/answer process with the planner.

In this methodology, the sections of the Policy Implementation Plan may be, for example:
General Description: describes the specific elements of a policy that are being implemented, and a general description of the way that the Policy Implementer is constructed to enforce the policy. This provides a summary Statement of Applicability.
Target Context: Describe a fictitious example organization and generalize a description of the environment that the organization could have. State a presumed characterization of the fictitious organization's ability to understand its risks and manage them without and with the Policy Implementer. Characterize the fictitious organization's preparedness for receiving and managing the Policy Implementation.
Risk evaluation methodology: Prepare Risk Analysis Report identifying:
   Addressed Threats and vulnerabilities,
   Proposals and evaluations of countermeasure effectiveness,
   Countermeasures trade-offs (performance impact versus cost versus security), and
   Residual risk
Ranking and definition of risks and impacts (i.e., low, medium, high) by requirements and policies as stated in the Security Requirement and Policy Development steps in this methodology.
Functionality. The functionality required of the approach, either identified by reference to a security standard or by detailed description.
Policy Traceability: describes specific elements of the relevant policies that are enforced by the Implementer. Boundaries are explained where limits to the implementation relative to the requirements of the policy have been established.
Assurance and Compliance Description: states the assurance level of the approach, and sets ‘efficacy evidence’ criteria needed to substantiate the assurance claim and to meet the traceability above. Describes the intentions of the Compliance Directives, Programs, and Procedures stemming from the specific element of the policies being addressed by the implementation approach, and provides forms for reporting compliance and requesting Audit, Accreditation, and Certification for the specific element of the policies addressed.
Functional Scope Limitations: If the level of assurance required in the policy will not be met solely by an automated security measure, or if the security measure selected does not fully cover the required security functionality, the deficiencies must be specified, and operating procedures provided.
Communication Description: describes the specific information and application protocols relating to the implementation of the Policy to fully inform the user and the review/audit/accreditation bodies regarding the nature of information transferred from and to the various elements of the implementation and how it is used.
Configuration Management: provides a baseline for configuration management of the developed function (bill of materials of internal elements and how they fit together). It also permits the specification of deployment and applicability (usability within other Implementers or for specific environments) of the Implementer, stating where its components will be placed within the infrastructure framework. Provide a plan for staged roll-out across the organization. It also provides a description of any configuration needed for any subcomponents of the Policy Implementer.
Processing Description: provides descriptions of all algorithms, rules, code, measurements, workflow, and processing schedules used to implement the Policies addressed. Failure Action descriptions will be included to show how the security approach will behave under failure conditions.
User Interface Description: describes and specifies the dashboard facilities for the Implementer. It sets roles and privileges for the use of the User Interface, and allows tailoring of existing interface components.
Management Specification: describes and specifies the issues raised by the Implementer and how they are directed (workflow) to those responsible, and how they may be cancelled based upon new events.
Operating Procedures: States relevant procedures used in the management, administration, and operation of the system under the approach. The Operating Procedures may consist of a number of independent procedures and include specific procedures designed to protect against known vulnerabilities in the approach which are not otherwise protected. Procedures may be security-relevant. Examples of relevant procedures include:
   storage management procedures;
   startup, recovery, and closedown procedures;
   user training and usage procedures;
   physical security;
   user id and password procedures;
   control of access and permissions;
   monitoring of privileged actions;
   procedures for development and Distribution;
   controls on connectivity and foreign software;
   review, audit, and accreditation procedures.
Development Review: describes and specifies the process involved in and any history of the review of the coding and methodology of the Implementer.
Policy Implementer Merchandising Objectives: describes who needs the Implementer, provides an FAQ for developers, and proposes packaging, pricing, sales policies, and subscription direction. Includes links to information on insurance plans and adjunct services such as Compliance Assistance and Process Improvement Services. This section describes the function for those involved in the Distribution or use of it.

This Plan is a requirements document when completed in this methodology. The choice of which of the words ‘optional’, ‘preferred,’ and ‘should’ may change depending upon the process of negotiation and scoping with the Implementer developers. When the certification process below begins, the documentation should reflect a choice usable during the code review.

Utility of Policy Implementation Plans

Policy Implementation Plans are used to stir Policy Implementers development and to provide a basis for Policy Implementer certification. Policy Implementation Plans and Policy Implementers will often be developed by different 3rd parties or internally, and the development of them may be accomplished by large or small teams, at times being formed ad hoc. These teams may be acting for financial gain or may be ‘open source’ developers. The described business process provides for improvement by updating of the plans and extension of the Implementers. The described business process also provides for the development of improved Policy Implementers by other 3rd parties and/or internal developers as requirements change.

The nature of this described methodology yields an overlapping of effort by those parties enlisted into the process. It is tuned to provide a broad group of developers with varying motives and expectations, and to coalesce their results into a well defined and integrated set of protections for somewhat defined policies. The results will be offered for sale in different described business models, offering incentives for developers. The certification process is meant to deter shoddy results from inclusion and deployment, but the incentives, quality of requirements statements, and marketplace structure will drive the eventual quality as marketplace competition is built into the process as well.

The added business utility of this described methodology is an improvement in the rapidity of development in response to new threats and vulnerabilities found in the wild (released into the open by nefarious individuals or states). This concept of Differentiated Security Enforcement and Response Automation is new in this market and technical arena. To enhance the rapidity, certain Implementation Plans will be published under the category of Rapid Policy Implementation Plans and will be incentivized appropriately. The process of creating the market in this manner is described here as the Rapid Security Response Automation and Deployment business methodology and the facility called the Policy Implementation Submission Infrastructure Component and the Policy Implementer Software Development Kit Infrastructure Components described below will support this methodology.

It is anticipated that various specialties will be taken on by developers and that their work will form vertical and horizontal market packages that will be bundled as subscriptions in the business model. Also, it is anticipated that various cost levels and quality levels will cause various market segments for the Policy Implementers. These factors, along with the specific intentions described in the Merchandising Plan Description above, will provide for categorizations in the catalog of available Policy Implementers in the E-Commerce Infrastructure Component described below.

Policy Implementation Plan and Description—The Description

In this methodology, each automated approach named and referred to as a Policy Implementer will be implemented within a structured process, within a framework and on an infrastructure to generally meet established criteria.

The Implementation Plan will provide the staged roll-out and the phased development objectives for the implementation. The context for use of each policy implementer will be stated in the plan and used for configuration management and deployment as well as for sales catalog categorization.

The structured process will provide for make/buy decisions, incorporation of multiple developer's works, and the reuse of prior developments. The framework and infrastructure provide an inventory facility for categorizing of function, configuration management for use and version control, and tracking of deployments. The infrastructure maintains records of ownership and/or licensing status of the policy implementer function for each unit sold and/or deployed either in a bundle, subscription, or otherwise.

The results of the Policy Implementation Plan—Description process are used as an input to the Audit Step in the methodology. The results are also used for Accreditation. They form an explanation for the Policy Implementer and are included as the basis of all online documentation. Online documentation for the functionality of the installed protection facilities on any system deployed will be available in an integrated document. The utility of this approach is that any user or reviewer will be able to see the specific protections for a specifically protected device at a specific time and the limitations, security approaches taken, and those protections that ARE NOT installed or licensed to them. In other words, the documentation is linked to the installation, and conversely, only the relevant documentation is available for the specific installed protections for a device.

Continuous tracking and retention of the documentation from policies to requirements for each specific policy detection, reporting, analysis, or enforcement element are kept in the infrastructure inventory. Duty of care status by policy and the traceability established during implementation are also retained in the infrastructure to show how and where the duty of care is met whenever needed. The Inventory Infrastructure Component provides for the proper control over this inventory, and the Data Structures provide the logical structure of the storage. The inventory will be used in the Business Process as the basis for catalog entry information, customer information, sales, and licensing. It will be used in the Distribution Infrastructure Component for control of deployment and configuration and for control of the information communicated into the Analysis and Discovery Infrastructure Component to effect localization of threats, breaches, etc.

The utility of the Policy Implementer and the Infrastructure is shown here—without this function and its development methodology, there is no easy way to effectively retrieve or to make use of this information for protection or enforcement, or to control the Business Process.

As policies are implemented, and policy implementer function is developed, often one policy implementer will contain protection function that applies to more than one policy. The Infrastructure provides the ability to trace the function provided by the policy implementer back to multiple policies, regardless of the domain or organizational purpose to which the policies apply. This methodology also provides for the integration of computer policy into and consistently with other organizational policies, such as personnel policies.

Policy Implementers are not specific to single sites in most cases. They are specific to contexts that are specified in the above steps.

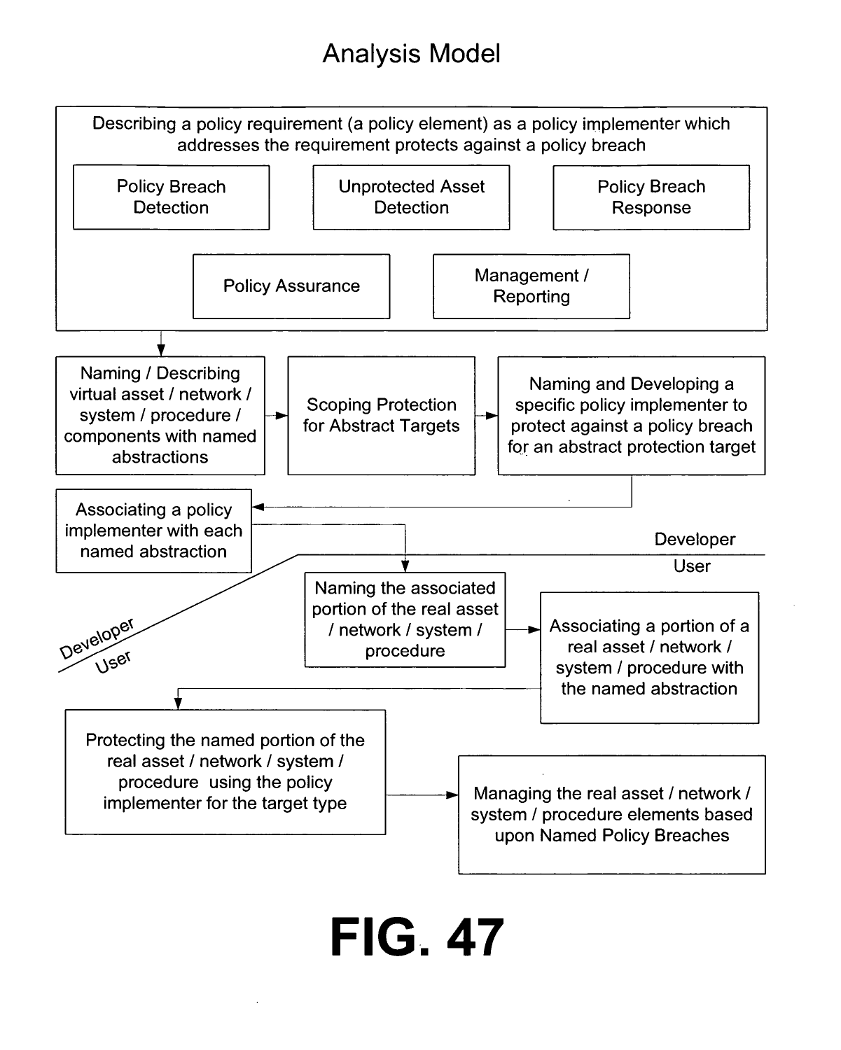

FIG. 47 is a process flow chart of an analysis process, according to an embodiment of the invention. More specifically, FIG. 47 illustrates the process involved in crafting a protection for a network component, a network, or a procedure. The protections created may not be tied to real world devices for several reasons, so a process of abstraction is used to form a development context for the development lifecycle against the presumed real world context where operation will take place. When the policy implementer is finally created, a specific version of it will be associated with each named abstract, and when it is deployed, the proper version will be sent out to protect the specific real world device. Furthermore, various components of the policy implementer will be programmed to operate of framework elements which themselves will be version controlled and be executing on specific versions of computing equipment. The version control mechanism for policy implementers will yield the proper specific component of the proper generic policy implementer for deployment to a specific framework part.

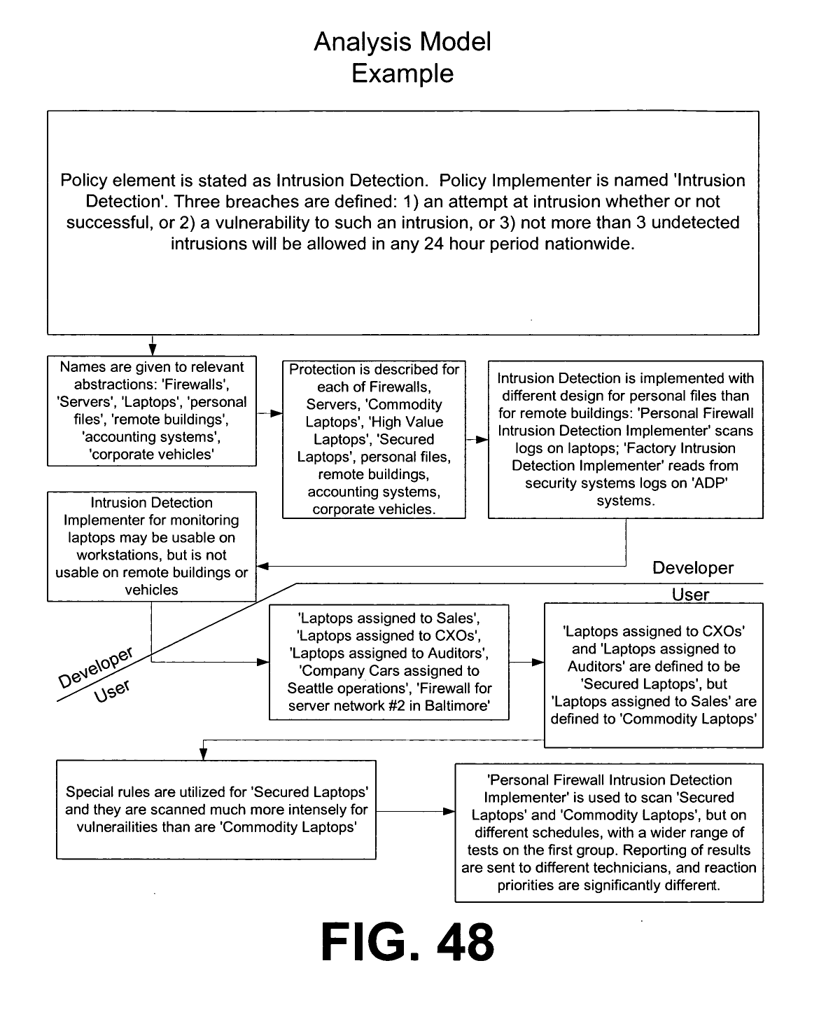

An example of the abstraction for the development process is provided in FIG. 48. The boxes in FIG. 48 correspond to the boxes in FIG. 47.

The plan for the Implementation is a statement of requirements and a presumptive statement of direction. This step in the methodology provides detailed descriptive entries for the context, purpose, approach, and sales scenarios for the Policy Implementation. This Description is a requirements document when completed in this methodology. The choice of which of the words ‘optional’, ‘preferred, ’ and ‘should’ may change depending upon the process of negotiation and scoping with the Implementer developers. When the certification process below begins, the documentation should reflect a choice usable during the code review.

By breaking apart the Implementation Plan from the Policy Implementation Description step, and the Implementation Description from the Policy Implementer Development step, the methodology further enhances the utility of separation of effort and inclusion of differentiated talents into the methodology of Policy Implementation. It also provides an improved tool for clearly conveying to developers, customers, users, and reviewers the protections that are being offered and the plan for rollout of improvements to that protection function.

The division of work forms informal but phased formality of contracts between disparate parties who are jointly building Policy Implementation function. This separation offers the utility to remove from the developers the need to so fully describe their work and lessens their defensive need to justify the lack of development of code due to implementation difficulty. It also provides a negotiated reality to those describing the function, and provides for less technical participants an incentive for involvement. This occurs because there is a natural negotiation process between the planners, the describers, and the programmers, recognizing that the three roles may reside in multiple organizations or be taken on by individuals.

This step occurs before, during, and after the Policy Implementer Development Step, and overlaps the Certification step. The utility of this schedule is that improved quality will result in the description, and because of the longer involvement and negotiation, a better description regarding the end functionality developed in the Policy Implementer will result.

Templates for the Description will be available in the Developer Component of the Infrastructure. Completion level and status metrics will be calculated automatically in the Assurance component of the Infrastructure. A degree of flexibility will be provided by the Infrastructure templates, different templates will be available for each major category of policy and type of mechanism. Each section of the description will have a fill-in the blanks form for starting the description and a diagramming tool. The templates will be organized to allow for rapid, but high quality development of Descriptions.

In summary, the following actions may be accomplished in the Policy Implementation Step:

Context Description

Develop context (system/site) description
   Describe a fictitious example organization and generalize a description of the environment that organization could have.
   Describe scope of protection (see Protection Paradigm Hypothesis)
   Describe location in generalized terms (see Organizing for Protection & Duty of Care Assignment)
   System or network description in generalized terms (see Organizing for Protection & Duty of Care Assignment)
      Approach Description
Describe approach to implementation by security requirements
   Discuss mechanisms that affect availability requirements
   Discuss mechanisms that affect integrity requirements
   Discuss mechanisms that affect confidentiality requirements
   Discuss mechanisms that affect accountability requirements
   etc.
Describe approach to implementation by security mechanisms
   Access Control
   Object reuse
   Accountability
   Identification and Authentication
   Audit
   Assurance
   Personnel security
   Physical security
   Software security
   Information security
   Communications security
   Contingency planning/continuity of operations
   etc.
      Description of Relationship of Function to Policy
Describe detailed traceability of automated function to specific elements of policies:
   Breach Characterizations
   Collection, Analysis, and Forensics Description
   Alert and Enforcement Actions
   Policy mandated review requirements for assurance
      Description of Assurance Process Related to Implementation of this Element of Policy
Describe the suggested or mandated audit and accreditation process for the Implementer being developed.
Describe the information collection requirements for the certification, audit, and accreditation procedures specific to this Implementation.
   Management Information System Online Status Dashboard
   Executive Dashboard Protection Evaluation and Printed Report Formats
   Certification Worksheet Questionnaire
   Audit Information Collection Questionnaire and Report Format
   Accreditation Information Collection Questionnaire and Report Format
   Process Improvement Information and Suggestion Lists
   etc.
      Description of Customer Relationship and Perspective
Describe approach to merchandising of security mechanisms
   Categorization of Policy Implementer
   Preparation of Collateral Material for Policy Implementer
   Catalog Entry information
   FAQ and packaging information
   Pricing, sales policies, and subscription information
   Information on insurance plans and adjunct services such as Compliance Assistance and Process Improvement Services.

The Utility of the Policy Implementation Plan and Description is the visibility of the Policy and the specificity of the protections that the Policy Implementation provides. Effective policies must usually be visible, but in this methodology, much of the protection, threat, vulnerabilities, and enforcement are unseen by humans until after the incident occurs. Visibility aids implementation of policy by helping to ensure that the correct protections are utilized and that the scope of the protection is well understood before purchase of the protection. Implemented Policies should also be integrated into and consistent with other organizational policies, such as personnel policies. The availability of a quality infrastructure and a quality presentation of protective measures will yield the understanding needed to integrate the protective mechanisms.

Policy Implementer Development

This step sees the detailed design and programming of a Policy Implementer which includes a number of items that collectively provide the requisite functionality to deliver an implementation of an automated breach detection, data collection, and/or enforcement mechanism required for some sliver of an issue-specific or system-specific policy and provides traceability sufficient to meet appropriate program-level policies.

As stated in the Policy Implementation Plan, not all of the function needed for the entire policy is attempted since to do so might involve a considerable development effort or some/too many requirements for manual procedures.

The policy implementer may consist of, for example, a series of:
programmed components such as agents and plug-ins,
build scripts,
deployment and provision rules,
templates,
descriptions,
analysis, workflow, response and reaction rules,
reports,
naming and definitions of components, device types, device/network asset-groups, etc.,
low-level policy directives,
schedules,
plans,
analysis queries and metrics,
workflow process definitions,
configuration rules for various connections or installations,
information and analysis displays,
data structures,
audit criteria,
evaluation criteria,
accreditation criteria, and
other programmed objects
   that together are sufficient to perform some automation of the automated configuration management, breach detection, data collection, data reporting, and/or enforcement actions within a planned context within a customer system.

Workflow process definitions form the foundation for controlling workflow between the constituent components.

Response and reaction rules define what actions to take when a policy is breached or when actual activity falls outside acceptable limits according to some metric.

A policy implementer could also combine the functionality of previously developed policy implementers. An Intrusion Detection Agent, Vulnerability Monitoring Agent, Vulnerability Management Agent, Network Discovery Agent and Network Asset Management Plug-in could all be combined by building a comprehensive set of analysis and reaction rules that integrate the operations of each component into a single policy implementer. This application would be responsible for insuring that an organization's network assets comply with a defined level of vulnerability protection and it would perform continuous audits of those assets.

Policy Implementers are developed for contexts, and the Infrastructure provides for the deployment to and configuration for each specific location and realized context.

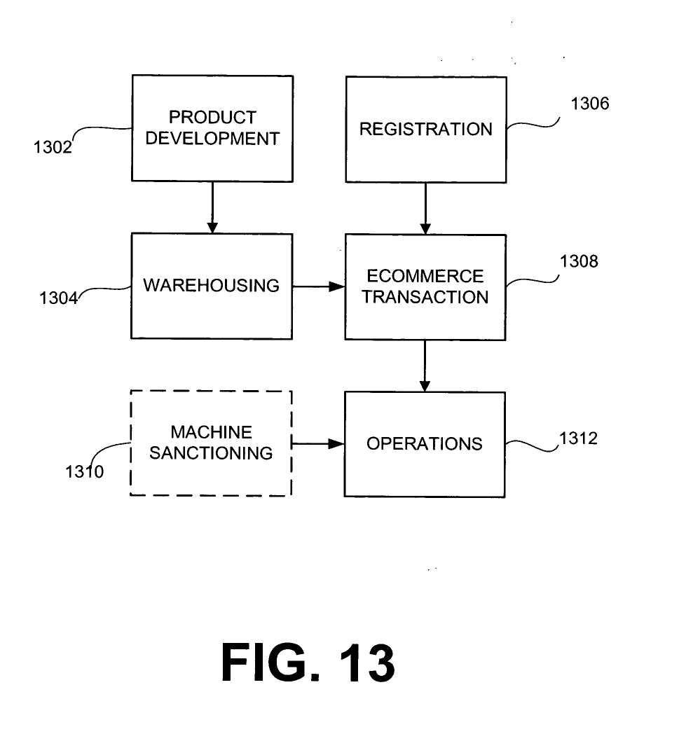

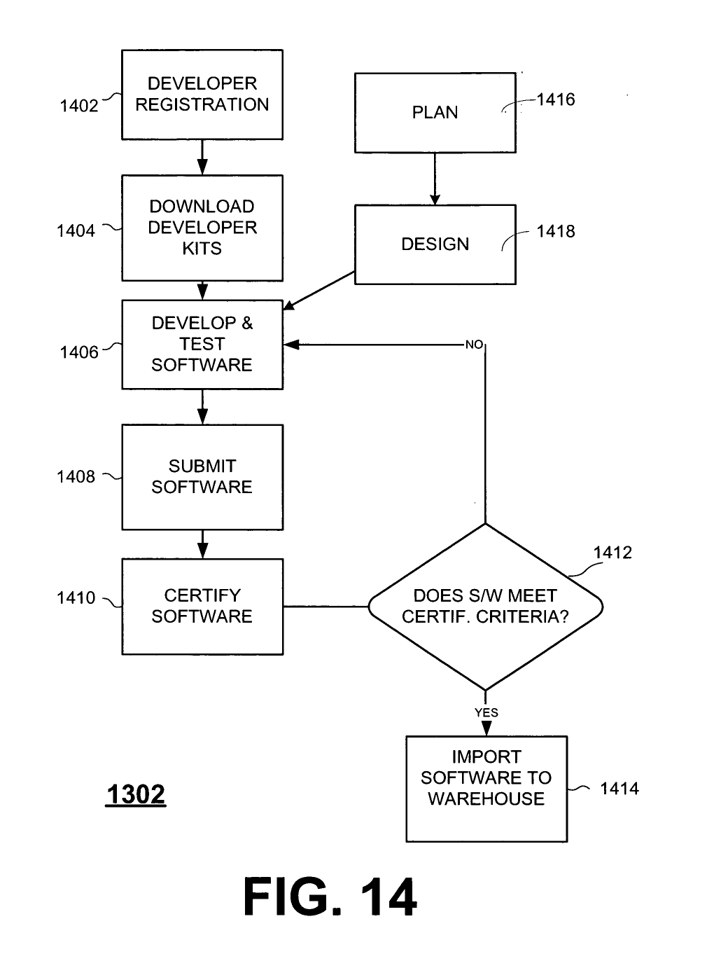

FIG. 14 is a process flow chart for the Policy Implementer product development process 1302 shown in FIG. 13, according to one embodiment of the invention. As shown therein, the process allows a registered developer (registered in step 1402) to submit developed Policy Implementer software for certification. It also provides tools required to develop, test, and submit software.

The Developer Component provides a developer exchange Website to provide the tools necessary for software developers to make contributions to the software repository and to administer their software and their financial and user account.

Primary functions provided by this web site include, for example, a developer code submission tool (which accepts new and updated Policy Implementers software components and inserts them into the code certification process) and code certification tools for third party certification and code review management. It would also provide forms and a question/answer facility for explaining what the Policy Implementer contains and how it is to be deployed.

Configuration information, and configuration management information will be entered through this portion of the Developer Component of the Infrastructure. Completion level and status metrics will be calculated automatically in the Assurance component of the Infrastructure. These forms and question/answer facilities will be integrated into the Policy Implementer Software Development Kits.

In FIG. 14, the developer uses the developer website and/or downloads a set of tools required to develop, test, and submit software in step 1404. Software is then developed in step 1406 and submitted in step 1408 for certification, together with test results. If the developer is updating existing software, then this is indicated, along with an identification of the component being updated. In the certification step 1410, software is subjected to a standardized Policy Implementer Certification (below) process where it is determined in step 1412 whether the software meets predetermined compatibility, security and performance criteria. Where certification fails, the developer is given an opportunity to return to the development & testing step 1406. If the software passes certification, then the software is transferred to the warehouse in step 1414, and made available for distribution. Preferably, development step 1406 is preceded by design step 1418, and design step 1418 is preceded by planning step 1416 as discussed herein.

Policy Implementer Certification and Release

Every Policy Implementer should be safe, secure, and sufficient in function to meet a stated requirement for duty of care for a specifically described policy detection, reporting, analysis, or enforcement element of a policy.

In the certification step 1410, software is subjected to a standardized certification process where it is determined whether the Policy Implementer or Framework software meets predetermined compatibility, security and performance criteria. If the software passes certification, then the software status is changed and the code is transferred to the CODE REPOSITORY and made available for distribution (step 1414).

This step describes the review methodology for certifying a policy implementer. Certification is the process of verifying the functionality produced during implementation and formally authorizing the policy implementer for deployment. Certification involves an independent review of each of the policy implementer components to ensure that the security measures implemented in the components are appropriate for the required level of security and the information being processed.

When networking computers that can access information of financial or personal value that our user/customer or their user/customers have entrusted to a computer system, it is essential that we consider information security and ensure that those components added to our Infrastructure do not diminish the security of that Infrastructure. The utility of this methodology is that the overall value of the solution is not decreased by the vulnerabilities of a component added by internal or outside developers.

Before programs may be placed in the Infrastructure, the source code is reviewed for deficiencies in the areas of security, reliability and operations. This methodology provides guidelines and checklists for certifiers performing the code review, but it also provides development teams with information about what is looked for in a review.

The results of the Policy Implementer Certification process are used as an input to the Audit Step in the methodology. The results are also used for Accreditation. Because of this later use, much of what would be asked later in the Evaluation Step is answered once during the Certification process while proper attention and knowledge are available. The Infrastructure provides the templates for the information required in later steps, and applies them for asking the questions during Accreditation. On the other hand, information gleaned during Certification is not specific to a customer or specific to the network structure and equipment that a specific customer has.

The certification methodology described is designed to be a collaborative process with the use of external resources coupled with internal resources forming a certifier community. The external resources include individuals and teams that are vetted and are unrelated to the developers of the Policy Implementers. The utility of this design is the ability to enlist outside, independent resources and to overlap the execution of certification of Plan, Implementation Description, and Implementer by parallel and integrated certification by several certifiers from a wide set of knowledgeable, competing candidates that often are working on a volunteer basis. Additionally, the separation of effort between certification of Plan, Description, or Implementer code provides for a limitation on exposure of the code to nefarious certifiers, since the vetting process will tend to reject unknown certifiers and will disallow the assignment of certifiers to review code until they have spent considerable effort on certifying Plans and Descriptions.

This approach establishes a negotiation process between the QA management for the Policy Implementer process and the Planners, Describers, and Implementers wherein documentation regarding issues with the submitted Plan, Description, or Implementer code is provided, in part, from the certifier community, and the direct negotiation regarding the repair of the Plan, Description, or Implementer is only between the author and the QA management team—the certifier is not exposed to the author unless they establish contact outside of the process.

The certification process formally analyzes the protection provided in terms of security assumptions and security assertions. A security assumption is some protective measure assumed to be provided within the electronic security domain or context whereas a security assertion is a protective measure included as part of the policy implementer and operating procedures being certified. A security requirement is therefore typically met by one or more security assertions which are reliant upon some subset of the security assumptions.

Certification involves several steps. These steps are provided for example only. Certification can include more or fewer steps as necessary.
Certifier volunteers for role to certify the Plan, Description, and/or Implementer.
Certifier is vetted for conflicts of interest and quality, and assigned to role if vetting is positive. Certifier is provided access to see Plan, Description, and/or Implementer code.
The Certifier studies the policy requirement and understands the context to be addressed by the policy. (This context is a generalization of the environment a fictitious example organization would have and the presumed nature of the organization).
The Certifier studies the Organizational Security policy, policy requirements, and organizational naming plans and understands the context to be addressed by the Security policy and supporting procedures.
The security approaches and measures developed in the Protection Paradigm Hypothesis are confirmed as correct by reviewing the detailed policy elements against the stated, and possibly other relevant, legal and organizational policies being addressed.
The Policy Implementation Plan is validated as promising appropriate and consistent security mechanisms to implement the functionality required by the policies being addressed.
The Policy Implementation Plan and Description are reviewed to ensure they adequately describe the approach and that the security overview correctly reflects the posture identified in the policies being addressed.
Certifiers will consider the Policy Implementer, and reason about its protective abilities in the contexts for which it is defined—its ‘efficacy’. The security evaluation of the policy implementer will confirm that the mechanism adequately protects the information being processed and stored, and that the security measures implemented cooperate as required to provide a well integrated security environment when deployed through the Infrastructure. The evaluation involves:
   Functional Operation. The Policy Implementer is reviewed to ensure that it acceptably perform the required functions as identified in the policy, plan, and description. This is achieved through testing the Policy Implementer's operability, deployability, reporting, handling of parameters, error conditions, and the ability to accept shutdown orders and make configuration changes rapidly.
   Performance. A number of qualitative factors related to security must be considered during the evaluation, including availability, survivability, accuracy, response time, throughput, code quality, and fit with Infrastructure. Performance is normally evaluated by stress testing and monitoring system parameters while increasing system load.
   Penetration Testing. Penetration testing is used to assess the ease of circumventing or breaking the system's security mechanisms, and is the most technically complex of the evaluation activities. While penetration testing is specific to each category of security mechanism, the following are common areas where flaws may be exploited:
      complex interfaces;
      poor programming—vulnerabilities in the code (i.e. buffer overflows);
      use of Infrastructure for security, deployment, reporting, configuration;
      improper database usage;
      confidentiality and integrity controls;
      poor maintenance procedures;
      administration procedures;
      error handling;
      temporary security level changes;
      residual information exposed in memory;
      new features and the interface between new and old;
      control of security information;
      etc.; etc.; and etc.
The Operating Procedures are reviewed to ensure that sufficient procedural security exists to ensure the effectiveness of the security measures implemented in the contexts described and to provide adequate security where security requirements are not otherwise addressed in the context.
Entries in the Infrastructure inventory will be verified against Configuration Management baseline documentation.
As a gauge to determine the sufficiency of the Policy Implementation Description and Implementer, describe a presumption regarding the example organization's preparedness for policy audit after installation of the Implementer.
As an evaluation, state the likely impact of the Implementer on the example company's risk analysis and management abilities. This process provides evidence that:
   an organization using the Implementer will be better able to adhere to its relevant policies and procedures;
   the Implementer and its Plan and Description conform to the requirements of the Policy it addresses; and
   the Implementer and its Plan and Description will be effective in achieving the Policy it addresses.

The process may result in a list of discrepancies and insufficiencies in the Policy Implementation.

A certification report is written by filling out online review forms through the user interface of the Assurance Component of the Infrastructure, and several recommendations are requested/made regarding quality and purpose of the Plan, Description, and Implementer.

In addition to making the process transparent, the utility of this methodology is the enhanced availability to set developer expectation and context to speed the code review process. It also explains some of the coding practices and common mistakes made.

The certification participants should remain nearly constant from review to review, version to version of the SAME Implementer, but some additional certifiers assigned to the Implementer as it matures will tend to keep up the quality and the innovation in this methodology.

Presentations for certification reviews can be online and assisted by diagrams presented that are stored with the documentation. The reviews will include, for example, the Plan, then Description, then Implementer being presented in order. Each portion should be presented by a group member who is qualified and able to answer technical questions about the Plan, Description, or Implementer. The presentations will be recorded by the Infrastructure for later review.

After the initial presentation, much of the evaluation process is handled privately by the parties, but secondary, on-line meetings with multiple parties may be held and managed through the Infrastructure.

No voting or wide agreement is needed by certifiers, since the Infrastructure manages the scoring of the certification review recommendations. Documents and code which are altered between reviews will be shown to certifiers by an automatic change annotation facility provided by the Infrastructure to ease understanding.

An example of a basic outline of the certification review process is:
Policy Understanding
   Basic Policy Requirement
   Protection Paradigm
   Requirements Context and Naming
Context Understanding
Approach Understanding
   Identify risk evaluation methodology
   Rank, order, and define risks and impacts (i.e., low, medium, high)
   Prepare Risk Analysis Report identifying:
   Threats and vulnerabilities,
   Proposals and evaluations of countermeasure effectiveness,
   Countermeasures trade-offs (performance impact versus cost versus security), and
   Residual risk
Plan Evaluation
   Goals and Objectives Overview
Description Evaluation
   Architectural Overview
   This overview will include a diagram of the approach being implemented, and the place of the Implementer under review in the system. The Architectural description of the system will also provide a data flow and a functional overview. The functional overview should include information about what threats the code is expected to deal with, and how it will deal with them.
Implementer Evaluation
   Functional Summary
      Installation Requirements & Environment
      The install procedure must be documented. Do we need to run any scripts to set up directory hierarchies? What will the permissions and ownership be on the installed files?
      How to invoke.
      What are the configuration files and settings? Are there arguments that the program expects? Does it expect environment variables to be set?
      Inputs, Outputs, Events, Alerts, Plans, etc.
      The Infrastructure or other objects used by or produced by the Implementer.
      Options & Configuration Files
      A complete description of all command line options is required. A complete description of the configuration files is required.
   The Infrastructure will store all of this information as part of the Policy Implementer development.
Code Review:
   Does the code look like it is well written and will work according to the description?
Code Test
   Does the code execute according to the description?
Compatibility Test:
   Does the policy implementer interfere with other components of the Infrastructure, operating systems or with the execution of other policy implementers.
Overall Evaluation
   Identify unconsidered risks and countermeasures
   Determine residual risk and assess portion of risk remaining after all countermeasures are applied:
      Where no countermeasures exist,
      Where countermeasures are insufficient, or
      Where countermeasures are pending and their schedule
   Recommend additional countermeasures and rank them by cost effectiveness

Certifiers will assess a degree and a characterization (type) for each Implementation issue.

The Infrastructure will automatically determine the adequacy of a certification based upon Certifier self-assessments and workflow a completed certification back to the Assurance Management team.

Certifications add to the documentation of the Implementation. The utility of the Certification Step is that it provides a tool to clarify Implementer compliance using gap analysis between the “ideal model” as specified in the plan, and the current implementation. It also assists in polishing the Policy Implementation Plan and Description, and the Policy Implementer by stating a list of necessary remedial actions.

In this methodology, Certifiers can perform the following tasks, for example:
Analyze problems and issues
Develop recommendations for improvement
Validate improvements
Request additional information
Request clarification of algorithms and/or results, and
Request greater detail in testing, reports, or other documentation
Define and require certain improvements
Demand corrective and preventive actions

In exchange they accept the responsibility to make the certification decision and decide whether to provide their certification

Over time, after the completion of the Certification, the extended certification record will be open to additions by certifiers for an Implementer. Comments added into this extended record may include, for example:
Reviews of relevant new threats and vulnerabilities;
Additional legislative directives and their impact on the certification;
Information regarding different protection approaches, defenses, and countermeasures;
Suggestions on changes to the review, assessment, and analysis posture; or
Identified needs for modification of policies, Policy Implementation or procedures.

When the Implementation is published to external users, a similar record will be provided for comments by the public. The utility of the separation is the additional endorsement assigned to the Certifiers record and the ability to use any change to the separate record as an impetus for notifying appropriate parties that important information has been entered.

Certifiers will be notified automatically by the Assurance Component of the Infrastructure when changes are made to the Policy addressed by an Implementation in this methodology. Certifiers may also identify a need for recertification and report that need based upon, for example, any of the following indicators:
Change in criticality and/or sensitivity and/or security policy
Hardware changes, or upgrades impacting countermeasures
Software (operating system or applications) additions, changes, or upgrades
Threat change creating a system vulnerability resulting in a higher risk
Mission changes requiring a different security mode of operation
Breaches, or unusual situations that reveal flaws in design exposing a vulnerability
Defective operating procedures
Configuration problems
   People and Tools

The Assurance Management team is responsible for continual process improvement of the methodology, and for continuous enhancement of the facility. They are also responsible for the specific reviews and specific certifications and their results, and for the assurance overall of the operation of the Infrastructure. The Assurance Management team is also responsible for the vetting of Certifiers. The certification process should itself vet the products of the Policy Implementation process steps in this methodology.

The Developer Component of the Infrastructure provides an information website for those wishing to participate in the planning and development of Implementers. The site also provides tools for development, including Configurators, Software Development Kits, quality testing tools for Implementers, and sample code.

The Configurators also provide the facilities to provide the Implementers for sale through the Infrastructure.

The Open Source model is followed where practicable, but incentives of various types will be offered in the methodology and e-commerce mechanisms are a part of the facility.

The Developer Component of the Infrastructure provides a developer community member the opportunity to contact and connect with others who wish to volunteer or to offer an Implementer for sale. The Developer Component has a search mechanism for concepts needing work, and for concepts being worked on by others where participation is needed. Those eager to get started may also post a message to the ‘board’ asking what people would like to see done to stir interest. Developers may post anonymous resumes on the ‘board’ to offer their services in the development process. Certifiers are often recruited off of the board.

The Assurance Management team may also:
Evaluate changes to the certification process;
Develop certification tools, analysis techniques, and documentation tools for the Assurance Component of the Infrastructure;
Conduct shadow certifications as an audit facility; and
Determine remedial actions for certification process problems
   Preparation for Deployment

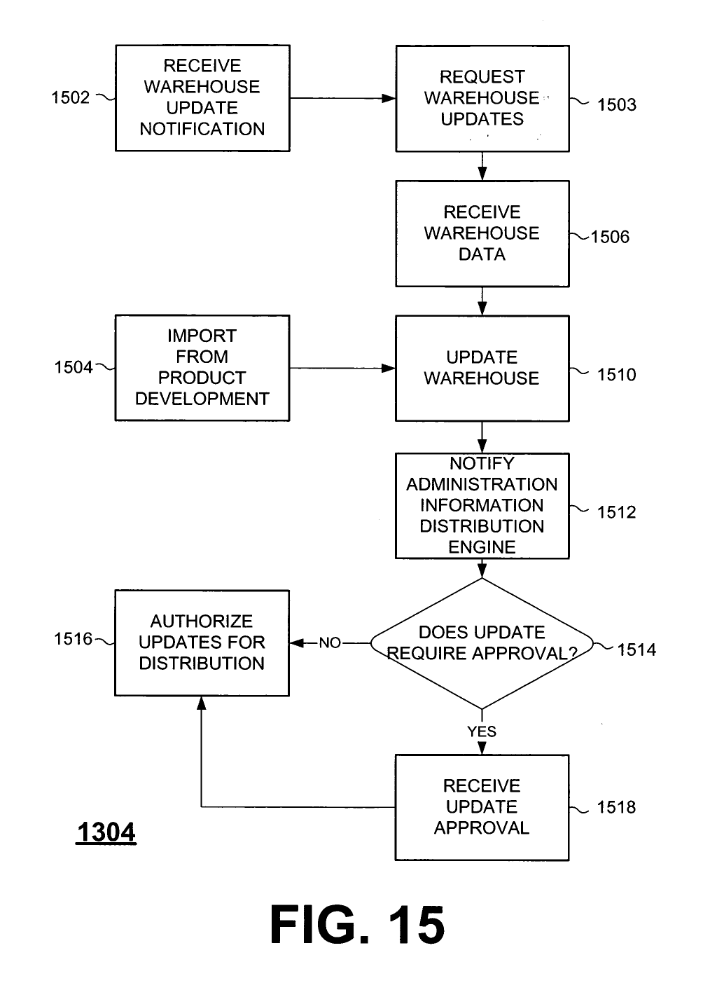

FIG. 15 is a process flow chart for the code warehousing process 1304 shown in FIG. 13, according to one embodiment of the invention. Warehoused software is placed into a CODE REPOSITORY and can be propagated from parent systems (in a tiered CODE REPOSITORY structure), or can be imported directly as a result of the product development process in step 1504. If the software is imported through product development, the current CODE REPOSITORY is the top level (i.e., the source) for that software.

Accordingly, the controller can receive a notification that there is a software update available in step 1502. In one embodiment, this notification triggers an update request in step 1503. Alternatively, or in combination, an update request can be generated on a scheduled basis. Either way, the local controller requests the CODE REPOSITORY updates, and updates can be downloaded from the parent CODE REPOSITORY system. Alternatively, new software can be added to the CODE REPOSITORY as a result of the standardized product development process.

Once software is updated in step 1510, the administrative information distribution engine is notified of the updates in the CODE REPOSITORY in step 1512. Where the update is merely a revision change, approval may not be required. In other cases, for example where the update is a new software component, approval (step 1514) from the administrative information distribution engine is required in step 1518 prior to authorization for distribution in step 1516.

Framework and Policy Implementer Sales

Infrastructure Establishment

The first step in the operation of the system is the Customer Relationship establishment process. This process involves the recording of the Customer and the initial security information for the customer.

The operation of a Policy Implementer is normally dependent on the presence of an Infrastructure but it is not a requirement to offer Policy Implementers only to enterprises who have or will have the Infrastructure installed. The Service Provider Model (Application Server Provider) provides for the case where the Infrastructure Framework is not installed by the customer beyond the client system.

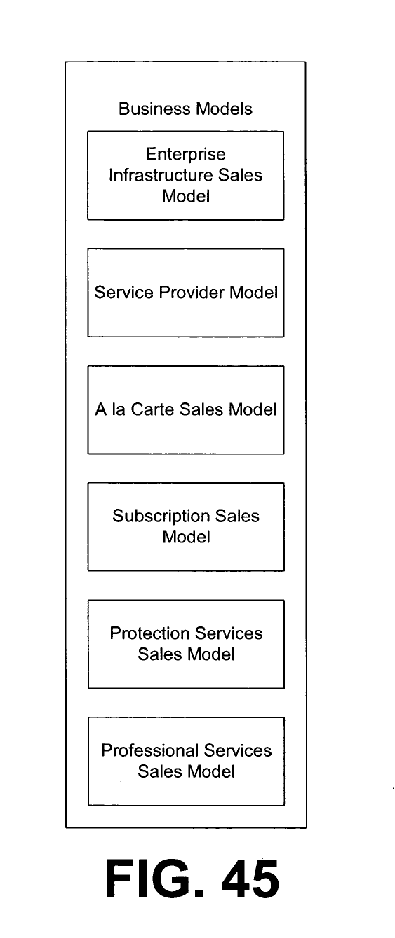

FIG. 45 is an illustration of business models, according to an embodiment of the invention. As shown in FIG. 45, the business models provided by this business process may be:
Framework Sale: Enterprise Infrastructure Model where the infrastructure framework is licensed to an enterprise or organization for use on one or more computer processors, with unlimited use of one or more specified Policy Implementers;
Non-Framework Sale—Service Provider Model: Application Server Provider where the infrastructure is used by multiple customers and where either Protection Services, Protection Insurance Services, or Policy Implementers are provided at a fee;
Non-Framework Sale—Subscription Model: Subscription sales where one or more Protection Services and/or one or more Policy Implementers are provided at a fee;
Non-Framework Sale—ala Carte Model: ala Carte purchases of additional function where one or more Protection Services and/or one or more Policy Implementers, selected without being a part of a subscription, are provided at a fee;
Services Sale: Providing services for customization and or custom development of protections.

The sale of a Protection Service is a transaction where a fee is paid in exchange for the tools needed to protect against a specific threat. The sale of Protection Assurance is the sale of an insurance policy stating that specific threats will not have an impact on the devices or network protected by the facility utilized to effect protection.

The Business Process presented in this application includes, for example, the processes of:
Prospecting for sales by network analysis method used by prospective customer;
Offering Infrastructure for sale;
Delivering/deploying Infrastructure;
Offering one or more subscriptions consisting of zero or more Infrastructure and one or more licenses to cover one or more known devices or networks for protection by an Infrastructure which is either covered by the subscription or is provided on an Application Service Provider basis;
Offering one or more licenses to cover one or more known devices or networks for protection by the Infrastructure;
‘Sanctioning’ or applying a license to a known device or network for protection by the Infrastructure;
Developing Policy Implementers for sale;
Accepting Policy Implementers for sale;
Offering Policy Implementers for sale;
Delivering/deploying Policy Implementers;
Configuring Policy Implementers;
Licensing and authenticating Policy Implementers;
Managing Policy Implementers;
Authorizing operation of Policy Implementers;
Authorizing communications operations and receipt of information from Policy Implementers;
Updating Policy Implementers;
Upgrading Policy Implementers;
Prospecting for new devices to license within a customer network;
Offering Protection services rather than Policy Implementers;
Entering information into the E-Commerce Component of the Infrastructure.

The E-Commerce Component of the Infrastructure is supported by the Data Structure.

E-Commerce Process

Registration

Initial Customer Registration—Framework or Non-framework

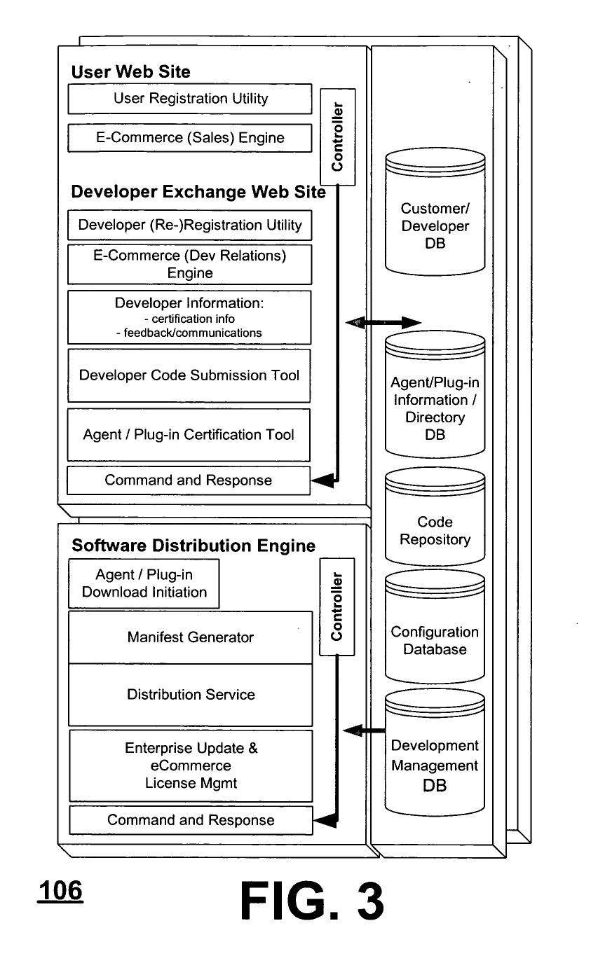

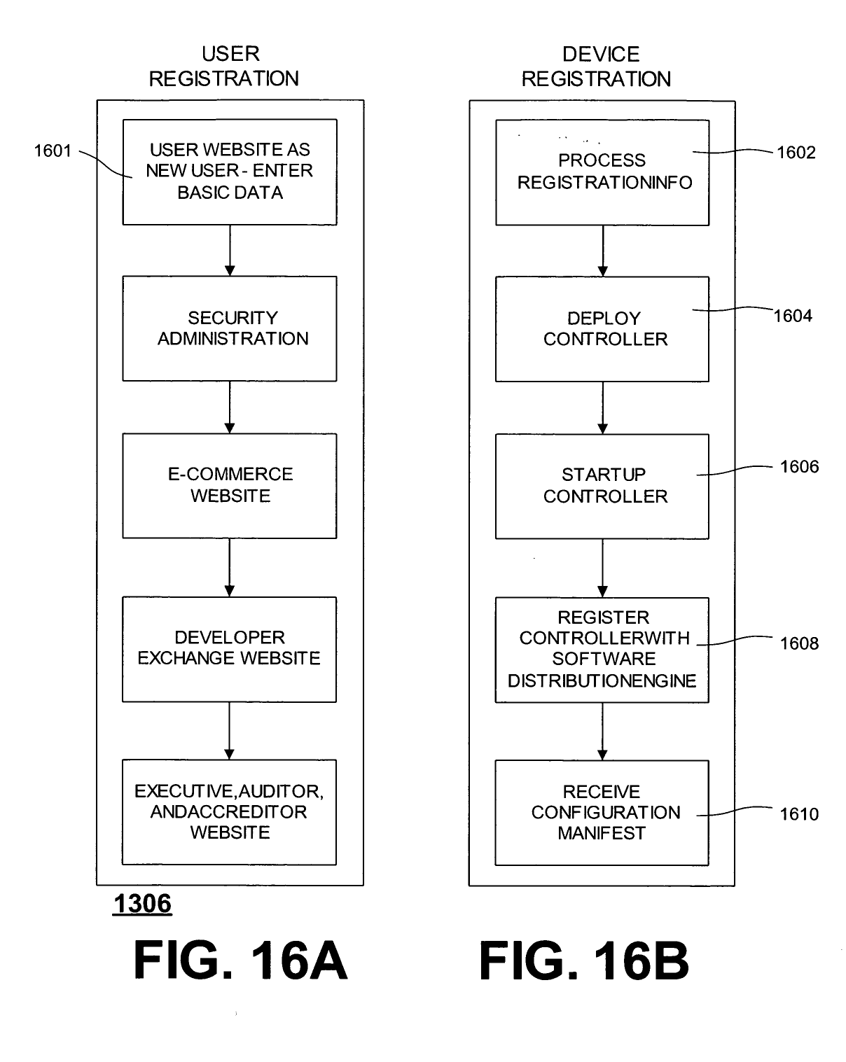

FIG. 16A is a process flow chart for the user registration process 1306 shown in FIG. 13, according to one embodiment of the invention. The process begins by collecting registration information in step 1601 from the customer after they begin using the customer website. Their personal and organizational information is persisted to the Data Structures as shown in FIG. 3.

Initial Device Registration—Framework or Non-framework

FIG. 16B is a process flow chart for the device registration and sanctioning process shown in FIG. 13, according to one embodiment of the invention. The process begins by collecting registration information about the device either from prior discovery and inventory information, from the customer, or from the device itself in step 1602. The approval of this information may be processed through the workflow process or may be granted automatically, depending upon global settings, through the Sanctioning section of the Distribution website.

Next, in step 1604, based upon the user's approval, a generic controller installer is packaged and deployed to the client system which the user has decided to protect. The user initiates the installation request from that device after customer log-in at that device to the Sanctioning section of the Distribution website, according to one embodiment of the invention.

Automatic controller installation may also be accomplished, according to one embodiment of the invention, by scheduling one or more ‘Sanctions’ through the Sanctioning section of the Distribution website and using an automatic ‘logon script’ or other automatic scripting tool for installing the controller in an automatic fashion to multiple devices simultaneously. In this case, there is no operator at the device being deployed to.

Upon completion of download, the controller is automatically extracted and installed from the downloaded package. Upon start-up, the controller gathers system configuration information, logs into the distribution engine and provides the information to the distribution engine in a secondary device oriented registration step 1608. In turn, the distribution engine prepares a controller manifest (see configuration, below) based on the configuration information, which is then received by the controller in step 1610, and the controller reports in to its management component in the final step. This completes the process of registration in preparation for e-commerce purchases.

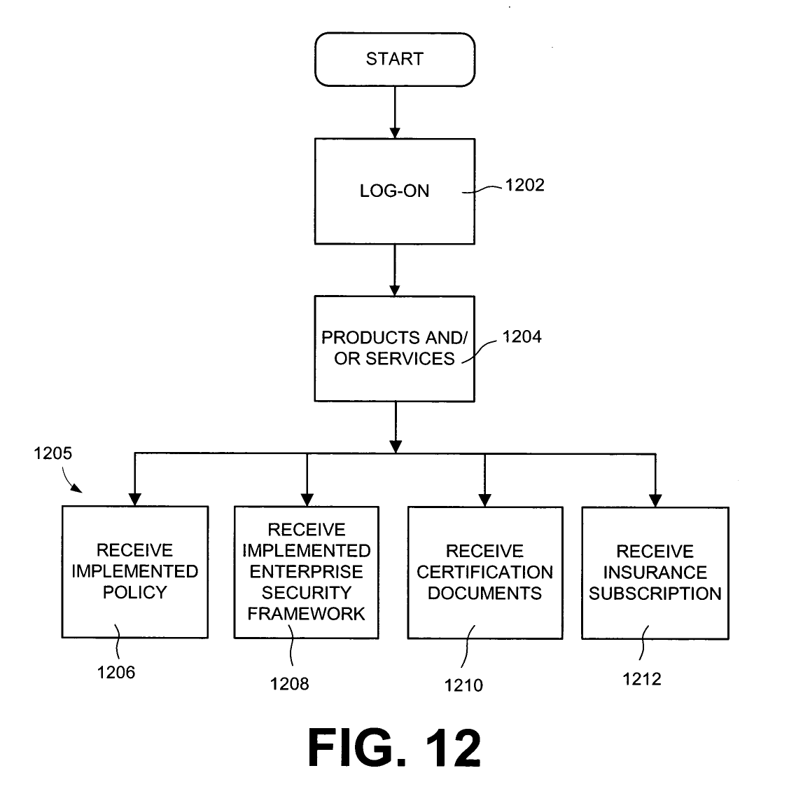

FIG. 12 is a process flow chart for an e-commerce transaction from the perspective of a customer, according to one embodiment of the invention. After the registration process above, the process continues when the customer logs onto an E-Commerce Component of the Infrastructure, for example via a Web portal in step 1202. Next, the customer reviews a catalog menu or other list of products and/or services, for example policy options, and selects the policy(ies) or other product or service in step 1204 that they desire to implement on their network or devices. They then search the list of Policy Implementers associated with the selected policies for purchase and to have installed on their network-based system. The customer then receives one or more deliverables from the e-commerce transaction 1205. For example, as shown in FIG. 12, the customer may receive: an implemented policy 1206; an implemented security framework 1208; certification documents 1210; and/or an insurance policy (according to predetermined terms) 1220. Such a transaction is enabled by the processes broadly depicted in FIG. 13.

Framework Sale and Distribution Process

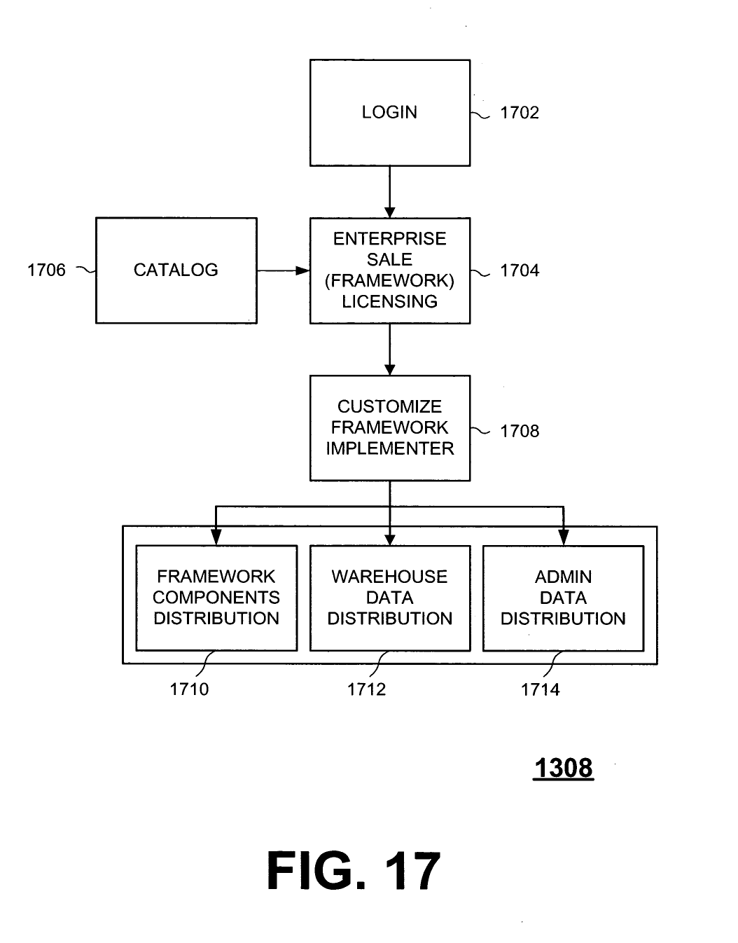

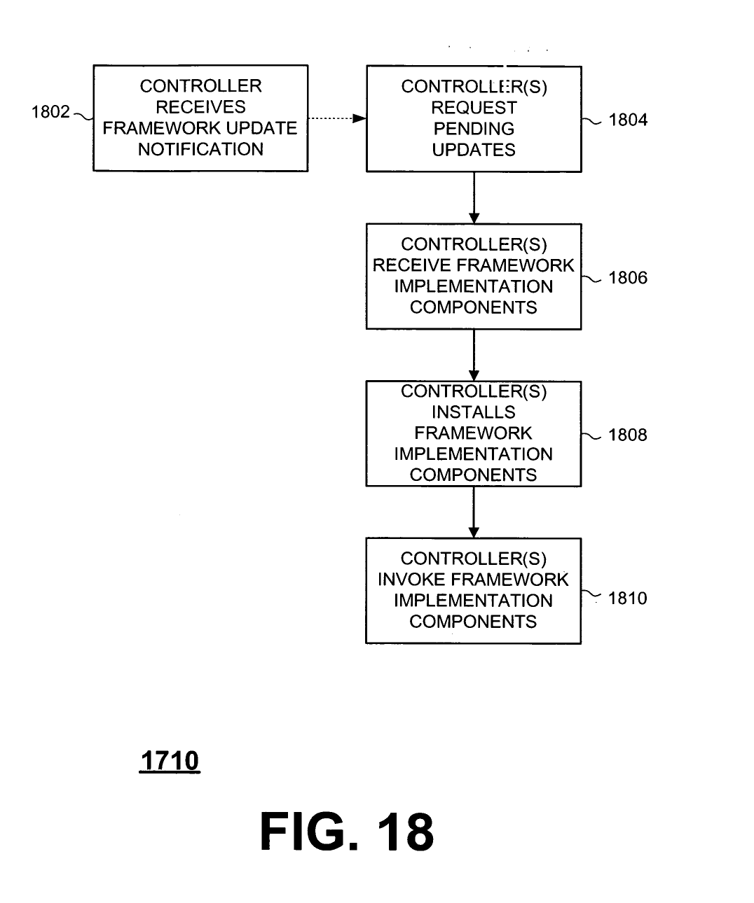

FIG. 17 is a process flow chart for the e-commerce transaction 1308 shown in FIG. 13, according to one embodiment of the invention. In particular, this embodiment involves a framework sale. A framework (or enterprise) sale can be initiated in step 1704 after customer login 1702. A menu of framework components are from a catalog 1702, which is based on products available in the warehouse. Once the sale has completed, a framework implementer is customized in step 1708 according to the configuration of the target host system, and the implementer distributes the purchased framework components in step 1710. The framework implementer likewise may trigger the distribution of warehouse 1712 and administrative data 1714, as shown.

Policy Implementer Sale and Distribution Process

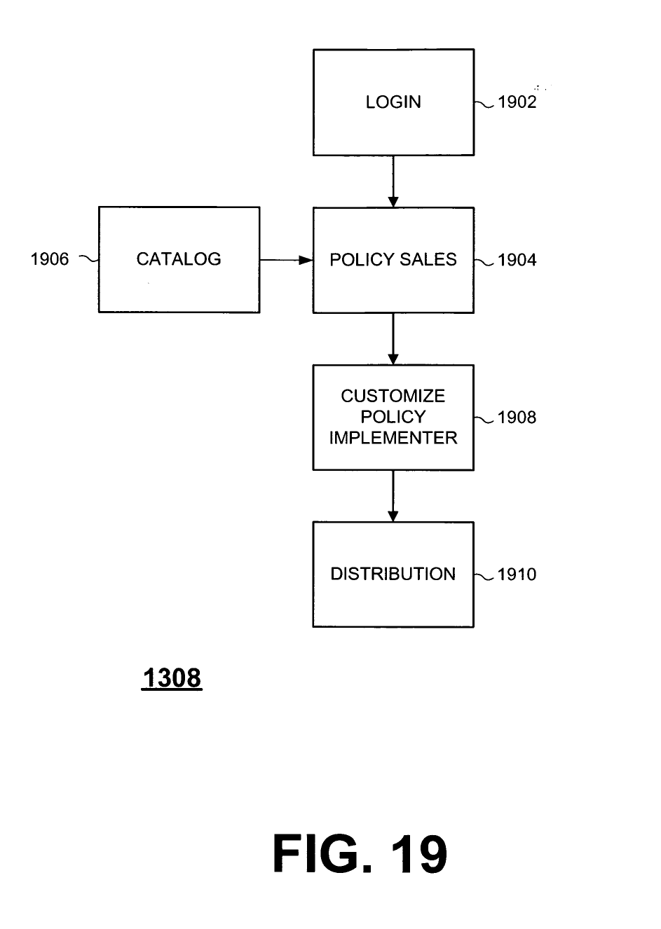

FIG. 19 is a process flow chart for the e-commerce transaction 1308 shown in FIG. 13, according to another embodiment of the invention. The result of the transaction is that one or more Policy Implementers become active on the user device or network. A user is prompted to login in step 1902. Like the framework process above, a user is presented with a menu of choices, here, policy choices in step 1904, based on products available in the warehouse catalog 1906. A policy implementer is customized in step 1908 based on user selections and the configuration of the target host system. Controllers retrieve agents, plug-ins, or other components of the selected policy from the warehouse, via the distribution service 1910, as described above with reference to framework components.

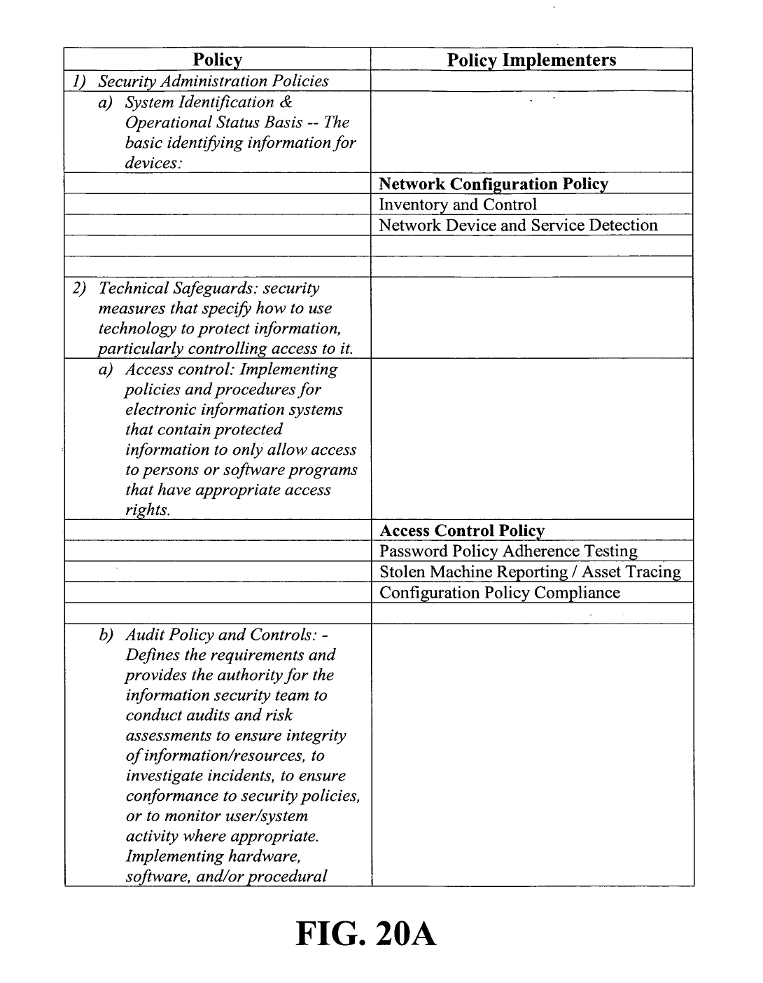

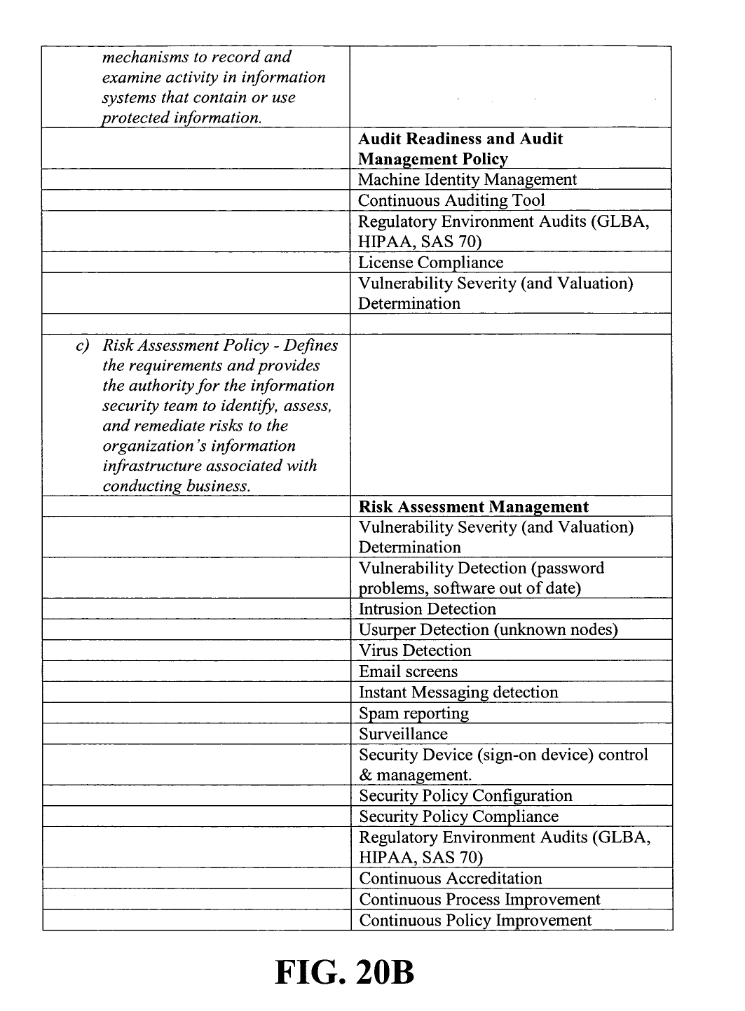

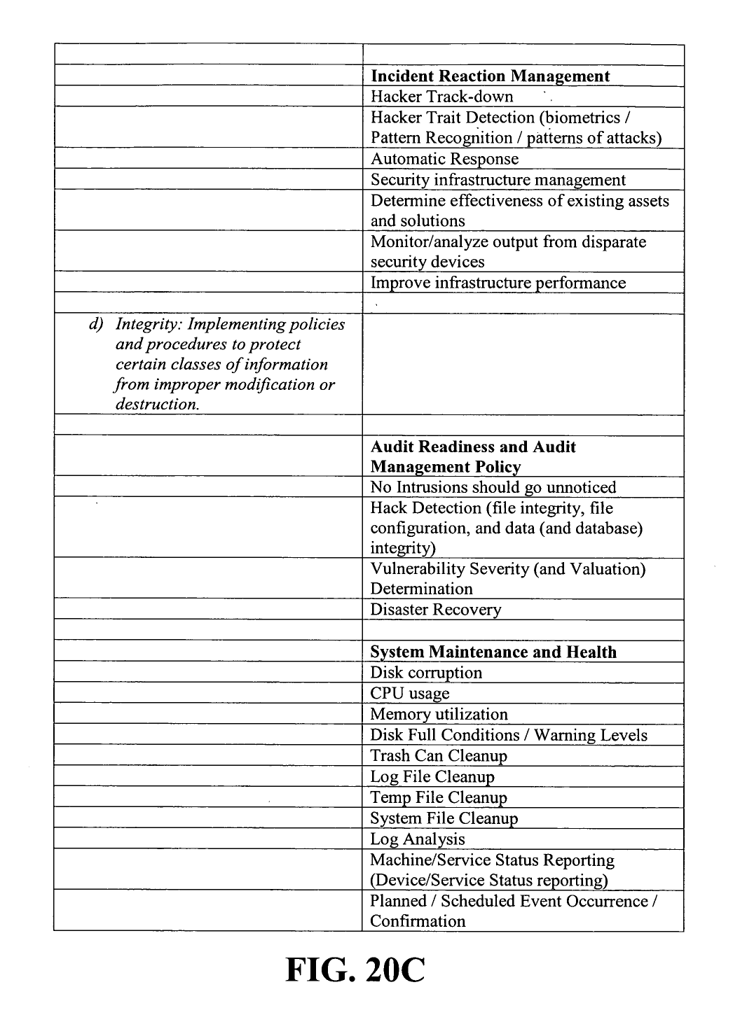

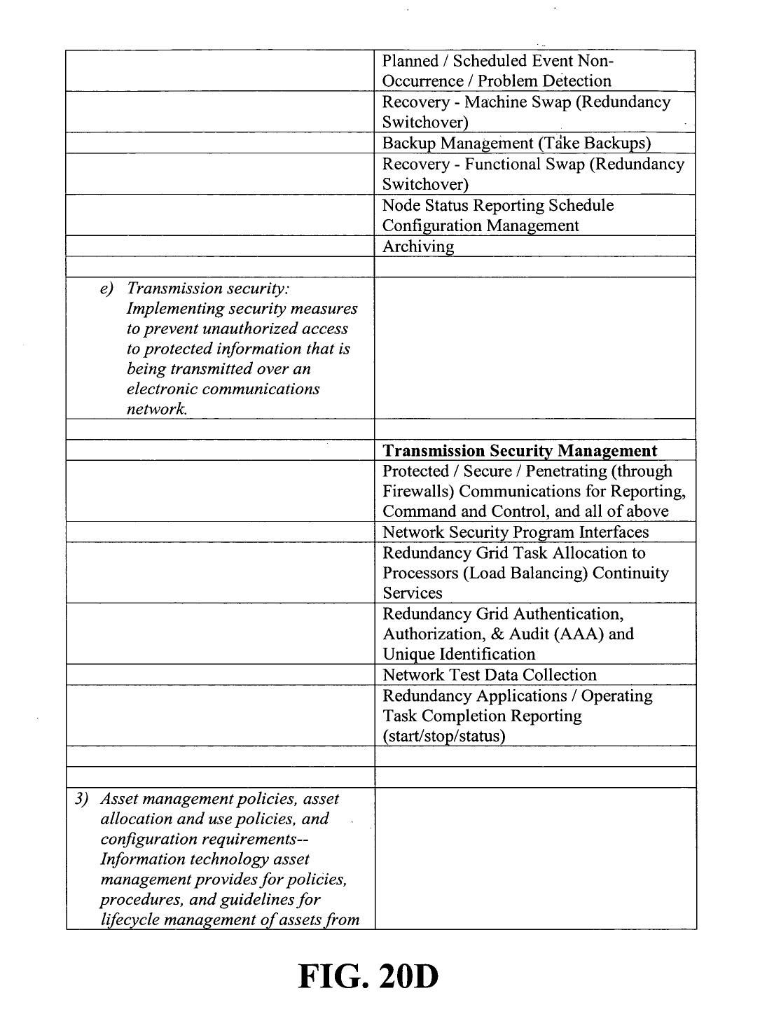

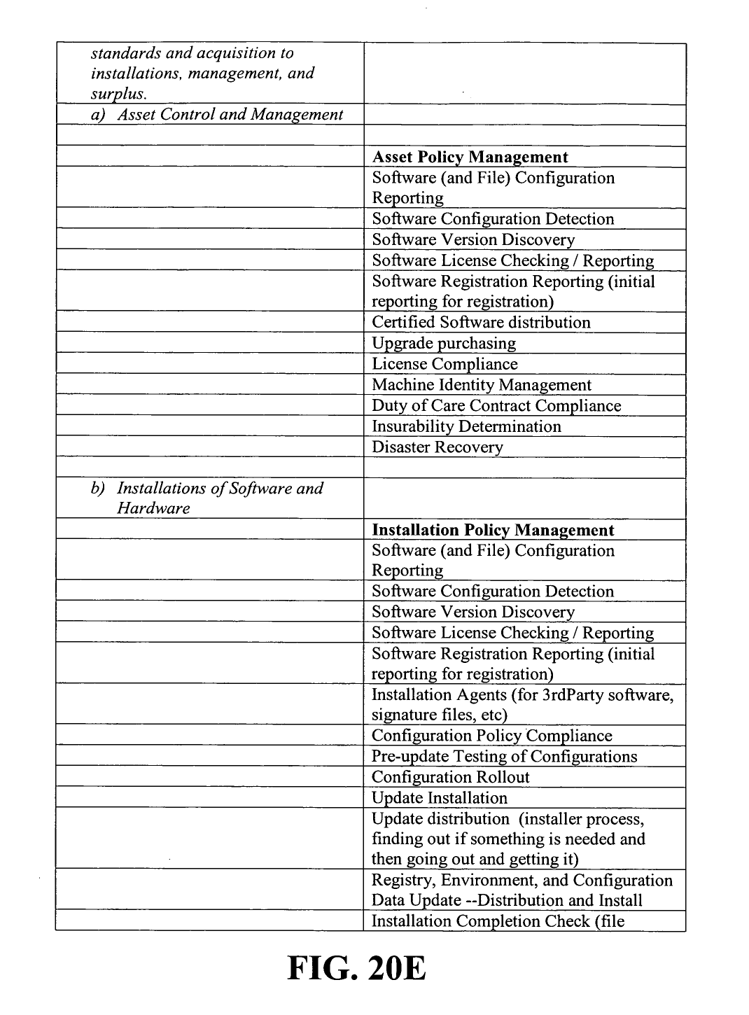

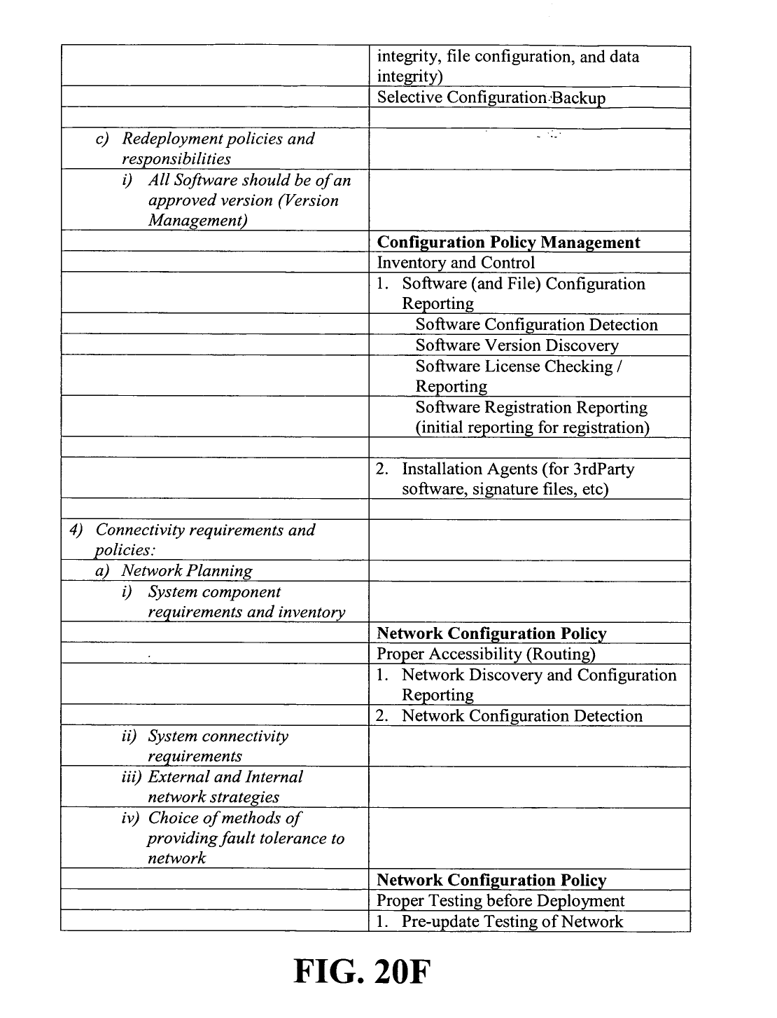

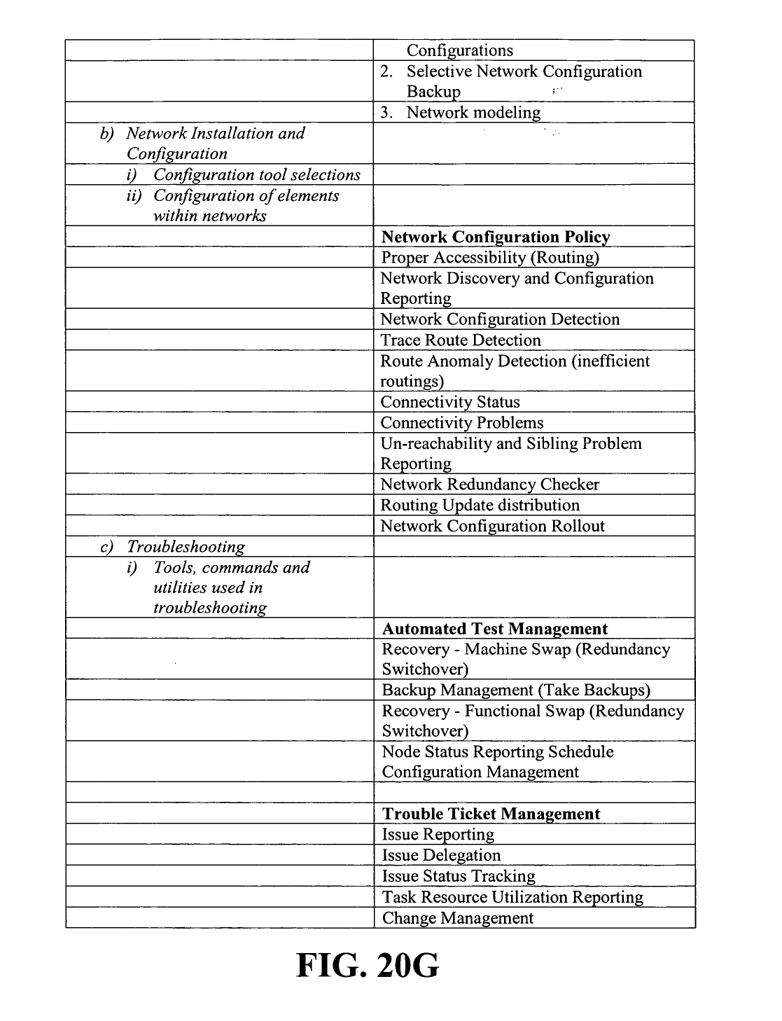

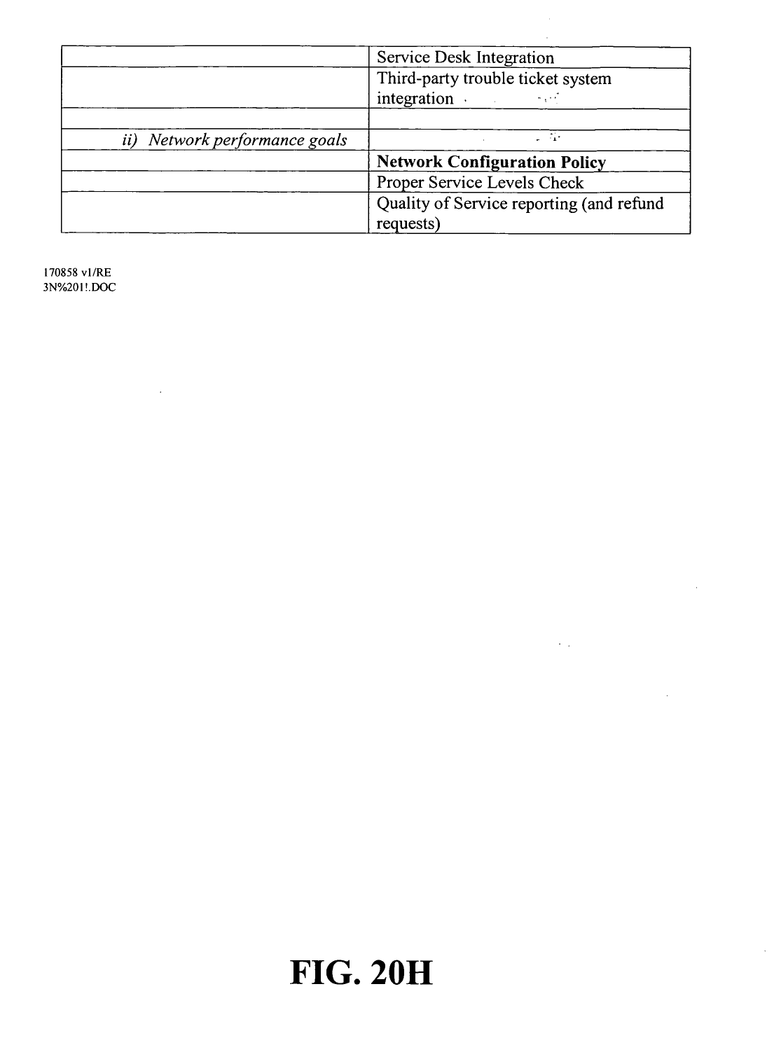

FIGS. 20A-H are illustrations of a table mapping policy choices to policy implementers, according to one embodiment of the invention. The left column provides examples of policy selections available to a customer. The right column indicates the policy implementer components associated with each of the example policy choices. Other policy/implementer combinations are possible.

Services Sale Process

Services consist of standard consulting and are accomplished by contract.

Third Party Sales

FIG. 13 is a process flow chart for supplying Policy Implementers from the perspective of a 3rd party service provider, according to one embodiment of the invention. To be available to a customer, the 3rd Party Policy Implementer must be completed and certified prior to a related e-commerce transaction 1308 (whether for framework or policy), as described above from the customer's perspective. Accordingly, a service provider first develops products in step 1302, then warehouses the developed products in step 1304. As shown in FIG. 13, a registration step 1306 is also a prerequisite to the e-commerce transaction 1308.

Licensing and Security for Infrastructure

All users of the user interfaces of the system should be registered to move beyond the basic informational elements of the websites of the system. All devices that connect to framework components must be registered and known by the components to which they connect.

All Infrastructure components must be sanctioned to serve as a component of the system framework other than ‘external devices’. The sanctioning process is distinct from the licensing process as it applies to the operation of a certain framework component on a certain device.

All Policy Implementer components should be installed on devices that are covered under a proper license for the Policy implementer to operate or to be deployed.

Distribution

Policy Implementer Distribution is implemented by the Distribution Component of the Infrastructure. Distribution of Framework components may be carried out in a similar manner. The distribution is begun when a new sanction, license, or update occurs.

License Distribution

Licenses and sanction information are established in the database of the Parent Administration Component, and are then deployed to all databases toward the user devices which they affect.

As a result of device registration, the device becomes a member of an asset-group of sanctioned devices. Licenses for the asset-group may then be applied to the operation of Policy Implementers on the device.

Authorization for distribution also allows for a child distribution engine to receive new versions of code as it is released, so long as the number of licenses for that code in ‘asset-groups’ below that distribution engine is greater than one and so long as the distribution engine remains in contact with the parent administration system. Authorization to operate and authorization to submit data to management nodes are controlled in a similar license based control facility.

Data Distribution

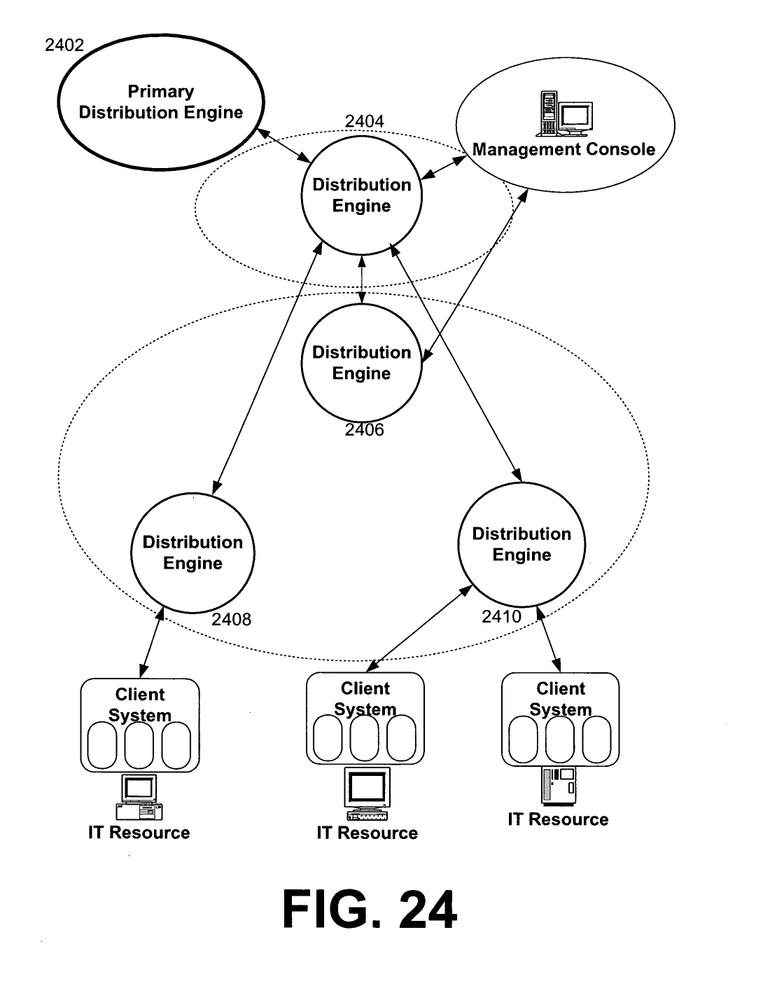

Base data and the database objects (stored procedures, data structure definitions, etc.) for the Infrastructure are deployed automatically by the Tiered Database Deployment facility of the Infrastructure. This facility consists of the elements shown on FIG. 3. The process involved in Tiered Database Deployment is shown in the process diagram in FIG. 24.

License and Sanction data is distributed by the same facility as Base Data. Security over the distribution is strict, and is aimed at automatic distribution and 100% correctness of result in all cases. An incremental distribution based upon a differential calculation is used to shorten the timeframe for distribution and to reduce bandwidth. The distribution is carried out between databases directly where possible so that the differential may be computed quickly.

Deployment Management

The SOFTWARE DISTRIBUTION ENGINE (see FIG. 3) is responsible for managing all software deployments in an implementation of the SYSTEM. It maintains knowledge of currently deployed components as well as associated version and configuration information with the Component Management facility. Utilizing the DISTRIBUTION SERVICE, it also processes update requests from child systems, and serves updates when requested by those child systems.

Software is stored in the CODE REPOSITORY, which also contains current version and release information for each software component. This information is used to ensure that proper updates are deployed by comparing the version requested against it.

When software is prepared for distribution, the resulting package includes Software and possibly other files which could variably contain Configuration data and Manifest information. The software is encrypted with a key that is used to authenticate and unpack the software component when the component is installed.

When software changes, a list of Controllers affected will be created by the Component Management element which is read by the Download Initiation service which then informs the relevant Event Managers to inform the Controllers to check in for new software and/or configuration information.

Component Deployment and Installation

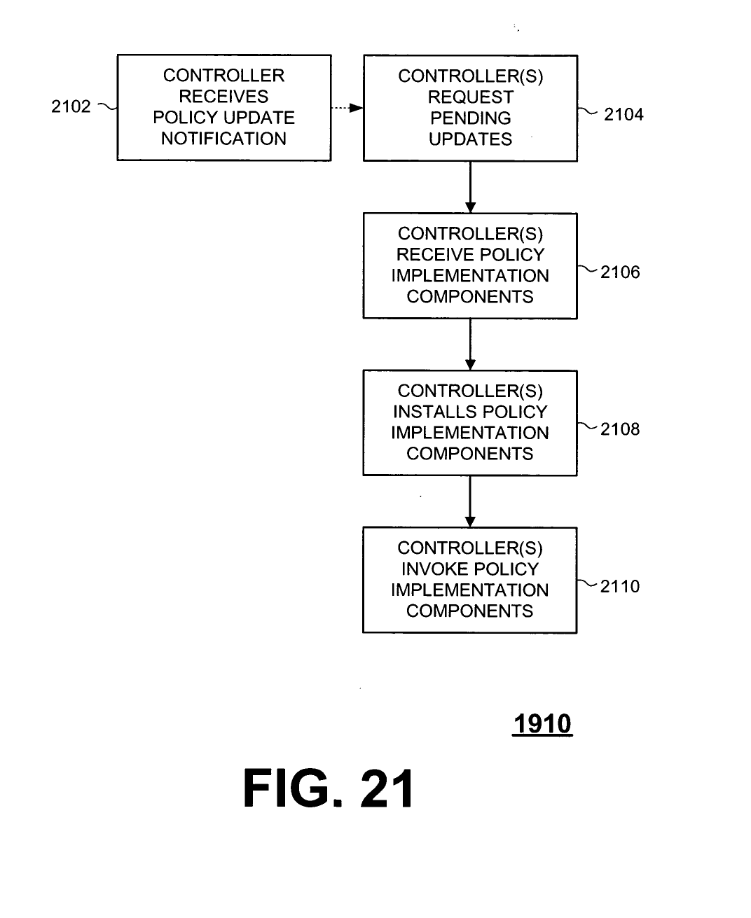

FIG. 21 is a process flow chart for the distribution process 1910 shown in FIG. 19, according to one embodiment of the invention. The process begins when the controller receives a policy update notice in step 2102. The controller will request pending updates from the distribution service in step 2104, and receive the updated policy components from the distribution service in step 2106. The controller then installs (step 2108) and invokes (step 2110) the policy implementer components.

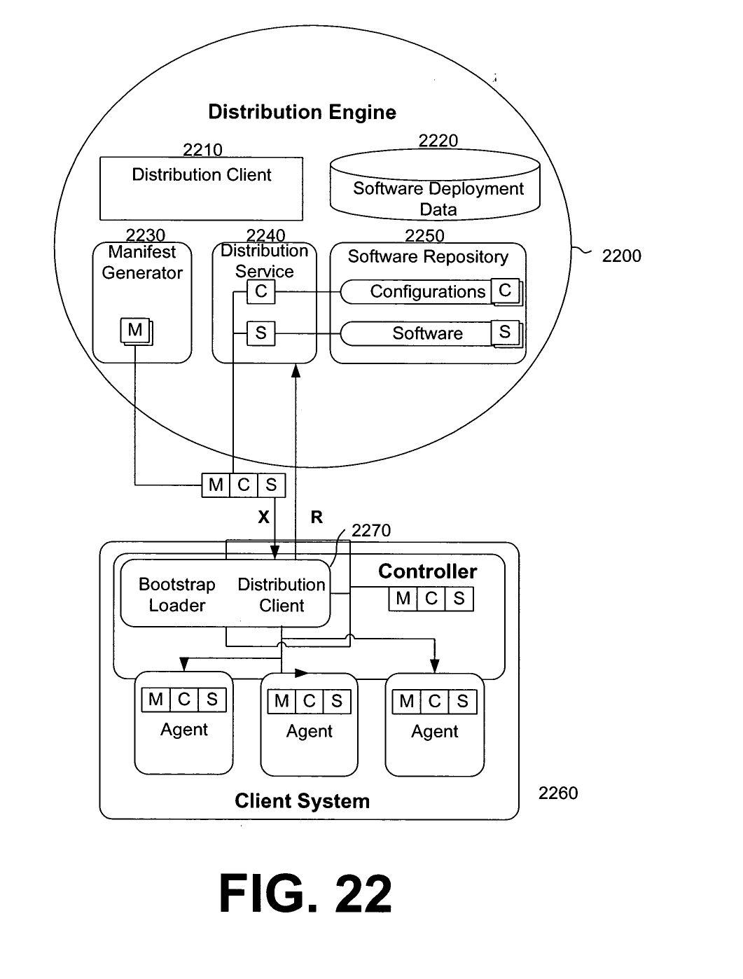

FIG. 22 is a block diagram of the distribution process shown in FIG. 19, according to one embodiment of the invention.

At the core of the Infrastructure is an enterprise-caliber software distribution platform capable of maintaining all Infrastructure components. It handles the automatic deployments of software and configuration releases for all Components—including agents, processing plug-ins, rule sets, templates, and output plug-ins—that are distributed throughout the network. The platform is naturally suited for scalability and network growth. This extensible architecture can easily incorporate configuration management of non-Infrastructure components as well. Support for release archival and rollback allow for robust failure recovery. Integration with the management console and wizard-based GUIs provide administrators with powerful remote management capabilities. In short, the Infrastructure provides a fully featured, robust software distribution platform designed with the Infrastructure components in mind, but extensible to embrace traditional software as well.

The heart of the distribution mechanism lies in the Distribution Engine 2200, as shown in FIG. 22. Each Distribution engine consists of components that work together to provide scalable and reliable software distribution: Distribution Service 2240; Distribution Client 2210 (in the controller); Code Repository 2250; Component Deployment Data 2220; and Manifest Generator 2230 web services.

The main component that coordinates the process is the Distribution Engine 2200. Its main task is to handle incoming requests from Distribution Clients 2270 within Controllers. Controllers know how to communicate with the Distribution Engine 2200 and abstract that complexity from the component where it is embedded. Controllers can send different types of requests, but the most common are requests for software or configuration release updates.

Each Distribution Engine Component Management Database provides the configuration and deployment data regarding what needs to be delivered to the Client 2260. The engine maintains a directory of all the devices and plug-ins that it manages, along with configuration and deployment data for each. This plug-in deployment data contains information about the plug-ins' type, location, software release, and configuration release, among others. Using this data, the distribution service applies business logic to determine what updates need to be delivered to the client 2260.

Software releases are all managed by another component called the CODE Repository. This repository is a version control system that is specially tailored to manage all versions of component code. It not only manages various software releases of a component, but also configuration releases as well, allowing administrators to rollback to previous releases if necessary.

Assuming that there are new updates, the Distribution Service returns a message to the CONTROLLER telling it what components and which releases are available. The CONTROLLER then communicates directly with the CODE Repository, downloads all changes, and initiates its update process.

Components request and receive updates through their Controller interface. As updates are received, the Controller notifies the affected Components. Components then handle the notification by installing the updates and reloading any affected code or configuration data. Controllers are configured to maintain a backup of the existing state of a Component prior to deploying an update. That way, rolling back to the last known good state is possible in order to recover from a failed install or update. In addition, Components can also request to rollback to an archived release if necessary.

FIG. 24 is a process flow chart showing a distribution hierarchy, according to an embodiment of the invention. For larger networks, distribution engines 2402, 2404, 2406, 2408, 2410 can be scaled and tiered to provide a manageable framework for software distribution. Distribution is performed top-down in a hierarchical manner, where the engines are logically arranged essentially as a hierarchical tree (as shown in FIG. 24), with redundancy. Distribution engines regularly communicate via the distribution client with their parent engine asking it for any software updates that are available. Updates are pulled down from the parent and persisted in the engine's local CODE REPOSITORY. Base Data and License is pulled down and stored in the DATA REPOSITORY. At leaf nodes, Controllers retrieve these updates the next time they query the distribution service.

Using this pull-down approach, software updates propagate down the hierarchy from the root as each child engine asks for updates. At the root of this distribution hierarchy resides a “master” distribution engine 2402 where copies of all the software, base data, and licenses for all the Controllers beneath it are stored. Each Infrastructure implementation may have one or more master engines at a customer site that serve this purpose, and additional masters may reside elsewhere.

The last step in distribution is Configuration. The startup of the installed component may not occur until the component manifest is received. Manifest distribution is a special form of configuration and task deployment, described in the following section.

Startup

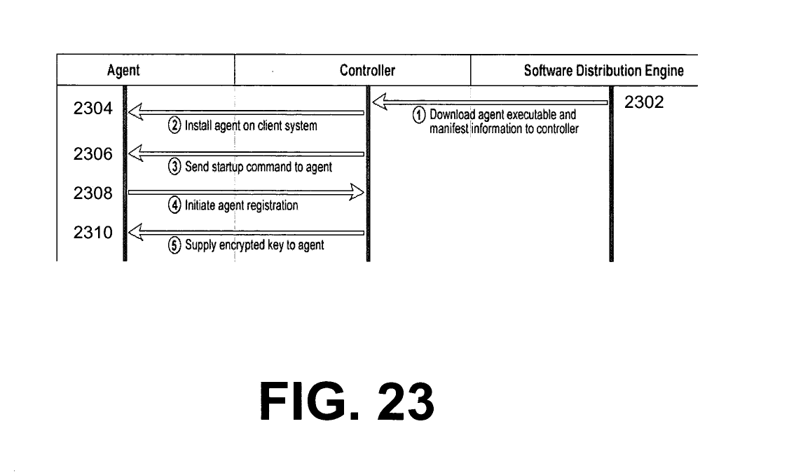

FIG. 23 is a messaging diagram for agent start-up, according to one embodiment of the invention. As mentioned earlier, the controller is responsible for the lifecycle of the Policy Implementer element's (an agent here) execution. The lifecycle begins with downloading 2302 the agent to the client system and installing 2304 it in the controller. The framework provides an automatic installation and update mechanism to simplify this process for the administrator in step 2306. Once the agent is installed and ready to operate, the controller loads it and initiates the registration process in step 2308. Each agent must register itself with the system in order to receive the permission and credentials to operate. During this negotiation process, the agent provides the controller with some identifying information, and the controller determines if this agent has the rights to operate. Rights could be revoked for many reasons, including expired subscription, invalid credentials, or insufficient resources. The controller makes this decision after consulting with the system's runtime configuration database. After the agent is given the approval to run, it is assigned an encrypted key by the controller 2310. This key is then used for subsequent interaction with the controller to ensure that requests coming from the agent are authentic.

Another important responsibility of the Controller is keeping software on the host system up to date. Rather than the traditional approach where applications are manually taken off-line while they are upgraded, the controller's update receiver uses an automated pull-down mechanism for agent updates. It automatically checks the system's distribution server regularly or on demand for new updates and downloads any that exist. It then performs the upgrade by installing the patch or reconfiguring the manifest files, and then restarting the affected code. No manual intervention is required, although the user can change preferences if they want to be notified prior to any updates. This same mechanism is used for installing new software on a host. An authorized user can remotely instruct the update receiver to download a new component from the distribution server and start it. The only prerequisite for installing a new component is that the controller must have already been installed and configured on the host and the host must be sanctioned and licensed to run the component, and these conditions are relaxed under development scenarios.

Customization, Configuration, and Operation

Customization refers to actions taken prior to distribution of code to target devices, and may include the final forming of a package of code to distribute based upon the type of machine(s) to which the code is to be sent, version of framework at that device, other installed components at that device, and/or upon other criteria. It may also include the alteration of the code being distributed for security purposes to make it impossible to execute the code on a device/network other than the device/network it is to reside on. Further, it may include the combined effects of using more than one policy implementer at a customer device, where one policy implementer adjusts its package definition based upon the presence of another policy implementer.

Used herein, the term Configuration information includes providing an identity and basic operating parameters to an executable using a manifest; dynamic changes to operating parameters using new manifests and commands; specific tasks to accomplish using task assignments; or specific targets or watch items for ‘scans’ using discovery plans, and other information. This variety of Configuration requires a wide variety of different data, including, for example:
Manifest:
   Security and permission information
   Version Information
   Identity information which must be submitted with events and other transmissions
   Code integrity information
   Execution limits on space and processor usage, etc.
   Transmission limits by type
Dynamic Configuration and Commands:
   Reporting information which must be submitted with events
   Startup parameters for the software
   Naming and context information
   Limit information for operation
   Filtering and Data Reduction Rules
   Publish/Subscribe Rules
   Response and Reconfiguration of Defenses Rules
   Local Predefined Correlation Rules and Policies
   Audit Rules
   Vulnerability/Threat/Device Discovery or other ‘Signatures’
   Provision rules to control external function
   Rules of Engagement
Assigned Task and Plan Schedules and Configuration:
   Schedule information
   Devices to test, Devices to protect
   Task definition commands
   Performance rules
   Reporting information which must be submitted
   Response and Reconfiguration of Defenses Actions
   Filtering rules for task
   Audit Actions
   Rules of Engagement for task
      Configuration, Discovery Plans and Task Assignments

The assignment of tasks and plans for Policy Implementer elements extends the requested operations of the Infrastructure from a concept into an action. The deployed software is the real interface point for the real world of the network and device under control. The continuous protection, detection and response capabilities against threats, remotely exploitable vulnerabilities and real-time incidents on the protected networks are provided by the deployed software as configured. Examples of the software functions being configured are:
Monitoring Functions
Intrusion detection, analysis and reporting
Anti-virus/anti-worm monitoring and recovery
Routing failure detection
Vulnerability assessments
Asset Discovery
Active Functions
Active Intrusion Response
   Identify and counter threat activity before impact
   Immediate Computer Incident Response Center (CIRC) notification and direction
Firewall reconfiguration
Circuit Management
Asset security incident response
Tasks and Plans are used variously to control these functions.

The last step in the distribution process is configuration of the component. Manifest information includes identifying system information and the license keys necessary for proper execution of the component code. Configuration and tasking information (see above) is also needed but is loaded at various times including but not limited to the installation timeframe.

The Manifest Generator answers the manifest request and produces a new custom manifests based on the component deployment data stored locally in the Distribution Engine Database. Since only the Manifest Generator can generate these encrypted manifests, integrity of the system is ensured.

In turn, the Manifest Generator contains another key that is used to authenticate and authorize the software component when the component is started up.

The Assigned Task and Plan data are produced by other web services connected to the distribution database and are encrypted with a key. These other Web Services answer requests for configuration and tasking data in a similar manner. The configuration data is used to control the software component during execution as well as at started up. The startup schedule may also be controlled by the Tasks and Plans data.

The utility of this configuration methodology is rapid resolution of security problems from the security operations center through tunable detection, easy reconfiguration, and rapid response by adjusting defenses against emerging attacks.

Operations

The basic purpose of the Infrastructure is intrusion prevention and risk reduction. More specifically, the purpose of the Infrastructure is to provide a framework for the effective deployment and operation of Policy Implementer solutions to aid in tasks such as:
Obtaining Information about threats and incidents
Taking Defensive Actions to stop harm and losses
Network Configuration Management and Asset Management are also provided.

A decision to launch the incident response process into action should be made based upon the threat, so the management process can be viewed as a continuous decision-making process: “What threat is present?”, “How to we defend against it to prevent harm?”. These decisions are based on the information provided by the Infrastructure and the Policy Implementer components. Paradoxically, without proper design, the more security devices deployed, the more difficult it is to make the right decisions about defensive strategies because of the analysis burden caused by the additional information.

To ease the decision formulation, the vast body of diverse data reported by security devices must be converted into knowledge. Most source data contains information as atomic events, which stem from a single notification from a security device. Correlating all those events from a single device to understand the nature of a threat or to distinguish an anomaly from a normal or first-time behavior is hard; correlating events reported within even a short timeframe by several security systems is often exponentially more difficult because the events may reveal simultaneous but unrelated attacks, or attacks which are much more or much less significant in scope.

The approaches used to cope with the complexity of this analysis can be categorized into
doing nothing with the data;
manual data reduction, and
automation tools, such as scripts and utilities aimed at processing the information flow.

The Utility of the Policy Implementers elements is that they collectively provide an integrated facility for processing the information flow. When properly constructed and used effectively in the Infrastructure, they are additive, allowing an assembly of information and the integrated analysis needed to understand it.

The devices that the Infrastructure is monitoring, whether aimed at prevention or detection, generate huge volumes of sensor, audit, log, or analysis data. Many diverse data formats and representations are used for those log files and audit trails, and Policy Implementers are used to convert those formats to a standard where possible to ease analysis and to speed prevention. Policy Implementers also reduce the false alarms that do not map to real threats. With the Infrastructure providing a standard Data Structure and a consistent analysis framework to identify various threats, prioritize them and learn their impact on the target organization, Policy Implementer components may be programmed more efficiently, making use of and extending the Infrastructure.

The Utility of the Infrastructure is that it provides rapid detection of attacks by using solid analysis techniques that pre-correlate and correlate data effectively. By coalescing data to remove redundancy, and archiving old data or worthless data, analysis is possible for long term threat trending and risk analysis.

The Policy Implementers often read data streams from a single sensor, or a security or application platform—the ‘point solutions’ which are highly effective in their own right but are often unable to provide full cycle security in a complex environment. More advanced Policy Implementers combine data from multiple security and application platforms, correlate that data and provide relevant and accurate data for threat response. Policy Implementers also provide the response, reconfiguration, and enforcement mechanism for threats.

The general steps included in the operation of the Infrastructure and Policy Implementer Components can include, for example:
Task Initialization
Monitoring for Detection
Detection Data Collection
Local Analysis
Local Reporting
Analysis
Persistence with Categorization
Policy Breach, Vulnerability, and Threat Detection
Alert and Action Definition and Workflow Initiation
Response Determination
Defensive Reaction Initiation
Enforcement Action Initiation
Further Analysis
Inventory Collection and Protection Extension/Initiation
Reporting and Metrics
Assurance
Security Administration
Data Archiving and Expungement.

Operations step 1312 refers to the execution of the services on the customer network. No services will be loaded prior to the e-commerce transaction step 1308. In addition, where the customer has purchased framework components to be loaded onto the customer-controlled network, the customer machine(s) must first be sanctioned in step 1310.

Operations Process

Task Initialization

Task initialization in this methodology includes the process of deployment and configuration of Policy Implementer components toward a defined purpose with a set schedule for specific actions on a defined target scope such as a network segment or a defined set of assets to be protected.

Different purposes and general actions are defined by the Methods construct. An example would be the Discovery method for nessus.

Schedules and targets are set by Plans. An example would be a Plan stating that a specific Controller component should schedule a SNORT agent to execute at 9 PM for a specific target address range.

When a Controller starts Policy Implementer components which either have a predefined schedule or have been given a scan Plan or Task, the component will begin its work. If no predefined Task is assigned, the component will start up but wait for direction from a senior Framework Part such as a Management Console or the Discovery Engine.

The actions are tuned by Parameters such as Method Parameters and Provision Parameters.

This phase is controlled by the Discovery Plan and Task Assignment facilities of the Infrastructure and is customized for a Policy Implementer by Discovery Plan Templates, Schedule Templates, Provision Rules.

The Utility of this facility is the significant reduction in system load resulting from the key-hole narrowing of the threat field-of-view. By providing focus to the monitoring and data collection efforts on a highly dynamic basis, the system overall is more effective.

Monitoring for Detection

A number of facilities are used for monitoring. To enhance the breadth and quality of monitoring, the Infrastructure is constructed to provide for use of 3rd party tools for monitoring, and the business process and facility provides for the deployment and control of the 3rd party tools. Policy Implementer Agent components manage and receive data from the 3rd party tools or perform the monitoring function directly. To receive data, the Agents interface directly with the 3rd party or internally developed tool, or read and interpret log files created by the tool. To manage the tools, the Agents are programmed to initiate and/or reconfigure the 3rd party tool.

When a Controller starts Policy Implementer components which either have a predefined schedule or have been given a scan Plan or Task, the component will begin its work. If no predefined Task is assigned, the component will start up but wait for direction from a senior Framework Part such as a Management Console or the Discovery Engine.

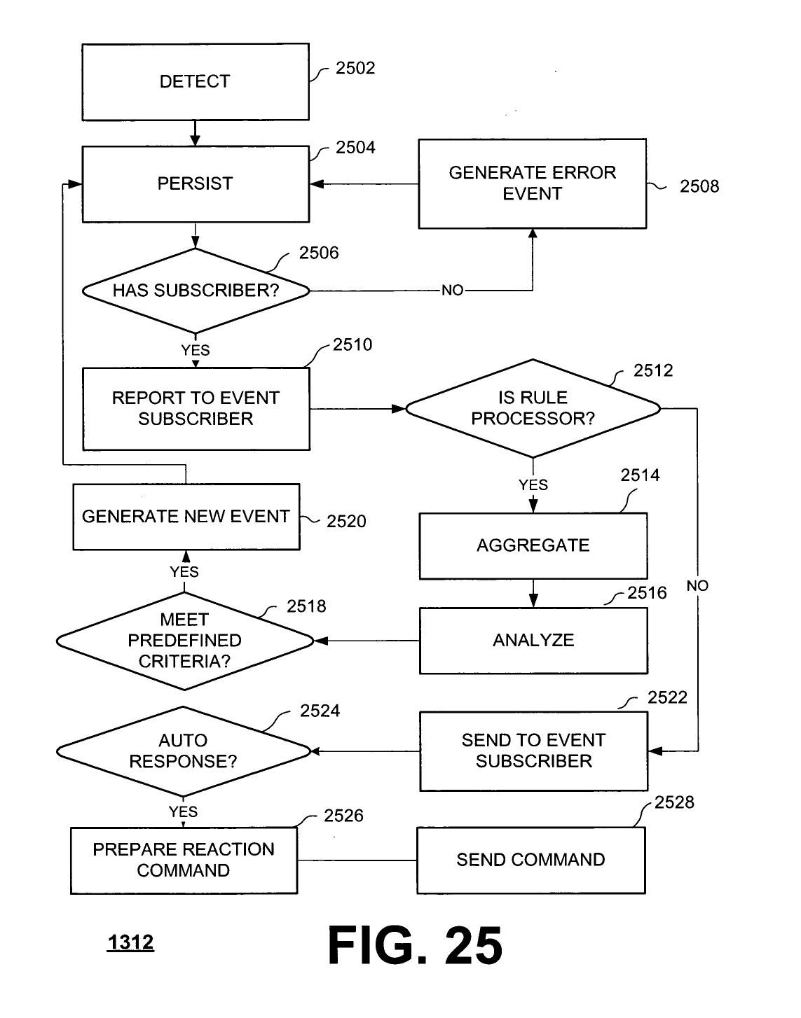

FIG. 25 is a process flow chart for the operations 1312 process shown in FIG. 13, according to one embodiment of the invention. As shown therein, interesting activities are first detected in step 2502, then persisted and or queued in step 2504. Event types are checked to determine whether the detected event has a subscriber in step 2506. If not, an error report is generated in step 2508. If so, then the event is reported in accordance with the subscription in step 2510.

Certain events will be analyzed against predefined rules in step 2512, sent to an event subscriber in step 2522, and checked against automatic response logic in step 2524. If an automatic response to the event is to be made, then a reaction command is prepared in step 2526, and the command is sent in step 2528. The response command could be or include, for example, a command to collect additional information, or a command to disable portions of the network-based system. Other events are merely aggregated in step 2514 and analyzed in step 2516, and, if they meet predefined criteria (step 2518), may be used to generate a new event in step 2520.

Detection Data Collection

Detection data is specifically the information that most cogently characterizes an anomaly, status (or state—a well-defined logical or operational mode that the network object is in), intrusion or attack, a presence or absence, etc. This data is either interpreted by an Agent or is used to form an Event by the Agent which the Agent communicates by publishing it.

As events are detected by reading system or device logs, reading communications traffic, reading system statuses and configuration settings on devices, or by other procedures, they are communicated and interpreted by the Infrastructure according to programming supplied in one or more Policy Implementer components. To enable better correlation, events that closely match the discovery, vulnerability, attack, breach, or status function are standardized as closely as possible for collection and transmission.

Local Agents do not simply pull sensor log files into the event reporting structure for posting to a database. Agents are developed to effectively report events, often performing some degree of analysis, normalization and aggregation on the data before creating a traditional event message. The Utility of the Agent concept within the Policy Implementer is that the various elements of the Policy Implementer collectively reach an optimal pattern of distributed collection and analysis, balancing the amount of initial analysis on the device itself against processor load, bandwidth consumption, and correlation processing.

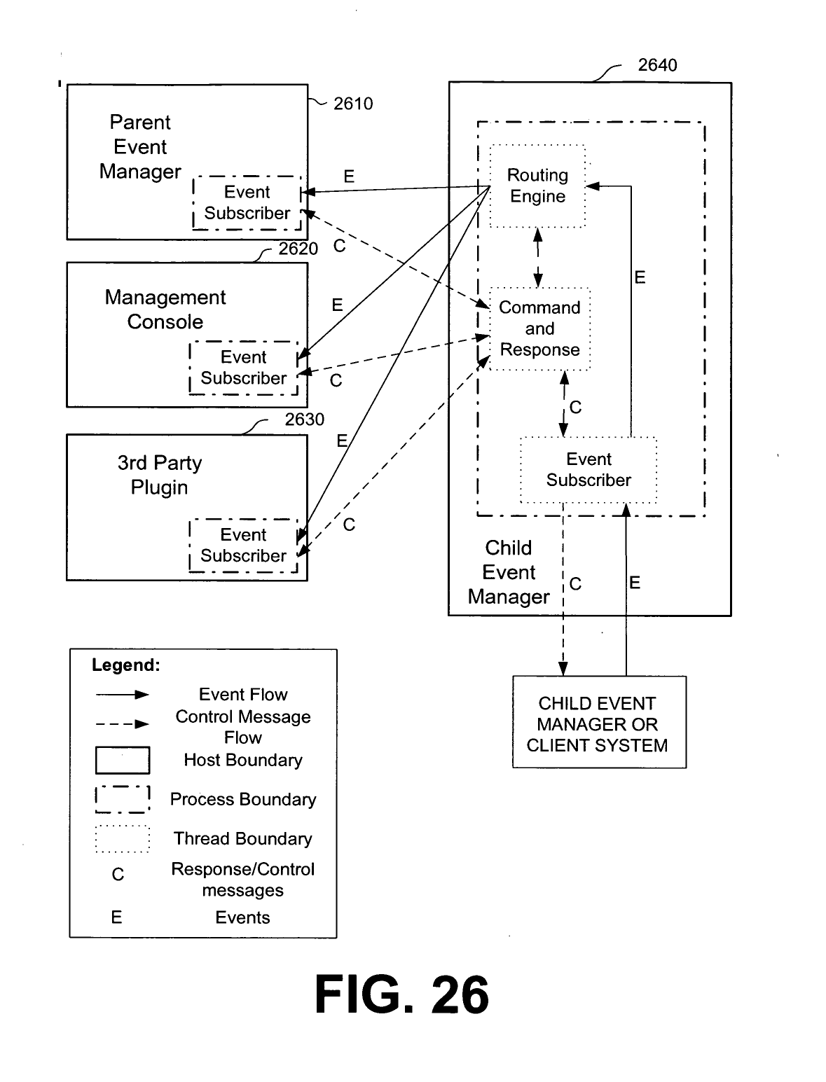

FIG. 26 is a block diagram showing functional components of event management, according to one embodiment of the invention. Events may be received by event manager from child event managers 2640 in a hierarchy of event managers. Events are routed to subscribers based on the routing tables with the event manager. Subscribers may be parent event managers 2610, management consoles 2620, or other plug-ins 2630. Although subscribers are shown as being on separate hosts, they may be threads that are local to the event manager which perform aggregation, analysis, correlation, or other functions.

Subscriber processes may return control messages that describe response actions. These control messages are received by the event manager's command and response component. Control messages are queued and sent to the intended recipient the next time the recipient checks in with the event manager.

FIG. 27 is a block diagram showing functional components of event management according to one embodiment of the invention. As indicated above, events may be received by event manager from child event managers. Events are persisted and queued using the calling thread. A routing engine thread dequeues the event, matches its type against one of the entries in its routing table, and sends it to all registered subscribers for that event.

Subscribers are invoked with an event manager thread. Generally, a subscriber will spawn a separate thread to perform blocking I/O operations. It also maintains a queue where events are stored until they are serviced by the subscriber.

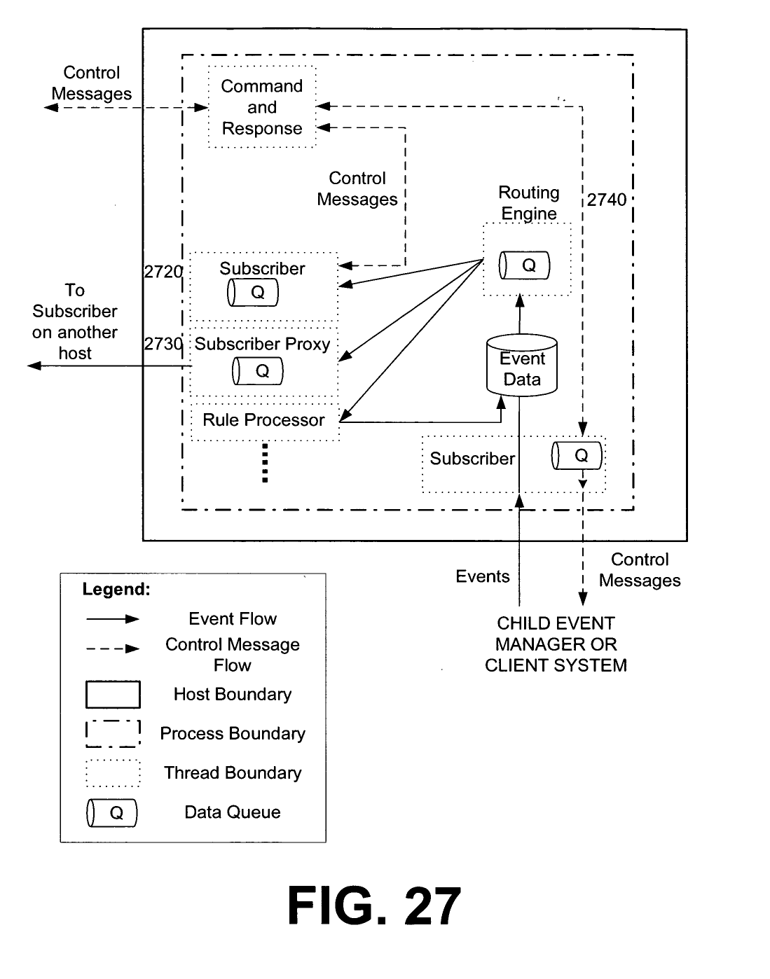

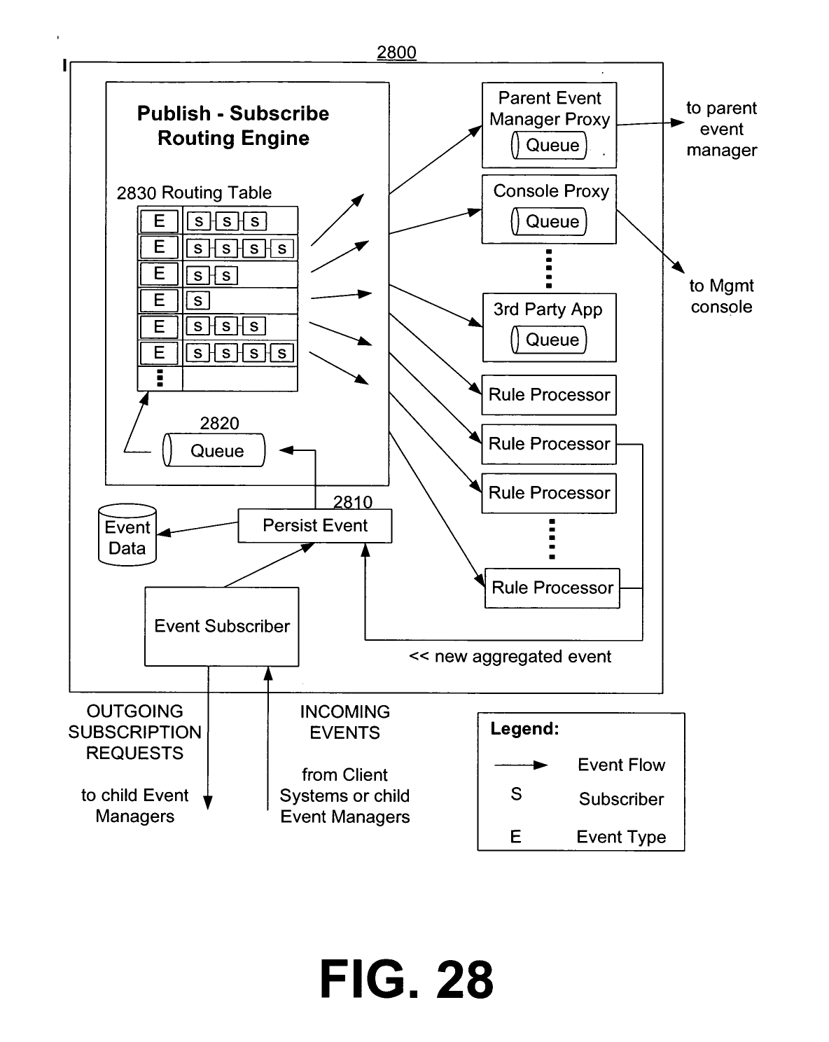

FIG. 28 is a block diagram showing functional components of event management according to one embodiment of the invention. As shown, the event manager 2800 has a proxy at the child event manager. The proxy knows what events the parent event manager 2500 currently recognizes. The proxy (on the child event manager) subscribes to the events that the parent wants to see. Events are immediately persisted in step 2810 prior to enqueuing in step 2820. Events are dequeued and compared against a routing table in step 2830 that matches event types to subscribers. The table is populated when subscribers notify the event manager with a new subscription request for a certain event type.

Any number of subscribers can subscribe to an event. If the event is found in the routing table, then it is sent to all of its subscribers. If the event type is not found, or it has no subscribers, then the event manager treats this as an error condition and generates an error event.

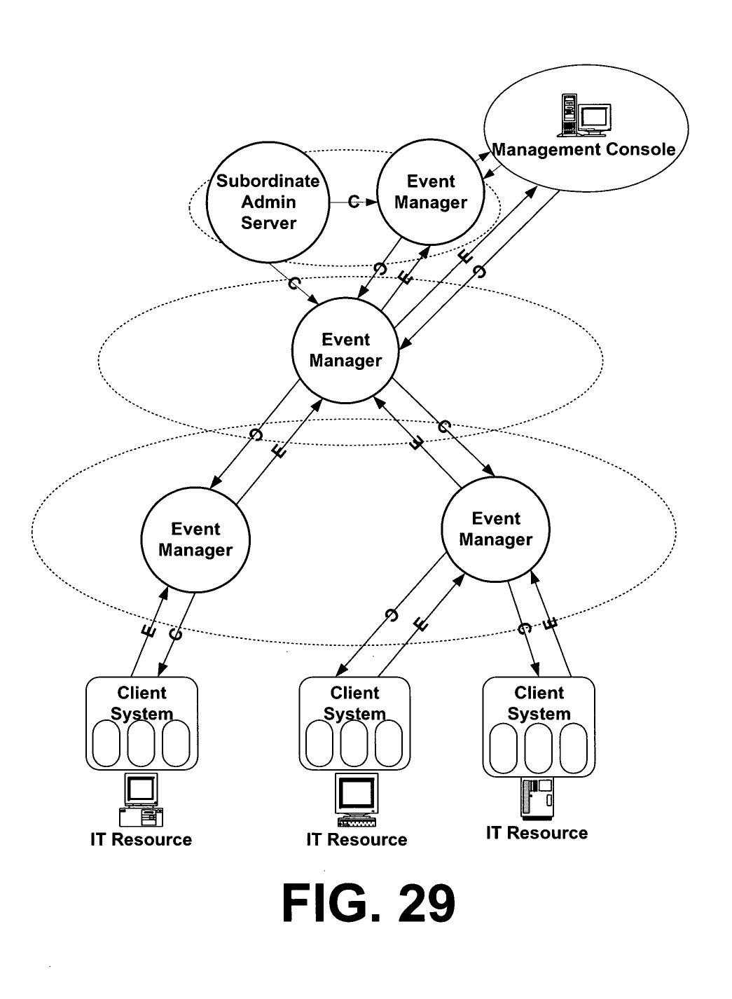

FIG. 29 is a process flow chart showing an event management hierarchy, according to one embodiment of the invention.

Most distributed monitoring applications adopt some variation of either a centralized or decentralized computing model. Centralized monitoring requires that all events flow through a central processing server that directs events from producers to consumers. Decentralized monitoring requires that all events be broadcast from all producers to all consumers. Both approaches have inherent performance and scalability problems when scaled to larger, more geographically dispersed systems. For these reasons, a better solution is required that allows efficient, localized monitoring in smaller environments, while also allowing for effective, real-time monitoring in much larger, distributed systems. Architecturally, the Infrastructure addresses these issues by taking a novel approach to event collection and correlation in a distributed environment. It employs a hierarchical filtering system that uses collaborative agents that filter events in multiple hierarchical levels according to user-defined monitoring requests. This implementation is more suitable than the aforementioned distributed models since it reduces event duplication and isolates filter and correlation processing to only those nodes that must perform it. Among other benefits, this manner of distributing collection work across many nodes drastically improves the performance and reliability of the monitoring system and does not overburden one particular resource. As a result, Infrastructure delivers a high performance, dynamic, flexible and non-intrusive monitoring architecture that scales well to large, distributed systems.

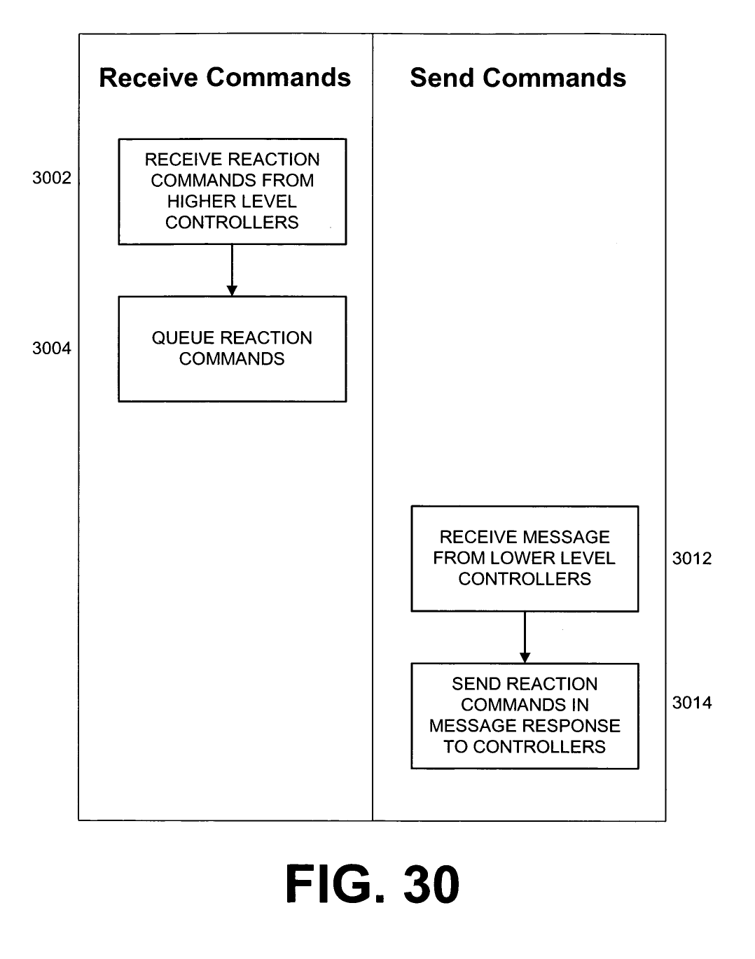

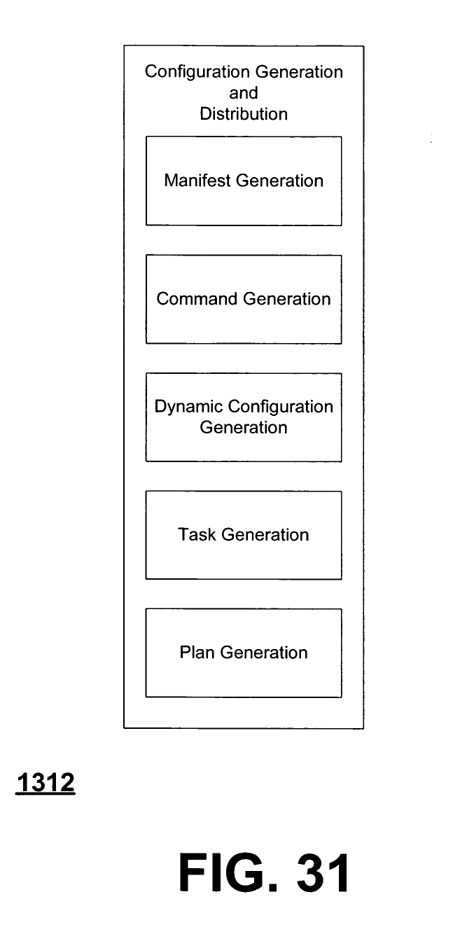

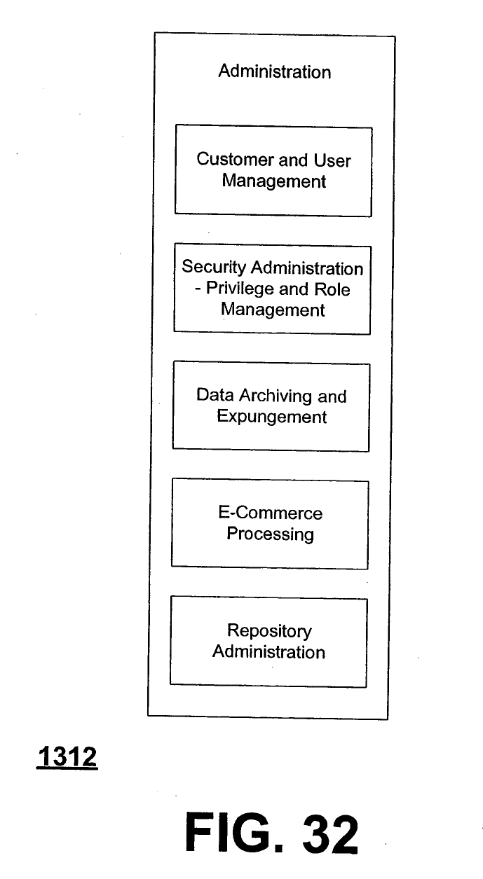

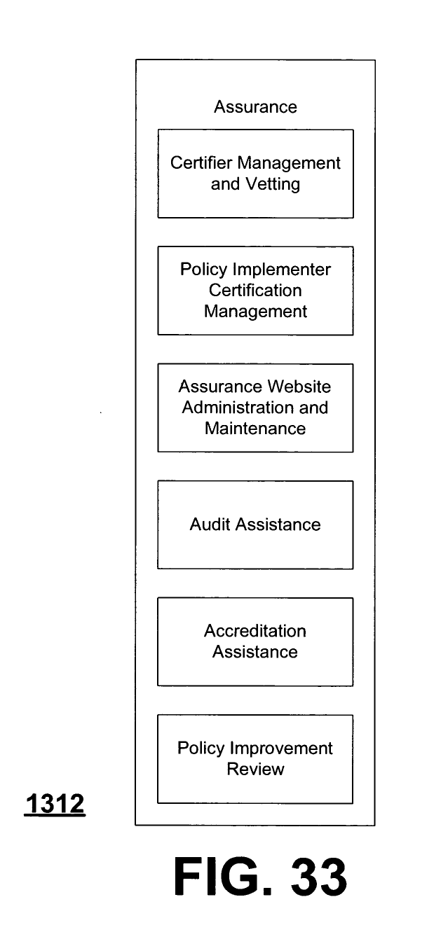

FIG. 30 is a process flow chart showing command propagation, according to one embodiment of the invention. The event manager receives commands from an upper level in step 3002. They can originate, for example, from the management console, administration server, or an event subscriber. Commands are queued in the event manager by the command and response component in step 3004.

Messages are also received from lower level controllers in step 3012. In response, the command and response component of the event manager removes commands destined for the controller off the queue and packages them into the messages response which is returned to the controller in step 3014.

Local Analysis

Analysis tools located near the Agent that generates an event, or that are in the child-parent reporting chain and can ‘subscribe’ to an event can perform Local Analysis. Analysis may consist of:
Aggregation or Event roll-ups: substituting a summary event for two or more real events during transmission; and
Normalization for Correlation: Re-characterizing a set of events as a single event of a ‘higher’ importance by (in the case of local analysis) relatively simple comparisons and calculations. Normalization takes multiple event data streams and ensures that they are presented to the next layer in a standard format for correlation. It is easier to compare data from disparate data sources and multi-vendor security solutions by pre-filtering and regrouping them in a distributed processing pattern.

This function is provided by Policy Implementer ‘subscriber’ plug-in components.

Local Reporting

Local Reporting consists of immediate notification of a user local to the generation of the event, or local to a device in the reporting chain ‘near’ to the generation of the event. This relatively low level but relatively high priority or importance presentation is accomplished by the included function of the Dashboard facility of the Controller or the Management Console, or by Dashboard or Management Console Policy Implementer Plug-In components.

Analysis

The Infrastructure, according to one embodiment of the invention, provides analysis facilities such as event correlation which may be utilized to improve threat identification and assessment by looking not only at individual events, but at their sets, bound by some common parameter.

Analysis is performed both before and after Persistence with Categorization. Here we discuss all analysis techniques.

Utility of Analysis: Automated analysis, by pre-correlation, correlation, or special programming can diminish false positives while enabling analysts to pull the proverbial “needle out of the haystack”—those true attacks that are ignored by individual point products. In reality, when it comes to stopping attackers, correlation is just the beginning of a complex threat analysis process, and the defenses must be managed and improved by a rigorous, but open system. The Infrastructure and Policy Implementers provide that needed full scope management.

Only with advanced analysis and correlation techniques and intelligent event categorization can an organization manage the multiplicity of security point solutions, appliances and devices they install. Use of “best of breed” off the shelf solutions is a practical necessity, but this typically implies that many security devices are employed, each one addressing only a stovepipe of security services. Human correlation alone is impractical. The analysis mechanisms provided by the Infrastructure and the Policy Implementers integrate the interpretation of security events under a common data structure and integrated planning and organizational structure, generating alerts in a common fashion so that decisions can be made and reactions can occur rapidly.

Types of Analysis

The analysis tools provided by the Infrastructure and the Policy Implementers are based upon Pre-correlation and standard correlation techniques.

Utility of Infrastructure: With the full cycle management provided in the Infrastructure, special assumptions may be made which are not possible elsewhere. The Infrastructure retains a record of the state of protection of every device it learns about. By having this inventory, and by being automated and self-auditing (scans are repeated to find changes of status on inventoried devices and networks), a reliance on the inventory allows for a reduction of data collection and analysis on those items.

Pre-Correlation

Pre-correlation is a new methodology available now because older mechanisms never reached a level of function where the methodology could be implemented effectively.

In the Infrastructure, according to one embodiment of the invention, Pre-correlation can be performed by:
narrowing the threat field-of-view;
collecting pre-categorized data;
tracking protection status;
performing incremental scans with narrowed focus because of good networks categorization;
performing incremental scans based upon need rather than network number ranges; and
providing strict assurance discipline coupled with rapid knowledge sharing.

To narrow the threat field-of-view in an environment several factors should be considered at once. First, a specific timeframe, specific capture point, specific method, specific device set and specific network segments under study, and specific device types should be used as the detection scope in a detection plan. It does no good to search all devices for all vulnerabilities and all attacks all at once, because the volume of data retrieved is simply too great.

Also, specific threats should be sought, since many threats are both common and benign if the defenses are kept up with the Infrastructure. Many ineffective scan ‘plug-ins’ and ineffective threat ‘signatures’ are known to exist in the point solution security systems and there is no need to continue to use them blindly.

Collecting pre-categorized data allows rapid partitioning of an analysis. The use of the naming for groups of assets and the characterization of them by standard typing allows for specificity and tuning in terms of analysis techniques, scan planning, and scheduling. Instead of using inefficient database queries because data is not categorized as it is sent in as events, streamlined, indexed queries can be used. Also, by using a data structure specifically established to characterize incoming data in an integrated fashion, and populating it rapidly, the analysis is much easier. The use of background database processes for coalescing (culling) the database data and the use of filters and roll-ups within the event reporting data collection stream allows data volumes to be reduced significantly.

Tracking protection status with an inventory of the health of devices being protected is necessary for any closed loop assurance methodology, or the process would be inefficient. The use of an Inventory system allows knowledge to be retained by device, network segment, etc. regarding update status for the devices, route blocks for connections, device and interface statuses (well-defined logical or operational mode that the network object is in), port settings, etc.

With an understanding of current device status, and a reliable status assurance mechanism, performing incremental scans against specific threat field-of-views can be achieved. The threat field of views can be based upon the known protection level of devices such that the known devices will not be scanned for all threats but rather only for threats for which protection is not yet established, and scans will be done not against an IP range but rather against devices specifically. It is insufficient to perform these without a rapid procedure for adjusting the scans when a new threat appears or when the reliability of the assurance or the information in the inventory decreases. At these times, the rapidity of scanning and the breadth and depth of information collected must increase in a hurry. Only a system that is capable of both modes and capable of the rapid adjustment is sufficient.

Incremental scans based upon groups of assets by specifying device names, device types, etc. rather than IP number ranges can also greatly improve results. The number of scans may increase overall, but their length is decreased, their penetration is deeper (larger numbers of signatures, for instance) and the information produced from them is better both in focus and usability. The Utility of this type of focused, incremental scan allows for the collection of discovery information, routing information, and vulnerability information at the same time and in ways not previously possible until after considerable traditional correlation was ‘data mined’.

Strict assurance discipline coupled with rapid knowledge sharing greatly reduces the time it takes to learn the manual tricks of configuring data collection and performing analysis. Any programming or scripting required that is worthwhile but is not shared or sharable by multiple individuals or organizations implies a costly development for the organizations not receiving it. Programming not shared is also not used to foster standards and to be used for continuous improvement of the process or facilities. Any expertise that can be shared should be provided with incentives to keep new improvements and learning occurring. At the same time, all of the shared resources must be assured or new security holes will open.

Utility: The Infrastructure can provide for reapplying the knowledge gained across ALL INSTALLATIONS rapidly. Three major ways of accomplishing this are:
Common Policy Information Knowledgebase—dynamic, community fed information on policies to naming to implementation to assurance.
Common Base Data Knowledgebase—this base data is deployed rapidly to all installation sites.
Policy Implementer Developer Community with rapid development and rapid, but certified deployment.

The Utility: New device type definitions, vulnerabilities, and all manner of new management object definitions should be provided widely, but without the Infrastructure making it possible to do so, in an organized approach, there are few solutions available currently.

Within an organization, there should be knowledge sharing and there should be common naming so that individuals can be utilized more widely without retraining. Naming is used between organizations where outside collections of computers can be determined, often with names like ‘universe’, ‘nefarions1’, ‘hackers network 1’, etc.

Utility: Between organizations, common naming allows for standardization and efficiency, since finding and isolating groups outside of an organization should be done by every organization and sharing of common naming and identifying information eliminates the redundant discovery efforts.

The Utility: Naming provides an organization point for new knowledge, and the Infrastructure makes use of this by opening up the collection of knowledge to a community of experts. With the ability to hold data very effectively with the Discovery and Inventory Data Structures, the Infrastructure is used as an asset management and network management database where new information can be persisted that may be beyond the current structures of the Infrastructure.

Information (see above) is collected and used to construct and share policies, requirements documents, protection approaches, implementation descriptions and programming, and assurance information. Utility: The Infrastructure greatly simplifies the implementation of security (or network management or asset management) for any organization. By offering it as an enterprise solution as well as an application service (ASP) solution, all customers and all developers are capable of making use of it.

The Utility of the Pre-correlation methodology and the Infrastructure is the significant reduction in system load resulting from the key-hole narrowing of the threat field-of-view and coincidental efficiency gained by disciplined and continuous learning. The cumulative effect of all of the facets of pre-correlation is that the actual resulting information from the tuned collection, categorization and organized storage is that the information is not in need of nearly as much real correlation BEFORE analysis even begins.

Pre-correlation is performed prior to Persistence with Categorization.

Further analyses may be performed later in the process and are discussed below. Coalescence and Automatic Correlation are performed after Persistence with Categorization. Various forms of Policy Implementer elements may perform analysis either before or after Persistence with Categorization.

Persistence with Categorization

The results of initial analysis are characterized by Breaches if they are Vulnerabilities, Attacks, or Violations, or other Discovery information. Other incoming data includes raw Events and Discovery data (descriptive information about the network and its components).

The Infrastructure supplies a standardized and integrated Data Structure for Events, Discovery, Vulnerabilities, and Intrusion Detection analysis. The Infrastructure also utilizes Data Structures for Inventory management with automatic extraction from the Discovery data structure. The Infrastructure provides a Data Structure for Alert workflow management, which also is automatically populated from the Events, Discovery, Vulnerability, and Intrusion Detection data structures.

By utilizing these data structures and their contents for setting up plans, Policy Implementers can more readily focus efforts on specific, targeted fields of threats. Also, analysis elements of Policy Implementers can run at the Repository Database and perform and can also populate more data into them.

The Utility of these data structures is that the authors of Policy Implementers may use a standard basis of data organization for their Policy Implementer elements to operate on.

Discovery data is stored into multiple tables in the database as efficiently as possible during discovery. Where possible, all of the rows inserted into the various discovery tables use the same identity number as the primary key when a specific new discovery item is entered. Utility: This eliminates the need to generate new identity numbers for each table, and provides efficiency since the enforcement of primary keys need not occur at this timeframe.

During the timeframe directly after insertion, the concept of a Plan (similar to a scan) identifying how the data was inserted is also very important. Over time, this information becomes much less important, allowing a combination of records based upon the elimination of the differentiation caused by the identity of the Plan which generated the information.

Data entered into the Discovery data structures is usually ‘point in time’ observation information. In the case where the Policy Implementer provides observation timeframe ranges, that information is also persisted.

Discovery data can also be created by Correlation, so it is important to continue the process of coalescence to include Correlation result data over time. Policy Breach, Vulnerability, and Threat Detection

The Infrastructure is established to track breaches of policies and to start workflows to alert responsible parties that the breaches have occurred. The Infrastructure provides status and evaluation reporting facilities for breaches by policy and by context. It also provides a facility for simplifying the process of auditing and accreditation—it provides for both reporting information by policy, but also provides a questionnaire system for collecting the manually entered information (completing the forms) required for audits or accreditation reviews.

Discovery of Breaches

The events are interpreted by a subscriber that is a part of the Policy Implementer or that is provided by the Infrastructure for reuse by policy implementers. The interpreted events are converted to breaches of various types in this interpretation processing.

Examples of breaches relative to a stated policy are:
incidents or conditions where the status of a device or connection is inappropriate;
events which occur that indicate an intrusion or inappropriate condition has occurred;
vulnerabilities which are detected that indicate that a configuration is incorrect or that an exposure exists;
configuration setting is read that is incorrect; and
threats or attacks which are detected.

Statuses include presence and condition information for assets and configuration information.

Alert and Action Definition and Workflow Initiation

Actions in response to breaches and status changes may be invoked by the infrastructure or by components of a policy implementer based upon rules included in the policy implementer. The actions are called alerts when the user should be informed, or action items when only workflow is initiated. Workflow processing may also create alerts for instigating action such as manual intervention by a user.

Response Determination

Specific Responses chosen are based on automatic rules which are linked to Breach Types and are provided by programmed elements of the Policy Implementer. The reactions may trigger rules for deploying new software or updating existing software, new provisioning of the network, alteration or blocking of the network configuration, or a large number of other Defensive Reactions or Enforcement Actions. The workflow associated with the breach's initiation of an Alert or an Action is performed by the Workflow facility utilizing the AutoFunctions function.

Reporting of status and unhandled workflow and Alerts is performed by the Management Console Components of the Infrastructure.

Discovery of Devices

Breaches and Statuses cause an awareness by the infrastructure of discovered network devices and connectivity as well as the configuration and ‘signatures’ of those devices. This information is tracked in the Infrastructure in both a discovery data structure (all discovered information) as well as an inventory giving all ‘last known’ information about the devices and their connectivity.

The Coalescence facility stores inventory data into the Inventory Data Structures.

Coalescence

The collection of information stored in the Persistence with Categorization step is large. One reason for this is the efficiency needed during the storing of data during high-speed data collection. During analysis and for a short time after data is persisted, certain analysis, metrics, and display operations can make efficient use of the Discovery data using the format, as the data is stored.

Operating as a lower priority (a background) task in the database, and requiring no user input, the Coalescence facility reduces the number of rows in the database. It accomplishes this by successively removing rows from each table in turn, addressing the information in that table on the basis of the information of all of the other tables as needed.

Though this process is akin to correlation, it is different because it is based upon comparisons of retrieved results based upon Plan scans primarily, to reduce the amount of data actually stored. It is also different because the purpose of it is to create timeframe range records from point in time records in the Discovery data.

Coalescence finds all Discovery observations in a timeframe where there is no substantive difference between the observations, and there is also no other observation in that timeframe for the same discovered object. In other words, the Coalescence facility searches for timeframes where the observations regarding a discovered object are substantially (described below) the same, then it reduces those timeframes by finding any observation regarding that discovered object which shows a difference in some characteristic that is considered important (this is described below). The first observed and last observed times for the timeframe are then set on one of the observation records in the timeframe (the representative) and all the other observations are eliminated from the database, adjusting other database records to point to the representative record (by resetting foreign keys).

Coalescence is not Consolidation. Coalescence does not include normalization in general, and it does not traditional aggregation. Consolidation can filter out irrelevant data, focusing on the important threat-related data using rules. Consolidation is performed before Coalescence by the Local Analysis facility and eliminates many false positives before persistence.

The Coalescence facility has two basic components: the fixed query structure and the extendable query structure. The fixed query structure is entirely programmed into the Infrastructure, while the extended queries are provided as Policy Implementer.

Over time, based upon the age of Discovery data, the Coalescence facility changes the list of discovery record characteristics (columns) that are used in its various queries. These queries are used to determine which records in the discovery tables are ‘substantially the same’. The list of characteristics are different for each type of discovery object, but are usually related to the ‘status’ (or state—a well-defined logical or operational mode that the network object is in) of the observed object. For instance, initially, the Plan that was the source of the observation is considered a differentiator. If two or more Plans generated observations within a timeframe, then the timeframe will be broken into two or more smaller timeframes. After a while, the Plan holds little meaning and it is much more important to combine the Discovery data based upon real characteristics. At this point, the queries in coalescence exclude consideration of plan differences.

The extendable queries may change the nature of the standards set by the Infrastructure by providing a different list of the observations in a given timeframe that will be combined.

As Coalescence progresses, Correlation becomes much easier if it is based upon the Discovery data. Discovery data can also be created by Correlation, so it is important to continue the process of coalescence to include Correlation result data over time.

Coalescence is also applied to Events in the Infrastructure, but is often less important because of the pre-processing performed by Policy Implementer Agents.

Automatic Correlation

Correlation is the process of establishing or finding relationships between entities. This definition is very general, but in security work, correlation may be defined as improving threat identification and assessment processes by looking not only at individual events or observations, but at sets of events and observations, based on some common parameter. Various types of correlation can be used to glean attack intelligence. Micro and Macro Correlation are both included in the Infrastructure. Correlation in the Infrastructure includes multi-variate threat analysis.

Correlation in the Infrastructure is based upon both Event data and Discovery data, as well as Inventory data. Correlation generates new Discovery data and new Alerts or Actions for workflow. Coalescence includes Correlation result data over time.

The Correlation facility has two basic components: the fixed query structure and the extendable query structure. The fixed Correlation facility is entirely programmed into the Infrastructure, while the extended Correlation facility is provided by various Policy Implementer.

Various types of Correlation have been defined by others and are provided in the Infrastructure. The Infrastructure provides specific implementation constructs for each type of Correlation:

Security-Specific Correlation—Rule-Based Correlation

In the Infrastructure rule-based correlation is provided by Policy Implementer which are written based upon pre-existing knowledge of the patterns of an attack (the scenario rules). The attack knowledge is used to relate Events within a common context, and are programmed into elements of Policy Implementer either residing near the Discovery database or within the Local Analysis stage. The rules are stored either in the Policy Implementer itself as algorithms or in the Inventory system Pattern-Recognition data structures.

The Pattern-Recognition scenario rules data structure contains and names scenarios which are sequences of events (first event x, then event y, etc.) which might indicate or describe some attack or user/machine action which should cause concern. The rules also include the necessary characteristics of status (state), conditions, timeouts and actions.

The Pattern-Recognition data structures also provide a list of rules which each Inventory Object is CURRENTLY being watched for, including the rule step which was last observed.

Correlation rules may be applied to incoming events data in real-time (as they arrive) or to the historical events stored in the database. The elements of Policy Implementer within the Local Analysis stage applies Correlation rules to incoming events data in real-time. The elements of Policy Implementer residing near the Discovery database applies Correlation rules to the historical Events and Discovery data stored in the database, providing data mining analytics to uncover concealed activity and threats from low level, long cycle activity.

The rules engine is schedule granularly for execution either by defaults or Policy Implementer settings, and may be reset by users.

Security-Specific Correlation—Statistical Correlation

Security-specific correlation—Statistical correlation does not employ any pre-existing knowledge of a specific attack but rather studies activities and events for their normalcy. In the Infrastructure statistical correlation is provided by Policy Implementer which are written to use the base understanding from the Inventory system and the Infrastructure Metrics facility data structures. In the Infrastructure, Statistical correlation may occur before data is persisted by the Persistence with Categorization step or after it. Statistical correlation performed before Persistence uses event data in the FIG. 26 is a block diagram showing functional components of event management, according to one embodiment of the invention. Events may be received by event manager from child event managers 2640 in a hierarchy of event managers. Events are routed to subscribers based on the routing tables with the event manager. Subscribers may be parent event managers 2610, management consoles 2620, or other plug-ins 2630. Although subscribers are shown as being on separate hosts, they may be threads that are local to the event manager which perform aggregation, analysis, correlation, or other functions.

Subscriber processes may return control messages that describe response actions. These control messages are received by the event manager's command and response component. Control messages are queued and sent to the intended recipient the next time the recipient checks in with the event manager.

FIG. 27 is a block diagram showing functional components of event management according to one embodiment of the invention. As indicated above, events may be received by event manager from child event managers. Events are persisted and queued using the calling thread. A routing engine thread dequeues the event, matches its type against one of the entries in its routing table, and sends it to all registered subscribers for that event.

Subscribers are invoked with an event manager thread. Generally, a subscriber will spawn a separate thread to perform blocking I/O operations. It also maintains a queue where events are stored until they are serviced by the subscriber.

FIG. 28 is a block diagram showing functional components of event management according to one embodiment of the invention. As shown, the event manager 2800 has a proxy at the child event manager. The proxy knows what events the parent event manager currently recognizes. The proxy (on the child event manager) subscribes to the events that the parent wants to see. Events are immediately persisted in step 2810 prior to enqueuing in step 2820. Events are dequeued and compared against a routing table 2830 that matches event types to subscribers. The table is populated when subscribers notify the event manager with a new subscription request for a certain event type.

Any number of subscribers can subscribe to an event. If the event is found in the routing table, then it is sent to all of its subscribers. If the event type is not found, or it has no subscribers, then the event manager treats this as an error condition and generates an error event.

FIG. 29 is a process flow chart showing an event management hierarchy, according to one embodiment of the invention.

Most distributed monitoring applications adopt some variation of either a centralized or decentralized computing model. Centralized monitoring requires that all events flow through a central processing server that directs events from producers to consumers. Decentralized monitoring requires that all events be broadcast from all producers to all consumers. Both approaches have inherent performance and scalability problems when scaled to larger, more geographically dispersed systems. For these reasons, a better solution is required that allows efficient, localized monitoring in smaller environments, while also allowing for effective, real-time monitoring in much larger, distributed systems. Architecturally, the Infrastructure addresses these issues by taking a novel approach to event collection and correlation in a distributed environment. It employs a hierarchical filtering system that uses collaborative agents that filter events in multiple hierarchical levels according to user-defined monitoring requests. This implementation is more suitable than the aforementioned distributed models since it reduces event duplication and isolates filter and correlation processing to only those nodes that should perform it. Among other benefits, this manner of distributing collection work across many nodes drastically improves the performance and reliability of the monitoring system and does not overburden one particular resource. As a result, Infrastructure delivers a high performance, dynamic, flexible and non-intrusive monitoring architecture that scales well to large, distributed systems.

FIG. 30 is a process flow chart showing command propagation, according to one embodiment of the invention. The event manager receives commands from an upper level in step 3002. They can originate, for example, from the management console, administration server, or an event subscriber. Commands are queued in the event manager by the command and response component in step 3004.

Messages are also received from lower level controllers in step 3012. In response, the command and response component of the event manager removes commands destined for the controller off the queue and packages them into the messages response which is returned to the controller in step 3014.

Local Analysis step and generates specific new Events and/or Discovery or Vulnerability information. Statistical correlation after Persistence rates incoming Events and Discovery information to distinguish normal from abnormal or suspicious activity.

The Metrics facility statistics data structure contains and names metrics used for differentiation between normal and abnormal activity. Each Metrics statistics row contains a query and a reference to a breach type that associates a risk to the metric. The metrics queries are run automatically based upon the frequency specified in the row.

The metrics generated are retained and reported in real time and historically as trends. The trends are stored in the metrics buckets structure of the Infrastructure. Algorithmic correlation is used in addition to the categorization of Events, Vulnerabilities and Discovery, as well as with the Inventory information to compute the threat levels specific to various attack types, such as the threat of a denial of service or worm/virus attack, and provide trends based upon the results, by device, asset-group, and policy.

Detecting threats using statistical correlation does not require any pre-existing knowledge of the attack for it to be detected. The queries in the metrics system provide thresholds and actions which may be set to find threats based upon pre-defined activity thresholds. The thresholds are defaulted but may be reconfigured based on the customer's experiences. The use of rules by type of asset-group is defaulted, and may be overridden for different customer asset-groups.

The Correlation Metrics provides various parameters in the Metrics Data Structures for asset-groups to set the algorithm for faster querying and higher accuracy detection. For instance, if a certain normal level of specific reconnaissance activity (e.g., port scans) is exceeded for a prolonged period of time, a specific Breach would be generated by the system. A different threshold applied on a different set of devices would imply a different level of activity to cause a Breach. These parameters may be adjusted over time by Policy Implementer so that the metrics computed from other available event context data (such as vulnerability scanning results or metrics settings for normal user activity on the asset-group) can take effect.

Events that are old enough based upon archiving rules and are no longer needed for the calculation of metrics (no longer contributing to these metrics) can be deleted and no longer considered in the risk profile.

Other Analysis Techniques

A number of other forms of Correlation and other analysis techniques can be run. To do so, the AutoFunctions function provides a relatively open facility to run predefined stored procedures and SQL queries. The AutoFunctions function is configured based upon frequency of execution of each stored procedure or query, and provides a result storage mechanism.

The AutoFunctions function is also used for managing workflow for the Infrastructure.

The Metrics facility extends well beyond the Statistical Correlation methodology. The Metrics facility provide for detecting problems with storage space and other database issues, track user interaction rates for trending, and provides Metrics for other risk levels based upon alerts being generated.

Inventory Collection and Protection Extension/Initiation

As coalescence continues, the Coalescence facility generates or updates the Inventory data structures. The Inventory data structures contain information about network objects which are similar (inclusive of) the discovery objects. The inventory information only contains the most recent ‘status’ information for each identified network object. The characteristics that form the ‘status’ are different for each network object and a standard, set by the Infrastructure, defines those characteristics. This standard is revised over time.

The Inventory data structures are used to persist information beyond what is generated by Discovery. Status requirements are set in the Inventory, so that when a status of a device is detected that is different from the status requirement, a Breach is generated internally.

Utility: The Inventory system provides the ability to check the statuses of various network objects, including services, open ports, open and blocked routes, etc. It also provides a simple lookup mechanism for finding all known devices by asset-group. It provides a consistent basis for the Discovery process and for Pre-Correlation.

The discovery process will find devices in a network under protection that are not actually covered for protection themselves. These unregistered devices should usually be licensed for protection, or they will be reported for auditing as insufficiently protected to the ‘duty of care’ level prescribed by policies and implemented by policy implementer rules. In these cases, licensing actions, installation and/or deployment of new Infrastructure (controller only in this case) and Policy Implementer will be triggered automatically or under a workflow approval process.

Utility is shown by the automatic licensing operations and deployment of infrastructure and policy protections to newly discovered devices.

The inventory structure yielded by the Discovery facility is used in reporting. New discovery is linked to this inventory information, and new information collected from the users about the network and its devices is tied to the inventory so that the collected information is all integrated and protected from loss more substantially than raw event or discovery data can be.

Reporting and Metrics

Specialized reporting is provided by the Report Generation facility of the Infrastructure. These include data mining, dynamic reports, and custom reports.

Assurance

Process Management Auditability

The discipline needed in Security management should be tested sufficiently so that the first time it is needed is not determined just after the first time a major attack occurs. Despite the best of efforts, few enterprises are able to proactively communicate security and privacy policies to employees, customers, business partners, and suppliers. Even fewer are able to integrate security policy into their technology infrastructure and procedural response systems. As a result, even the largest enterprise is always on the defensive. The Infrastructure not only reduces and mitigates risks, but also provide mechanisms to gain control over the reams of data produced by security products in order to take proactive control.

This is not enough. The discipline should be checked by Audits and Accredited to the proper agencies as a cross check on the audit and security management. This is required by the governance rules and laws regarding most large organization today.

The discipline starts with management over the process of protection. Duty of care cannot be proven unless the management system is working and that it is auditable just as an accounting system. The only way of being able to automate security processes to meet audit ability standards is to introduce “intelligence” or active policy applications, which are called Policy Implementer in this application. Furthermore, when Policy Implementer are connected via workflow applications for security, it is possible to take full advantage of technology to automate security processes, and to be auditable. Lastly, when Policy Implementer are combined with security events occurring in real time, via active risk management applications, the basis for automating the security procedures of the organization is established.

If the process is stated, and followed, and metrics are taken on the success of the management relative to the cost of losses not occurring or the risk reduction, then the process can be improved reliably.

Audits

An “audit” is conducted by an outside organization and results in a formal written examination of the enforcement discipline and appropriateness of the policies of the organization. Security audits test how the confidentiality, availability and integrity of an organization's information is assured.

A computer security audit is a systematic, measurable technical assessment of how the organization's security policy is employed at a specific site. Computer security auditors work with the full knowledge of the organization, at times with considerable inside information, in order to understand the resources to be audited.

The Infrastructure assist the auditor by supplying, for example, the:
information needed about the policies,
audit plans,
templates for recording interviews,
templates for questionnaires for audits (and a facility to customize the templates),
information about the network topology and naming,
information about the type and degree of protection implemented on all known elements of the network,
all current risks, threats, and vulnerabilities known, and
a history of all recent metrics.

This is usually the set of ‘security ledgers’ that managers think of when they think about audits—this information explains in detail, by policy, just how secure a site really is. They are all produced by consistent standards and procedures

Utility: The Infrastructure tells an auditor how the security policies—the foundation of any effective organizational security strategy—are actually used and an assessment of how effectively the organization's security policy is being implemented.

The audit is a continuous operation that is broken into visits for ease. As organizations evolve, their security structures will change as well. The security audit is not a one-time task, but a continual effort to improve data protection. The audit builds on previous audit efforts to help refine the policy and correct deficiencies that are discovered through the audit process.

Utility: With the use of the Infrastructure, the audit can progress with the use of organized, consistent, accurate, data collection and analysis process to produce findings that can be measurably corrected.

Accreditation

Accreditation is performed by an authority above the development team called the accreditor. The result of Accreditation is the formal authorization to set a system into production or operation. Accreditation is the process of independently verifying that a system operates properly in performing an appropriate organizational need based upon all available information and inspections of the implementation. The system requirements statement and documentation produced during certification, and perhaps the procedures documentation for procedures surrounding the system are examined, and the system and its context are inspected. Accreditation for security also ensures that the security measures implemented in the system are appropriate for the required level of security and the information being processed and that discipline for maintaining the specific security protection can and will be continued.

Within the Infrastructure, the Assurance components provide for Accreditation much in the same way as for Audits. The Assurance facility provide a central repository for the policy documentation, and direct traceability to all Policy Implementer and the plans and documentation for all aspects of the implementation of those Policy Implementers. It also provides templates and checklists that can form a basis for the accreditation.

For accreditors which inspect and authorize for larger organizations such as government agencies, the templates and checklists will also include interview questionnaires and fact finding questionnaires that allow for a step by step completion process for the accreditation based upon their standards. The standards are usually stated in terms of security ‘assumptions’ and security ‘assertions’. A security assumption is some protective measure (a protection) assumed to be provided within the security domain by an external (from the Policy Implementer) facility whereas a security assertion is a protection being declared as being provided by the Policy Implementer. A security requirement is met by one or more security assertions which are dependent upon some limited set of the security assumptions.

The normal (initial or default) questionnaire for an Accreditation includes, for example, checklist items for each Policy Implementer and for each protection offered:
The security protections are confirmed by reviewing the Implementation Plan against the referenced and other relevant organizational policies.
The Policy Implementation Plan is validated as providing appropriate and consistent mechanisms to implement the functionality required by the Policy.
The Operating Procedures are reviewed to ensure that sufficient procedural security in the context being addressed by the Policy Implementer to ensure the effectiveness of the security protections implemented and to provide adequate security where security requirements are not otherwise addressed.
The Policy Implementation Description is reviewed to ensure that it adequately describes the system and that the security overview correctly reflects the posture identified in the Policy and Implementation Plan.
The Policy Implementer security assumptions and assertions are extracted from the Policy, the Implementation Plan, and the Operating Procedures and security checklists created.
Each context (asset-group if real or example context) is inspected (if real) or context (if example) to confirm adequate implementation of physical and personnel security, and to ensure communications and computer security protections (measures) have been correctly installed (for real only). Equipment (real or presumed) will be verified against Configuration Management baseline documentation.
An evaluation of the computer system will be carried out to confirm that the computer system adequately protects the information being processed and stored, and that the computer security protections implemented cooperate as required to provide a well integrated security environment. Evaluation looks at the protections (measures) from the following points of view:
   Functional Operation.
   Performance.
   Penetration Testing:
      complex interfaces,
      maintenance procedures,
      error handling,
      temporary security level changes,
      residual information,
      new features and the interface between new and old, and
      control of security information.
An accreditation report is written and a recommendation made to the Accreditation Authority.

Results of certifications, audits, accreditation examinations and reviews are entered into the infrastructure, either into the report library or the policy oriented documentation library as issues, reports, rejection notices, and comments, and are assigned to developers or managers according to their role in the organization to which the results pertain.

Security and Responsibility Administration

The Customer uses the Infrastructure Security component to authorize users and set up new business units as needed. The User Administration function allows an administrator to manage organizations, users, memberships of users in organizations, and their associated roles and privileges. Registered users may also update their own details.

The Customer also uses the Infrastructure Security component to assign responsibilities to users and business units as needed. The customer also establishes a record in the database for organizations which participate in enforcement, issue management, audits, accreditation reviews, and other assurance procedures. The reporting and review relationship structure between the organizations is also entered. Each of the organizations are associated with responsibilities as roles, and users are assigned to the responsibilities. The registration process then notifies the users assigned to those roles of their rights of access to the system. Registered users may then update their own details.

The original roles for Infrastructure with associated privileges are defined as follows:
Infrastructure Management—All access, read only, electronic feedback capability for the areas and asset-groups they manage.
Reporting and Review personnel—For personnel performing audits, accreditations, etc. Each author will have read/write access to only their specific area information. Once they enter the data and forward it “up the chain”, the data can be write-protected; however, when reviewer's edits are passed back to lower tier personnel, the lower tier personnel should be able to edit.

Indirect (web-based) access to the Infrastructure database is established via an application-level login from the Infrastructure application as described above. Direct access requires knowledge of the Schema's credentials within the database.

Passwords are stored in the database in an encrypted format for security and privacy reasons.

The license and security and distribution components, in cooperation with the controllers, enforce software licensing. All Infrastructure components (other than the top most Administration Server) should (relaxed in the case of development systems) be sanctioned to serve as a component of the system framework as it is finally installed. A machine may be sanctioned to perform as zero or more of the Framework components.

Each Policy Implementer component (and controller) is counted by the licensing mechanism before it is allowed to operate. The Authentication and Authorization processed are defined above.

Data Archiving and Expungement

Event data is collected in great volume. Discovery data and some alerts are entered in lower volumes. Each of these forms of data may be expunged after action is taken on them. Inventory, on the other hand, should be retained for further use. This differentiation allows for the controlled expunging paradigms implemented in the infrastructure. Background processes remove unneeded event, discovery, and alert information to off-line files.

The archiving process is controlled by Archiving Rules stored in the Infrastructure database. These rules specify which data may be archived based upon queries. These Archiving Rules may be provided by Policy Implementer or by the customer.

Enforcement, Audit and Policy Accreditation

The results of the Policy Statement, Policy Implementation Plan and Description, and Certification process are used as an input to the Enforcement, Audit and Policy Accreditation Step in the methodology. The Assurance Component of the Infrastructure provides an inventory and report description data structure, an online documentation facility, a report generation facility, and a data entry facility (for additional report information entry) for use by reviewers, auditors, and accreditation. Online documentation for the functionality of the installed protection facilities on any system deployed will be available in an integrated document.

Much of the traditional process of audit and accreditation is the inventorying of the network and equipment in a system being reviewed. Past that, a rough database is created from the process of determination of the protections on the networks and equipment. The utility of the Infrastructure is shown for a protected customer system in that, for example:
The network and equipment installed is detected automatically and cataloged by the Infrastructure.
The protections active on the network (by segment) and on the equipment is cataloged automatically (including devices that are protected by other devices and do not have/need protections installed on them)
The complete documentation for the protections effective over a device or network is complete, cogent, relevant, available, linkable, integrated by topic, and dynamic.
The inventory is downloadable for off-line study, and automatically formatted into report segments for specific accreditation agencies and audit types.
Specific traceability is retained from inventoried items back to specific policies, and back to specific certifiers and developers. The traceability is dynamic, hierarchical, and multidimensional.
The costs associated with Accreditation and Audit are greatly reduced because the information is available, organized, and reportable. The recertification process is not repeated for every Accreditation or Audit project or for every permutation of network segment and protection.
   Policy Improvement Review

Upon completion of the Policy Implementer Assurance process, the Policy itself is evaluated and improvements are made, for example:
Analyze problems and issues
Develop recommendations for improvement
Implement improvements outside of Policy Implementer
Take corrective and preventive actions
Validate improvements
Continuing education, training, and awareness to all stakeholders
Threat change creating a system vulnerability resulting in a higher risk
Mission change requiring a different security mode of operation
A breach of security, a breach of system integrity, or an unusual situation that reveals a flaw in security design exposing its vulnerability
Significant change in physical structure of the facility
Significant changes in operating procedures
System configuration change (e.g., connections outside approved parameters)
Inclusion of additional (separately accredited) system(s) affecting security
   Maintain And Improve Implementer, its Plan and Description

Upon completion of the Policy Implementer Assurance process and Policy Improvement, the Policy Implementation itself is evaluated and improvements are made entailing, for example, the following steps:
Maintain accreditation
Review new threats and vulnerabilities
Review or assess system/environment and Software (operating system or applications) additions, changes, or upgrades
Review system or environment modification requests
Analyze problems and issues
Develop recommendations for improvement
Implement improvements
Take corrective and preventive actions
Validate improvements
Continuing education, training, and awareness to all stakeholders
Threat change creating a system vulnerability resulting in a higher risk
Mission change requiring a different security mode of operation
A breach of security, a breach of system integrity, or an unusual situation that reveals a flaw in security design exposing its vulnerability
Significant change in physical structure of the facility
Significant changes in operating procedures
System configuration change (e.g., connections outside approved parameters)
Inclusion of additional (separately accredited) system(s) affecting security
   Introduction to the Architecture

The basic purpose of the Infrastructure is intrusion prevention and risk reduction. More specifically, the purpose of the Infrastructure is to provide a framework for the effective deployment and operation of Policy Implementer solutions to aid in tasks such as:
Obtaining Information about threats and incidents
Taking Defensive Actions to stop harm and losses
Network Configuration Management and Asset Management are also provided.

The distributed framework provides, for example:
a structure for scheduled invocation of those elements called for by or packaged in the Policy Implementers;
a set of services that are used in common by these invoked elements;
a set of services for controlling and constraining the invoked elements;
a set of services for deploying the Policy Implementers parts;
a structure for communication within the framework;
facilities for aggregation, correlation, and analysis of information;
a structure for distribution and administration of the framework;
a structure for effecting an e-commerce process for the purchase of the framework, subscriptions and licensees for its use, Policy Implementers, and specific other elements;
a structure for the full-cycle of policy definition, policy enforcement, policy deployment, policy breach detection (problems: faults, conditions, issues, or events), problem isolation, problem reporting, problem response, and system reconfiguration or repair.

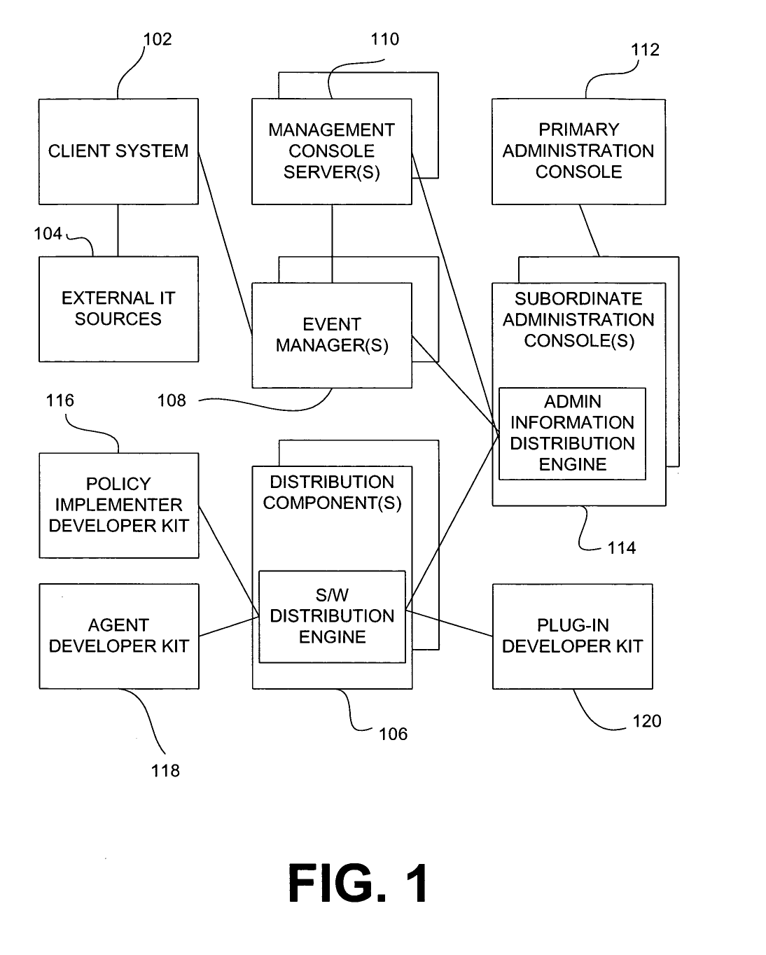

An embodiment of the Infrastructure includes the components as shown in FIG. 1: including the Management Framework and the Installed System Framework. The Management Framework and Installed System Framework closely model each other, but the descriptions provided here differentiate for emphasis. The Management Framework provides strong Developer and Assurance Components which provide complete facilities for internal and external developers, whereas the Installed System Framework provides less emphasis on the complete functionality in those components. Only the Management Framework includes the complete E-commerce Component. Policy Implementers submitted through the Policy Implementation Submission Infrastructure Component in an Installed System Framework are not subject to sale from the Management Framework on an automatic basis.

The Management Framework includes client system(s) 102, distribution component(s) 106, Policy Implementation submission component(s) 110, developer component(s) 118, assurance component(s), E-commerce component(s), inventory component(s), analysis and discovery component(s), license and security component(s), event manager(s), management console(s), primary Administration console 112, subordinate administration console(s) 114, and software development kits (SDK's).

The Installed System Framework includes client system(s), distribution component(s), Policy Implementation submission component(s), developer component(s), assurance component(s), E-commerce component(s), inventory component(s), analysis and discovery component(s), license and security component(s), event manager(s), management console(s), subordinate administration console(s), and software development kits (SDK's). The Policy Implementation submission component(s), developer component(s), assurance component(s), E-commerce component(s), and SDK's are optional.

As a general matter, all components of either framework may be in communication with each other, although selected links are depicted in FIG. 1 and will be described below. Also, Policy Implementers consist of packages of elements where the elements may be installed on different components in the Infrastructure.

Policy Implementers

The Infrastructure described here provides a distributed framework and process for policy-based computer and network security, network management and configuration management in any collection of computing or networking devices. This framework encompasses the apparatus and process for implementing security, network, and configuration policies, called ‘Policy Implementers’. A Policy Implementer is a body of computer program code stating some set of the following:
measurement rules, measurements to be taken, measurement schedules, and measuring algorithms;
notification rules and issue workflow rules;
measurement and event data rollup and correlation rules;
analysis algorithms;
dashboard tools;
reporting rules and algorithms, including audit and accreditation templates;
descriptive and user guidance information, including links to standards, etc;
decision guidelines, with workflow and business rules;
commands for reacting, reconfiguration rules, and prevention and response effecting algorithms;
deployment rules and version information; and
certifications of correctness, efficacy and applicability.

Policy Implementers specify and control the deployment and activation of the code and proper parameters throughout an instance of the distributed framework to maintain an improved level of operation of the network in a managed process.

A Policy Implementer names a configuration. Policy Implementers provide a facility to coordinate the detection, analysis, and response to network inefficiencies, errors, outages, security events, software aging, and other factors, using some set of coding, rules, and the tools available in the Infrastructure across one or more devices within the Infrastructure Framework. A Policy Implementer consists of one or multiple application service elements (ASE). Each element provides one part necessary for the successful enforcement of the Policy being implemented. The elements of the Policy Implementer ASE rely upon the infrastructure provided by the Framework to provide program to program associations and connections, remote operations management, and reliable data transfer, among other facilities.

Policy Implementers can also provide a manageable tool greatly simplifying the burden on systems administrators, packaging most or all tools and parameters needed to detect and respond where needed to manage the network of devices. Policy Implementers provide a simplified mechanism for ensuring effective and auditable deployment of the proper structure for network protection. Policy Implementers provide a packaging facility to allow for the sale of those elements and knowledge to end users and organizations which are needed to address a specific type of vulnerability or issue.

Policy Implementers can provide a management tool for compliance. With Policy Implementers, an organization may more easily demonstrate due diligence in meeting specifications of legislation (Sarbanes-Oxley, HIPAA, GLBA) or other industry or government standards (e.g. NIST). When a Policy Implementer is deployed throughout an organization's network, it installs some collection of agents, plug-ins, and rules that address the measurement/detection, analysis, and reaction requirements of the policy, transparently adjusting to the actual structure of the network and the devices in it.

Policy Implementers can provide a management tool for accreditation. With Policy Implementers, an accrediting organization need only specify the minimum set of Policy Implementers that need be deployed into an organization, and be satisfied that those Policy Implementers are up to the task of breach detection and enforcement of the Policies which they implement. An organization being audited for accreditation need only show that they have deployed the proper Policy Implementers and that they have kept them up to date.

Policy Implementers can provide a management tool for systems administration. Policy Implementers consist of components and rules that are each specific to an application or platform in the environment. A sign-on policy enforcer would include an Agent that detects poor rules on an ERP system on a mainframe running SAP, as well as one for a mainframe running PeopleSoft, one for a Solaris system running SAP, etc. It would also include an application detector Agent. It would include a Management Console plug-in for displaying detected installations of ERP systems in the network, non-conformant installations and installations that are properly protected. The Policy Implementer would also include the event descriptions for the messages coming from these agents, correlation rules for assisting the analysis, the alert descriptions needed for analysis, decision rules that allow a user interaction where needed to respond to breaches, the report descriptions for the accreditation proceedings, auditor reporting tools, and administrative information. With one instruction to deploy the Policy Implementer, all of the needed rules and programming would be sent to the proper devices and activated according to proper schedules.

Policy Implementers can also be specified as a part of another Policy Implementer. This encasement technique allows for easier deployment of the Policy.

Policy Implementers can provide a management tool for development. Rather than attempt the difficult and complex task of developing an entire implementation of a policy in one step, the Policy Implementer provides a task structuring and phasing device to limit the scope of development to a smaller requirement at the beginning and retain discipline as the scope of implementation grows on subsequent versions.

Data and database objects (stored procedures, data structure definitions, etc.) are included in the Data Repository.

The data stored in the Repository is generally classified into categories for distribution. These categories are set in the Infrastructure Management Framework Repository.

| | | Categories of Data |
|---|---|---|
| Database Area | Purposes Served by Area | Stored |
| Administration | Organizational Structures, | System Parameters: Control |
| Data | Users, Remote Device, and | information for the database |
| | Security Management - | programming which controls |
| | Manages Customer | debugging, logging, and |
| | structure, roles, | other internal functioning. |
| | permissions, user, device, | Some portions of it control |
| | and other security | internal security of the |
| | information. | system and should not be |
| | E-Commerce, Subscription and | altered or the operation of |
| | Licensing - Stores and | the system will cease. |
| | manages licensing and | Infrastructure Data: Data that |
| | accounting information. | the user should not ever see |
| | Database Integrity - Stores, | or alter. Alteration of it will |
| | distributes, and manages | in many cases cause the |
| | the integrity and basic | system to malfunction or |
| | security of the repository on | entirely cease operating. |
| | a distributed, tiered basis. | Security Data: Data controlling |
| | Ensures that the license | accessibility to the |
| | structure and permission | application data in the |
| | management system is not | database. Some security |
| | subverted. | related data is Base data, and |
| | Database and Base Data | should not be changed by |
| | Deployment - Provides the | the customer, and some is |
| | distribution and tiering | infrastructure data which |
| | mechanism for the | should not be changed by |
| | repository used for | the customer or any |
| | Administration of the | application programmer. |
| | Infrastructure system. | Base Data: Data where a service |
| | Provides consistency of | provider has changed the |
| | configuration management | values of tables or rows that |
| | throughout the Customer | the end user is not supposed |
| | community. | to alter, but application |
| | Base Data Management - | programmers at customer |
| | Stores and manages the | may add to. |
| | basic system information | |
| | for Infrastructure, | |
| | including: | |
| | Error Codes and Messages | |
| | Breach, Alert, Event, | |
| | Component, Rule, Policy | |
| | Implementer, Template | |
| | types and naming. | |
| | Reference Values and | |
| | Validation Values | |
| | System Parameter Management | |
| | Base Security information | |
| Customer/ | Managed System Inventory | Initial Customer Data: Data |
| Developer | Tracking - Stores the | where a service provider has |
| DB | Inventory information | set some values of tables or |
| | found through discovery or | rows that the user is |
| | entered by customers. | supposed to use initially and |
| | Deployed System Tasking and | may alter at will. |
| | Work Scheduling - | Customer Data: Data that the |
| | Manages the assignment of | customer has created and |
| | work to Infrastructure | that a service provider |
| | components. | should not alter the |
| | Schedules | semantics of, but may |
| | Plans | update the structure |
| | Rules | underlying the data. |
| | Tasks | |
| | Commands | |
| | Customer Communication | |
| | Tracking - Stores user input | |
| | regarding Alerts and | |
| | messages sent to users. | |
| | Messages | |
| | Request Response Data | |
| | Report Information | |
| | Question/Answer | |
| | Management | |
| | Error and Status Message | |
| | Tracking | |
| | Organizational Structures, | |
| | Users, Remote Device, and | |
| | Security Management - | |
| | Manages Customer | |
| | structure, roles, | |
| | permissions, user, device, | |
| | and other security | |
| | information. | |
| Development | Deployment and Component | Base Data: Data where a service |
| Management | Version Tracking and | provider has changed the values |
| DB | Development Record Keeping - | of tables or rows that the end |
| | Manages Configuration of the | user is not supposed to alter, but |
| | following Infrastructure | application programmers at |
| | components. | customer may add to. |
| | Agents | |
| | Plug-ins | |
| | Database Objects | |
| | Database Base Information | |
| | Web Pages | |
| | Other Components | |
| | E-Commerce, Subscription and | |
| | Licensing - Stores and manages | |
| | licensing and accounting | |
| | information. | |
| Code Repository | | Computer Code |
| Agent/Plug-in | Deployed System Tasking and | Base Data: Data where a service |
| Information | Work Scheduling - Manages | provider has changed the values |
| /Directory DB | the assignment of work to | of tables or rows that the end |
| | Infrastructure components. | user is not supposed to alter, but |
| | Schedules | application programmers at |
| | Plans | customer may add to. |
| | Rules | |
| | Tasks | |
| | Commands | |
| | Database and Base Data | |
| | Deployment - Provides the | |
| | distribution and tiering | |
| | mechanism for the repository | |
| | used for Administration of the | |
| | Infrastructure system. Provides | |
| | consistency of configuration | |
| | management throughout the | |
| | Customer community. | |
| Event/Alert/ | Alert Workflow Management and | Customer Discovery Data: Data that |
| Status Data | Information Management for | is generated due to the actions of |
| (Relational) | Semi-Automatic Alert | the user by setting up discovery |
| | Response Process Control - | plans. |
| | Stores generated Alerts and | |
| | manages the workflow for | |
| | alerts up to the initiation of | |
| | responses. | |
| | Automated Response Rule | |
| | Management - Provides | |
| | management of responses and | |
| | establishment of rules. | |
| | Event Receipt - Stores received | |
| | Events and manages the receipt | |
| | of Events. | |
| | Discovery and Breach Recording - | |
| | Stores discovery information | |
| | and Breach Information and | |
| | manages those processes. | |
| | Data Coalescing - Manages the | |
| | processes for Coalescing of | |
| | Discovery data and generation | |
| | of Inventory | |
| | Automatic Metrics Measurement - | |
| | Stores the rules and results of | |
| | Metrics calculation for | |
| | statistical correlation and for | |
| | Infrastructure performance and | |
| | operation management. | |
| | Query and Reporting Facility - | |
| | stores rules, templates, lists, | |
| | and content; and manages the | |
| | queries and reports for the | |
| | Infrastructure, including: | |
| | Basic Data Extract | |
| | Evaluation | |
| | Audit Information Tracking | |
| | Accreditation Information | |
| | Tracking | |
| | Questionnaire Tracking | |
| Issue Data | Problem Management - Stores | User Entered Comments |
| | reported problems encountered | |
| | by users related to specific | |
| | components or in general. | |
| | (Data is not necessarily stored | |
| | in the same database.) | |
| Configuration | Managed System Inventory | Base Data: Data where a service |
| Database | Tracking - Stores the Inventory | provider has changed the values |
| | information found through | of tables or rows that the end |
| | discovery or entered by | user is not supposed to alter, but |
| | customers. | application programmers at |
| | Deployment and Component | customer may add to. |
| | Version Tracking and | Customer Inventory Data: Data that |
| | Development Record Keeping - | is generated due to the actions of |
| | Manages Configuration of the | the user thru a workflow process |
| | following Infrastructure | after discovery. |
| | components. | Sample Data: Data where a service |
| | Agents | provider has changed the values |
| | Plug-ins | of tables or rows that the user is |
| | Database Objects | supposed to alter when used in a |
| | Database Base Information | tutorial. |
| | Web Pages | |
| | Other Components | |
| | Database and Base Data | |
| | Deployment - Provides the | |
| | distribution and tiering | |
| | mechanism for the repository | |
| | used for Administration of the | |
| | Infrastructure system. Provides | |
| | consistency of configuration | |
| | management throughout the | |
| | Customer community. | |

Licensing and Security Components

Licensing and Security Components control the use of the system. Only sanctioned devices may receive the Infrastructure software and only registered devices and users may submit new data to the repository or obtain information from it. Licensing and security should be distributed. Licenses control the number of client systems or networks that may be sanctioned or from which information may be collected. These licenses are established in the E-Commerce component, and are controlled centrally to ensure the collection of revenues. For that reason, the licenses should be distributed and the system repositories should be protected so that licenses may not be compromised. Thus the system is tiered for security purposes, and the repositories distribute licenses and security information downward as needed to provide for the operation of customer systems under the licensing and security. Since multiple levels of parent-child relationships can exist, licenses and accompanying security information should be propagated from parent to child so long as the child is properly authorized to receive those updates, until no child needs access to the license. The Distribution components, in concert with the Controllers, enforce software licensing.

Client System

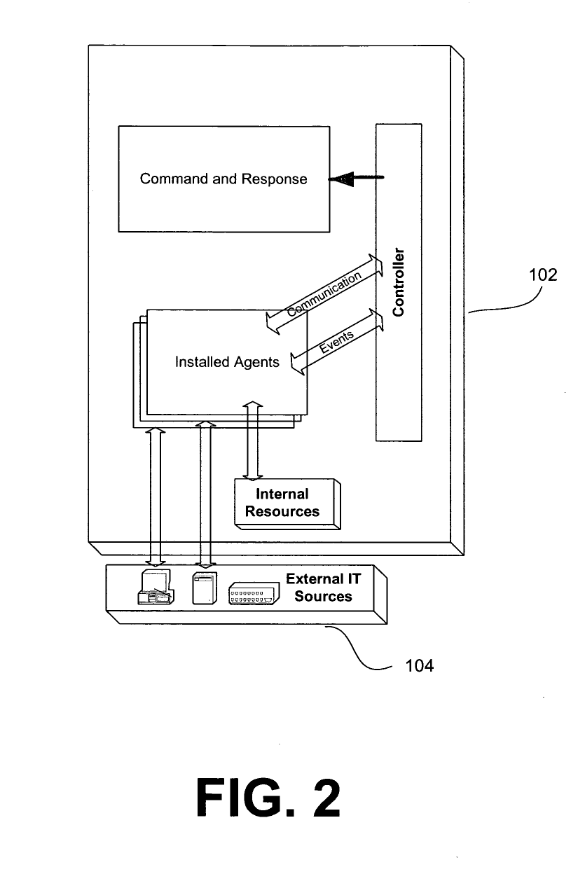

FIG. 2 is a block diagram of the client system 102 components and the external information technology (IT) sources 104 shown in FIG. 1, according to one embodiment of the invention. The client system represents a computer system upon which, at a minimum, a controller is installed. Typically, this is a system to which agents from a Policy Implementer are deployed rather than other framework components. The client system may or may not represent the target of the agent's operations, since the agents installed on it may detect and control external devices. In the framework, protections over Infrastructure Components other than the client system may also be established by the installation of a controller on those components and the distribution of policy implementer agents to that controller.

Controller

The controller on the client system represents a mediation point between an agent and the rest of the functional architecture. The controller provides critical agent management and monitoring functions, insuring that its agents do not operate outside specified bounds. It also provides secure communication with other framework components, and provides a unique identity for the device it is resident on.

If the agent is not targeting the client system upon which it is installed, it performs its operations on one or more external IT sources. Typically, these agents utilize network management, such as simple network management protocol (SNMP), or other control protocols to communicate with their targets.

E-Commerce Components

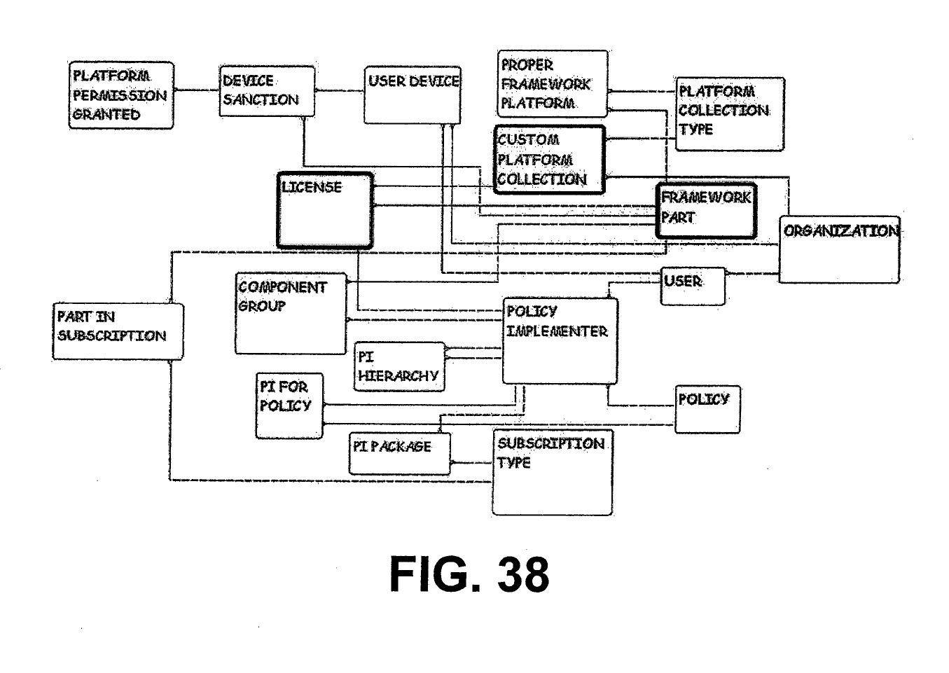

The distribution architecture may include various subcomponents, detailed below. In one embodiment, the distribution architecture includes an E-Commerce Component (See FIG. 38) providing a user Web site providing a graphical user interface for software selection, purchase and deployment. Only authorized, registered users are granted the necessary permissions to perform these functions. When Framework software is purchased, the sanctioning process provides for establishing the framework component on a customer device and the retrieving of the framework software to that device from a distribution component. When Policy Implementer software is purchased, the licenses for it are deployed to a proper administration and distribution components, allowing for the distribution of the software to a local client system, or to be added to the customer's software distribution engine for enterprise distribution.

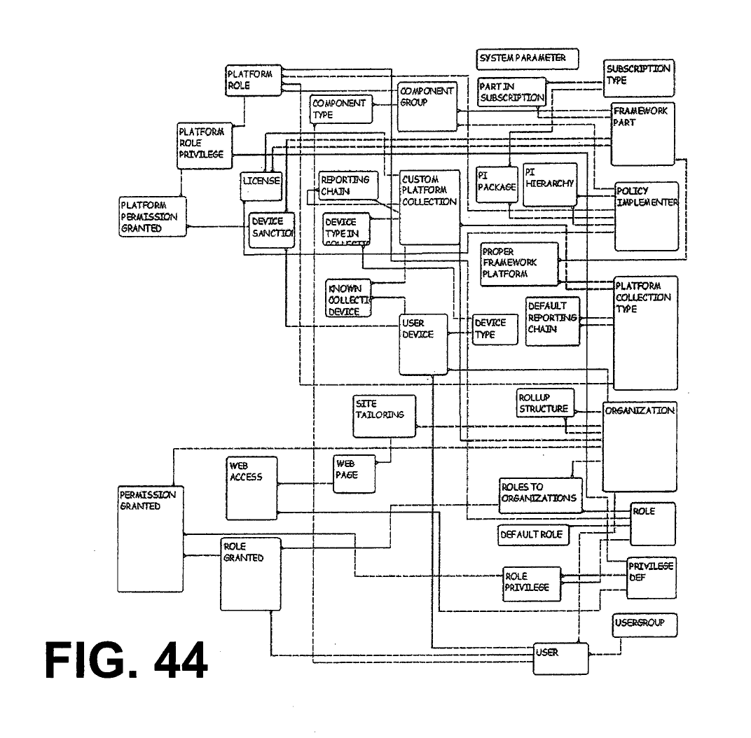

A Data Structure is shown in FIG. 44 which provides the persistence needed for enforcing security in the Infrastructure.

The license and security and distribution components, in cooperation with the controllers, enforce software licensing, software installation and upgrades, user access, data submission, and all other aspects of system use.

All users of the user interfaces of the system should (relaxed for development) be registered to move beyond the basic informational elements of the websites of the system. All devices that connect to framework components should be registered and known by the components to which they connect.

All Infrastructure components should be sanctioned to serve as a component of the system framework. The sanctioning process is distinct from the licensing process as it applies to the operation of a certain framework component on a certain device.

All Policy Implementer components should be installed on devices that are covered under a proper license for the Policy implementer to operate or to be deployed. Authorization for distribution typically comes in the way of valid ‘per-device’ and ‘per-network’ software subscriptions, which entitle a registered device in the network to obtain new versions of Policy Implementer or Framework software code and configuration information from a distribution engine so long as the number of devices registered for the code in the device or network ‘asset-group’ does not exceed the number allowed by the license (or subscription) for that ‘asset-group’. Authorization for distribution also allows for a child distribution engine to receive new versions of code as it is released, so long as the number of licenses for that code in ‘asset-groups’ below that distribution engine is greater than one and so long as the distribution engine remains in contact with the parent administration system. Authorization to operate and authorization to submit data to management nodes are controlled in a similar license based control facility.

Distribution Components

FIG. 3 is a block diagram of the distribution components 106 shown in FIG. 1, according to one embodiment of the invention. Distribution delivers software, configuration data, and updates to target systems, including client systems as well as other core components. The precise process of performing distribution varies depending upon whether the update is for programming, data, or data structure.

FIG. 24 is a process flow chart showing a distribution hierarchy, according to an embodiment of the invention. For larger networks, distribution engines 2402, 2404, 2406, 2408, 2410 can be scaled and tiered to provide a manageable framework for software distribution. Distribution is performed top-down in a hierarchical manner, where the engines are logically arranged essentially as a hierarchical tree (as shown in FIG. 24), with redundancy. Each engine, or node, in the distribution tree only knows about those distribution nodes directly beneath it, but the children are under multiple parents in a priority scheme to provide the redundancy. Non-leaf nodes with Data Repositories higher in the tree contain summary meta-data about all the engines, devices, Infrastructure Framework and the Policy Implementer components managed beneath it. License information, but not configuration information is stored at these nodes for non-immediate children. Conversely, leaf nodes with Data Repositories contain detailed information about Infrastructure Framework and the Policy Implementer software and configuration releases and device data that is necessary for managing component instances. Distribution engines regularly communicate via the distribution client with their parent engine asking it for any software updates that are available. Updates are pulled down from the parent and persisted in the engine's local CODE REPOSITORY. Base Data and License is pulled down and stored in the DATA REPOSITORY. At leaf nodes, Controllers retrieve these updates the next time they query the distribution service.

Using this pull-down approach, software updates propagate down the hierarchy from the root as each child engine asks for updates. Child engines can be configured to poll its parent at any regular time interval, or at specific times, or on demand. Therefore, the maximum latency for an update to reach a Controllers amounts to the sum of the maximum time that it takes each engine to receive an update from its parent going all the way up to the root.

At the root of this distribution hierarchy resides a “master” distribution engine 2402 where copies of all the software, base data, and licenses for all the Controllers beneath it are stored. Each Infrastructure implementation may have one or more master engines at a customer site that serve this purpose, and additional masters may reside elsewhere. A master is provided for Application Service Provider customers as well. A service provider provides a separate master distribution engine that customer implementations can use as their root engine in order to receive live updates to their existing repositories. Customers can elect to either be connected to a service provider master engine, or they can maintain their own (disconnected) master distribution engine internally. In this case, software and data updates are performed manually at the master and then propagate down to the Controllers.

License Distribution

Licenses and sanction information are established in the database of the Parent Administration Component, and are then deployed to all databases toward the user devices which they affect.

As a result of device registration, the device becomes a member of an asset-group of sanctioned devices. Licenses for the asset-group may then be applied to the operation of Policy Implementers on the device.

A machine may be ‘sanctioned’ and licensed for the hosting and operation of zero or more of the Policy Implementer components, and is counted by the licensing mechanism before it is allowed to operate for each of those components.

Software Distribution Engine

The software distribution engine is responsible for managing all software deployments in an implementation of the system.

Distribution delivers software, configuration data, and updates to target systems, including client systems as well as other core components. Administration and Distribution components can be tiered, so that multiple levels of parent-child relationships can exist, whereby deployments and updates propagate from parent to child so long as the child is properly authorized to receive those updates. Deployment involves programming, data, and data structure updates to child systems. The precise facility and methodology of performing deployment varies among these three types of updates.

In the following, the term Component is used to refer to specific software configuration items as used in the Infrastructure. A Configuration Item in this description is limited to be a software element that is under control of the Component Management configuration management system. It refers to the deployable format of software in the Infrastructure rather than the source code from which the deployable format stems unless they are the same. It includes all elements that contribute to the deployable baseline.

Examples are:
All code files
Infrastructure elements
Compile/build/install scripts
Configuration files and scripts
Test drivers

The code deployed in the Infrastructure may include:
Database Base Data (and occasional other data)
Database Objects and Structure Changes
Framework Code
Policy Implementer Code
Non-infrastructure code (3^{rd} party products, etc.)
Configuration Data

Each of these types may be deployed differently.

Policy Implementer Distribution

Policy Implementer Distribution is implemented by the Distribution Component of the Infrastructure. Distribution of Framework components may be carried out in a similar manner. The distribution is begun when a new sanction, license, or update occurs.

Repositories Distribution

Data Repository Distribution

Base Data Management and Deployment

Base data is information persisted in the databases of the Infrastructure that is generally common to all installations. It includes control information for the Management Framework and for the Installed Frameworks. It is differentiated from other data in that it is not specific to any customer. It includes template information form many objects and sample data. Without this data, the Infrastructure could not properly function. FIG. 1 provides the data structure components comprising this base data.

Base data is deployed with each Installed Framework. Updates to the base data must be copied to all Installed Frameworks from the Management Framework.

Base data and the database objects (stored procedures, data structure definitions, etc.) for the Infrastructure are deployed automatically by the Tiered Database Deployment facility of the Infrastructure. This facility consists of the elements shown on FIG. 3. The process involved in Tiered Database Deployment is shown in the process diagram in FIG. 24.

License and Sanction data is distributed by the same facility as Base Data. Security over the distribution is strict, and is aimed at automatic distribution and 100% correctness of result in all cases. An incremental distribution based upon a differential calculation is used to shorten the timeframe for distribution and to reduce bandwidth. The distribution is carried out between databases directly where possible so that the differential may be computed quickly.

The database serving as the source of the base data and the licensing data need not be the same. The database serving as the source of the base data and objects is one of the Quality Assurance databases so that all objects in the system are appropriately tested before deployment. Special views and mechanisms are set up in this database so that only that data and those objects appropriate for deployment to the target or child database may be seen during the deployment.

Then source database for licensing and security information is a database which has a window into the Main Administration database where E-commerce business rules are controlling the alteration of information. This window limits the information visible to the child and guarantees that the child cannot alter the data.

The methodology for determining differences is based upon a table (called DB_OBJECT_VERSIONS) that contains a series of metrics which form a signature for all objects and data in the database. Upon any attempt to read from this table, a trigger in the database recalculates the signatures based upon the present state of the objects in the database. This recalculation is done efficiently relative to the speed of the transmission of the contents of the difference.

For any row of the data in the DB_OBJECT_VERSIONS table where the signatures from the table do not match the signature calculated at the child database, an attempt is made to obtain the newer object or data. The data is obtained in proper dependency order for updating the child database. Once completed, the signature at the child is recalculated and checked against the signatures from the parent. If there is a difference, a database integrity breach is generated.

Any objects that do not exist in the child are created in this process. Any objects that exist in the child database but do not exist in the parent are retained. The process is carried out on a schedule and as the child is commanded to attempt the synchronization.

For data that is on the child database that should be communicated to the parent, a similar process is used, but the comparisons are against a ‘surrogate’ database for the child database rather than the main distribution database. Any data in the surrogate that should be used by the Management Framework is drawn out of the surrogate database in a strict procedure involving proper business rules that are specific to the data. Synchronization issues are avoided by using primary key generators that provide uniqueness at all child database.

Along with the licensing data, a special number called a security token is passed to the child database in this process. This token allows security procedures in the child to detect breaches of security or lapsing of licenses and to take appropriate action.

The utility of this mechanism is that the control data for the system is distributed and checked for accuracy on an automatic basis. Changes to the database structure are controlled and distributed as well.

Component Management

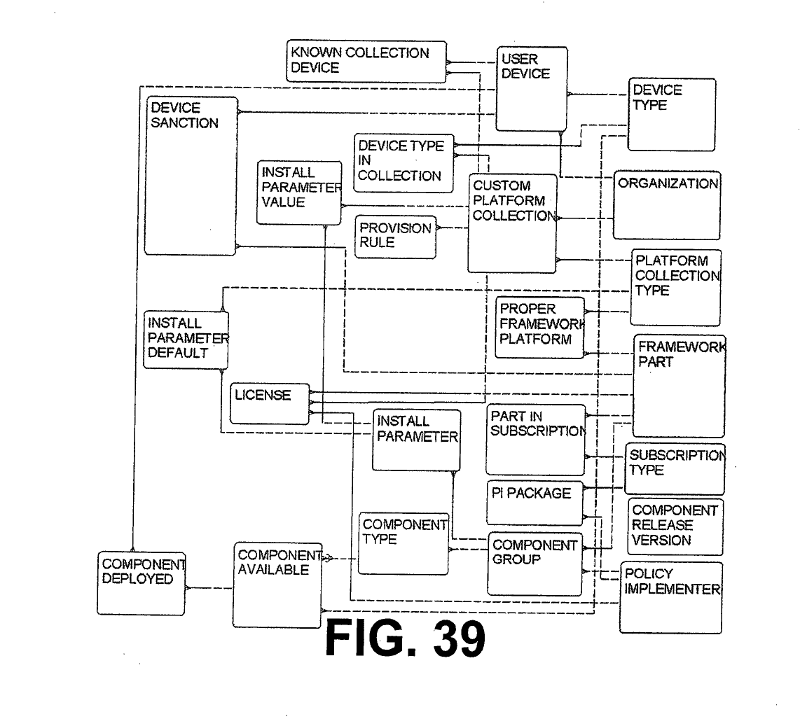

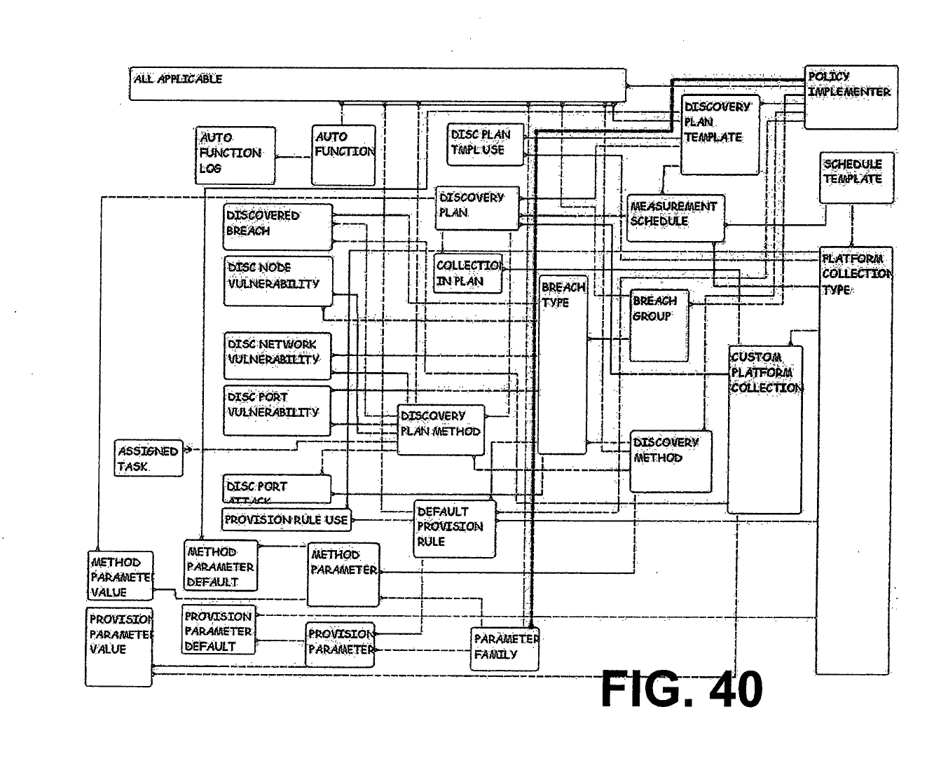

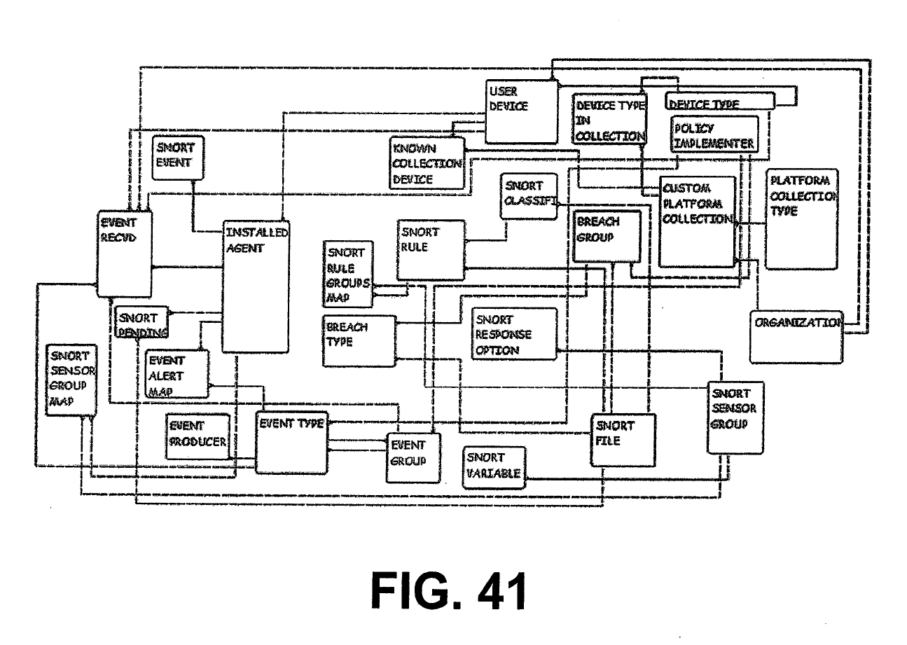

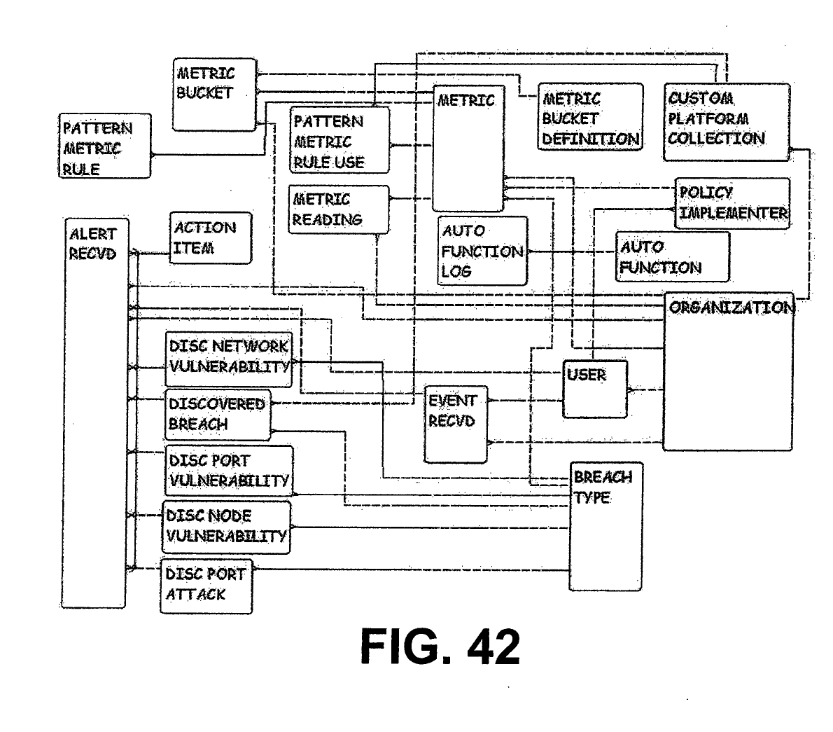

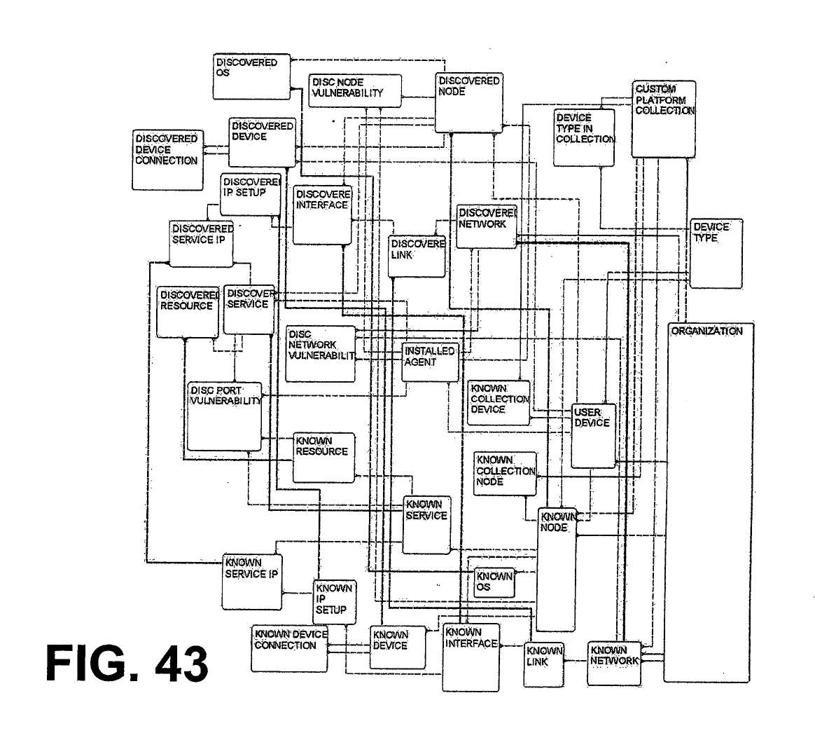

FIGS. 38-44 provide the data structure used for managing components of the Infrastructure.

Deliverable Components are under configuration management, and their readiness for deployment is tracked. The components are defined initially to be immutable—without a version. As the component is developed, it receives a version number and the list of these versions is a dynamic product configuration list. Those components with versions which are ready for deployment are added to a third component list. All of these lists are a part of the base data, and are thus deployed in the process above. Each child database that has a list of licensed and sanctioned devices automatically obtains these lists as they are updated.

Each Distribution Engine Database maintains a directory of all the licensed and sanctioned devices and components that it manages, along with configuration and deployment data for each. This deployment data contains information about the components' type, location, software release, and configuration release, among others. Using this data, the Distribution Service applies business logic to determine what updates need to be delivered to the Client.

Each child database that has a list of licensed and sanctioned devices will automatically generate a list of components that should be deployed and the device where they should be deployed to whenever new data is received from the parent regarding the components newly available. This last list is updated as components are deployed by the SOFTWARE DISTRIBUTION ENGINE, and the updates may be provided back to the parent for licensing controls.

The utility of the Component Management element is the ability to strongly control deployment of all Policy Implementers and Framework elements.

Code Repository

Software is stored in the CODE REPOSITORY, which contains current version and release information for each software component.

Event Managers

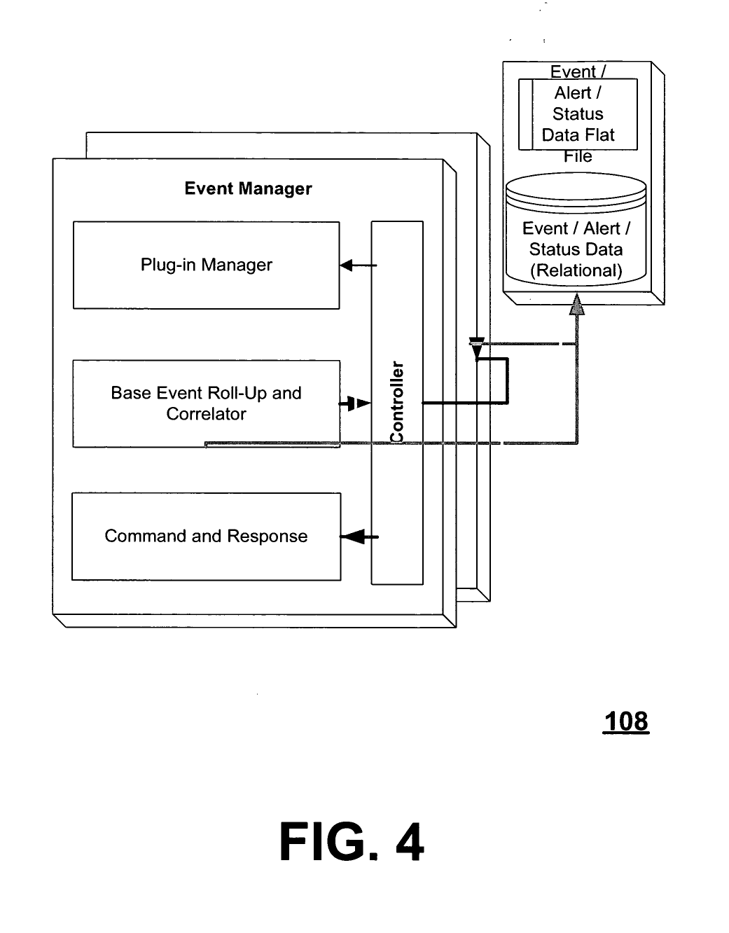

FIG. 4 is a block diagram of the event management components shown in FIG. 1, according to one embodiment of the invention. EVENT MANAGERS are responsible for performing two primary functions: Event analysis and Command propagation. EVENT MANAGERS subscribe to events from other EVENT MANAGERS or directly from CLIENT SYSTEMS. As a result of these subscriptions, EVENT MANAGERS are configured to receive, log, analyze and distribute events to other subscribers. This publish and subscribe architecture enables events to be analyzed, aggregated and combined through multiple processing layers. Subscribers to an EVENT MANAGER can include other EVENT MANAGERS, MANAGEMENT CONSOLE SERVERS or registered 3rd party Policy Implementer elements called plug-ins.

Consoles

Management Console

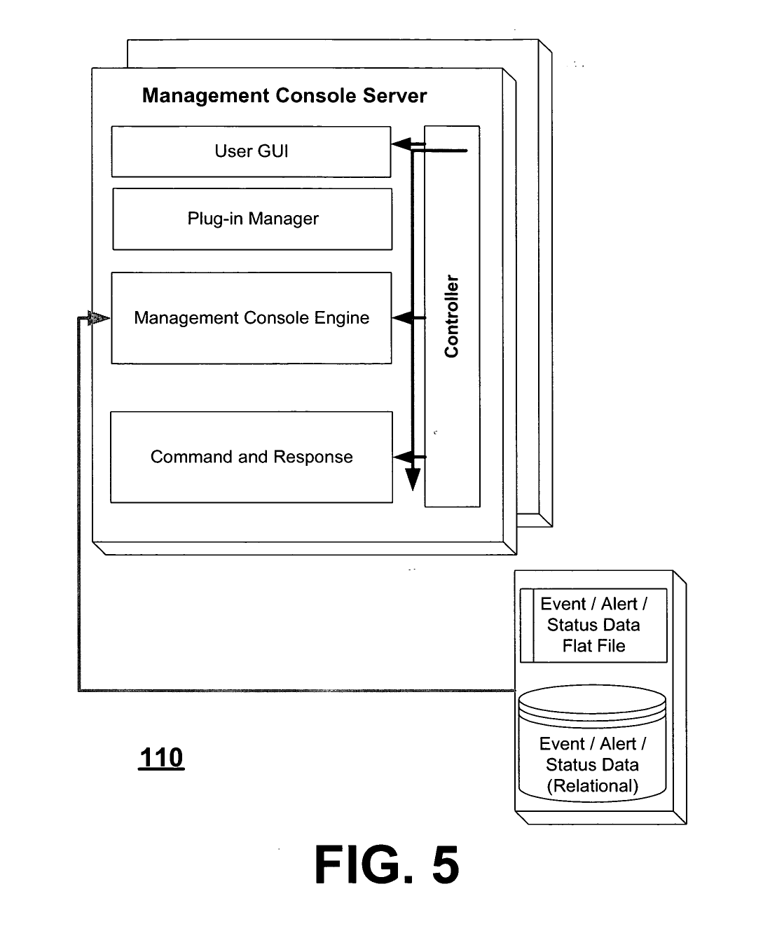

FIG. 5 is a block diagram of the management console server shown in FIG. 1, according to one embodiment of the invention. The MANAGEMENT CONSOLE SERVER provides the end users with a presentation mechanism to expose data and functions of the SYSTEM, customized by the elements of a Policy Implementer. As with all other SYSTEM components, a CONTROLLER is installed on the MANAGEMENT CONSOLE SERVER and is used to perform general management tasks including receiving and installing Framework and Policy Implementer software updates, and receiving configuration changes and administrative commands from the Administration Console Server for execution.

Management Console Server

The MANAGEMENT CONSOLE SERVER 110 (See FIG. 5) provides a basic user interface and is capable of dynamically incorporating new console modules in the form of Policy Implementer plug-ins. PLUG-INS are loaded into the MANAGEMENT CONSOLE SERVER by the PLUG-IN MANAGER. Utilizing the MANAGEMENT CONSOLE ENGINE, these plug-ins subscribe to events from known EVENT MANAGERS and provide custom display, analysis and management capabilities for those events. Additionally, plug-ins can persist data for future access and reporting and manage communications.

Primary Administration Console Server

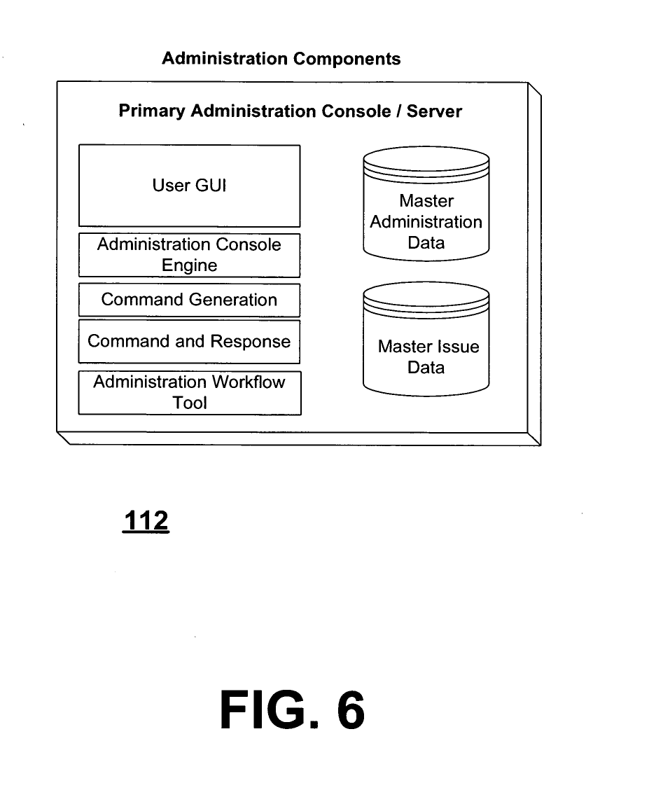

FIG. 6 is a block diagram of the primary administrative console 112 shown in FIG. 1, according to one embodiment of the invention. The PRIMARY ADMINISTRATION CONSOLE SERVER is a central warehouse of administration data used to track customers, sales and globally aggregated operational data. It is used as the ultimate arbiter of data validity in the SYSTEM. It also provides a senior level of management system tools for supervision of the SYSTEM.

Subordinate Administration Consoles

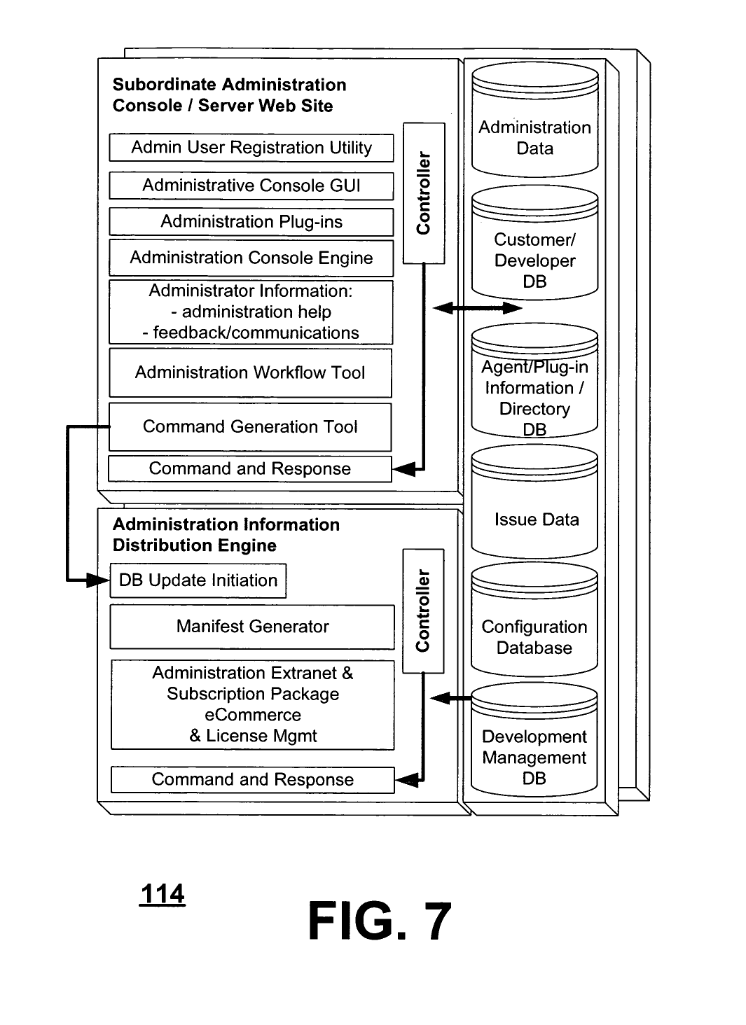

FIG. 7 is a block diagram of the subordinate administrative console 114 shown in FIG. 1, according to one embodiment of the invention. The SUBORDINATE ADMINISTRATION CONSOLES provide a facility for constrained administration of the Framework by administrative personnel at the service provider, or, if deployed at a customer's site, by the customer's Framework administrator. It allows for user authorization and password control, software release control (within proper bounds), system status evaluation, and system overrides.

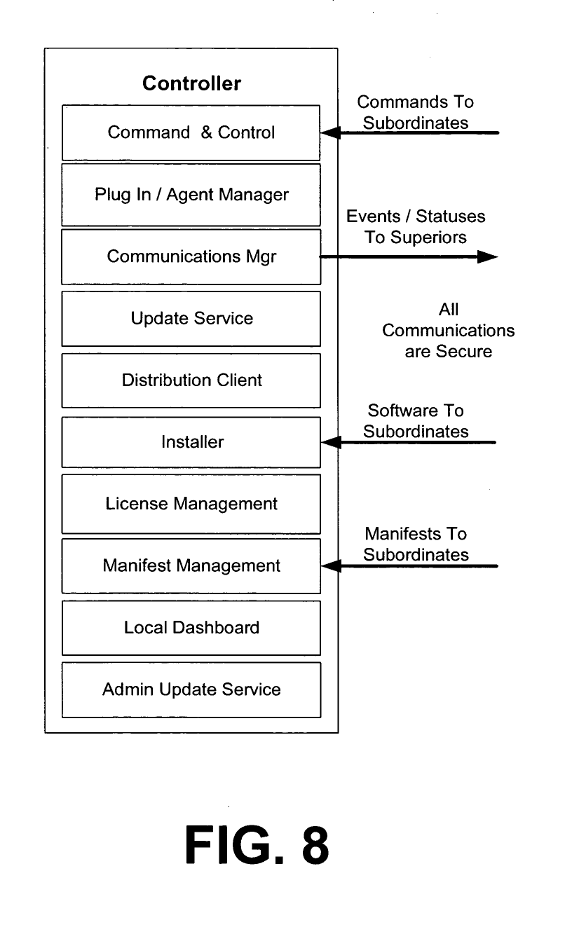

FIG. 8 is a block diagram of controllers, which are distributed throughout the functional architecture shown in FIG. 1, according to one embodiment of the invention. Each of the functional components depicted in FIG. 1 preferably include a software controller (hereinafter, just “controller”) used to control agents, plug-ins, or other software.

Developer Components

Developer Components may include:
User and Developer Relations components,
Software development kits (SDK's),
Policy Implementation submission components, and
Assurance components.
   User and Developer Relations Components
   User Web Site

The USER WEB SITE provides a graphical user interface for software selection, purchase and deployment. Only authorized, registered users are granted the necessary permissions to perform these functions. The Developer Community first enters into involvement with Infrastructure by contacting the User Web Site. They receive an initial system for trial and learn about the system on the User Web Site.

As Users increase their involvement, they may become developers, customer executives, certifiers, auditors, or accreditors.

Developers create Policy Implementer software for distribution and, potentially, for sale through Infrastructure.

Developer Exchange Web Site

The DEVELOPER EXCHANGE WEBSITE provides the tools necessary for software developers to make contributions to the software repository and to administer their software and their account with a service provider. Functions provided by this web site may include:
Developer registration
Developer code submission tool, which accepts new and updated software components and inserts them into the code certification process.
Code certification tools for third party certification and code review management.
   Executive, Auditor, and Accreditor Web Site

The EXECUTIVE, AUDITOR, AND ACCREDITOR WEBSITE provides the tools necessary for customer executives, the auditing and the accreditation community to ensure a proper discipline, process improvement, and duty of care over the security system they purchase from a service provider. They may use the Management Framework and/or their Installed Framework to manage the audit engagements and accreditation efforts needed and to administer their account with a service provider. Functions provided by this web site may include:
Executive, Auditor, and Accreditor registration.
Establish primary customer roles and responsibilities.
Provide vetting and executive information sharing.
Formulate and implement top level risk mitigation plans.
Implement selected executive management reporting process.
Engagement Information Management (primarily contact information, security privileges, and checklists only).
Access to Policy Implementer Certifications and Policy information.
Audit and Accreditation tools for third party reviews.
Provide appropriate education, training, and awareness to all stakeholders

A customer executive is a CXO level manager of an organization that has become a purchaser of Infrastructure. Executives are provided access to the Audit and Accreditation Community on a confidential basis and are provided with evaluations of their system beyond what is normally provided in the Installed Infrastructure.

Certifiers are vetted individuals who review Policy Implementer software. They have specialized access to the system resources.

Auditors are organizational users who provide Security Audits to clients who are Infrastructure customers. They are provided specialized access to Infrastructure, and their permissions for use are propagated on a very restricted basis to the Customer repositories for a specific engagement period. Customers MUST request the distribution of security access to their repositories, and the control over the access is managed at the Customer repository on a confirmation basis. The Auditors create their reports utilizing the facilities of the Infrastructure Management Framework system, and their reports are, in part, made available to customer executives on the Management Framework and other approved users on the Installed Framework.

Accreditors are organizations which certify the operation of entire systems for security at Infrastructure customers. Their representatives are provided specialized access to Infrastructure, and their permissions for use are propagated on a very restricted basis to the Customer repositories in the same way as the permissions of auditors, but for a specific and shorter duration. The Accreditors create their reports utilizing the facilities of the Infrastructure Management Framework system. Their accreditation certification report may be provided on the Management and Installed Framework systems at their discretion.

Policy Implementer Developer Kit (PoDK)

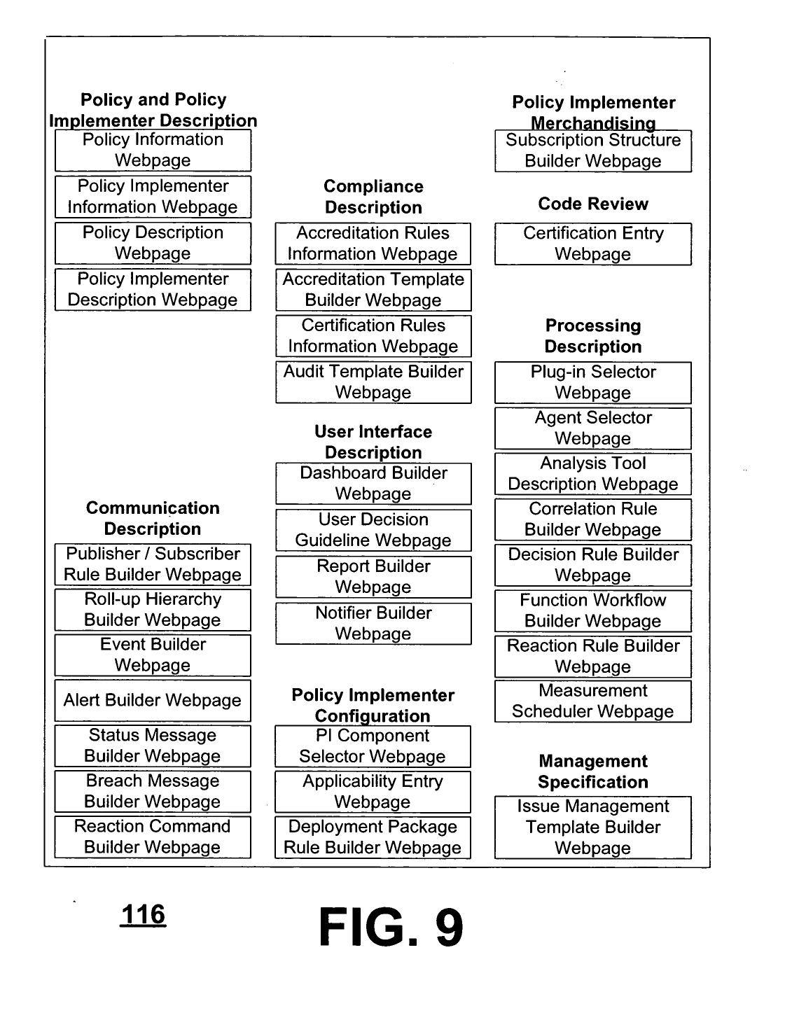

FIG. 9 is a block diagram of the policy implementer development kit 116 shown in FIG. 1, according to one embodiment of the invention. A POLICY IMPLEMENTER DEVELOPER KIT (PoDK), in conjunction with the Developer Component of the Infrastructure provides the tools to combine the functionality of certified system components, including Agents and Plug-ins, to provide the requisite functionality to deliver an implementation of a Policy. Provided as part of the PoDK is a facility to define and manage analysis and reaction rules, which form the foundation for workflow between the constituent components.

This kit along with other Developer Components provide a context for defining the relationships between agents, plug-ins, and rules. It also enables users (acting in the role of policy builders) to define accreditation criteria—ranges of acceptable behavior from elements of the policy system, and to define what actions to take when the policy is breached—when actual activity falls outside those limits. For example, using the PoDK, a policy builder could combine the functionality of an Intrusion Detection Agent, Vulnerability Monitoring Agent, Vulnerability Management Agent, Network Discovery Agent and Network Asset Management Plug-in by building a comprehensive set of analysis and reaction rules that integrate the operations of each component into a single policy application. This application would be responsible for insuring that an organization's network assets comply with a defined level of vulnerability protection and it would perform continuous audits of those assets.

The Policy and Policy Implementer Description section describes the Policy being implemented, and the way that the Policy Implementer is constructed to enforce the policy.

The Compliance Description section describes the intentions of the Compliance Directives, Programs, and Procedures related to the Policy being Implemented, and provide forms for reporting compliance and requesting Accreditation and Certification. It also states the ‘efficacy’ of the Implementer.

The Communication Description section describes the specific information and application protocols relating to the implementation of the Policy to fully inform the user and the Accreditation bodies regarding the nature of information transferred from and to the Client System and how it is used.

The Policy Implementer Configuration section provides a configuration tool to specify by selection any subcomponents of the Policy Implementer that have already been developed or to create a ‘stub’ for those subcomponents not yet begun. It also permits the specification of deployment and applicability (usability within other Implementers or for specific environments) of the Implementer, stating where its components will be placed within the Framework.

The Policy Implementer Merchandising section describes who needs the Implementer, provides FAQ and packaging information, and states pricing, sales policies, and subscription information. Includes information on insurance plans and adjunct services such as Compliance Assistance and Process Improvement Services.

The Processing Description section provides descriptions of all algorithms, rules, code, measurements, workflow, and processing schedules used to implement the Policy.

The Code Review section describes and specifies the process involved in and history of the review of the coding and methodology of the Implementer.

The User Interface Description section describes and specifies the dashboard facilities for the Implementer. Sets roles and privileges for the use of the User Interface, and allows tailoring of existing interface components.

The Management Specification section describes and specifies the issues raised by the Implementer and how they are directed (workflow) and how they may be cancelled based upon new events.

Agent Developer Kit

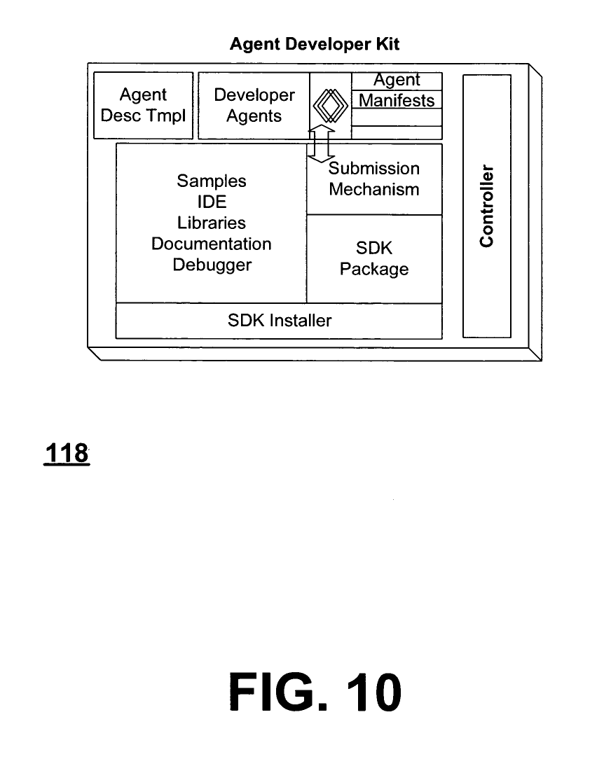

FIG. 10 is a block diagram of the agent developer kit 118 shown in FIG. 1, according to one embodiment of the invention. The Agent Developer Kit, in conjunction with the Developer Component provides the facilities for a software developer to implement new agents. The ADK is comprised of a number of tools, including:

Sample software (which provides a number of reference agent implementations); Integrated Development Environment (IDE); core agent software libraries; developer documentation; software debugger used to provide a facility to test and debug software; and a submission mechanism, which enables a developer to submit agent software to the Developer Exchange that the programmer is registered with.

A CONTROLLER is installed on the ADK both for use as a test mechanism for agent development, but also to receive and install software updates. This CONTROLLER has special facilities to enable debugging.

Plug-In Developer Kit (PDK)

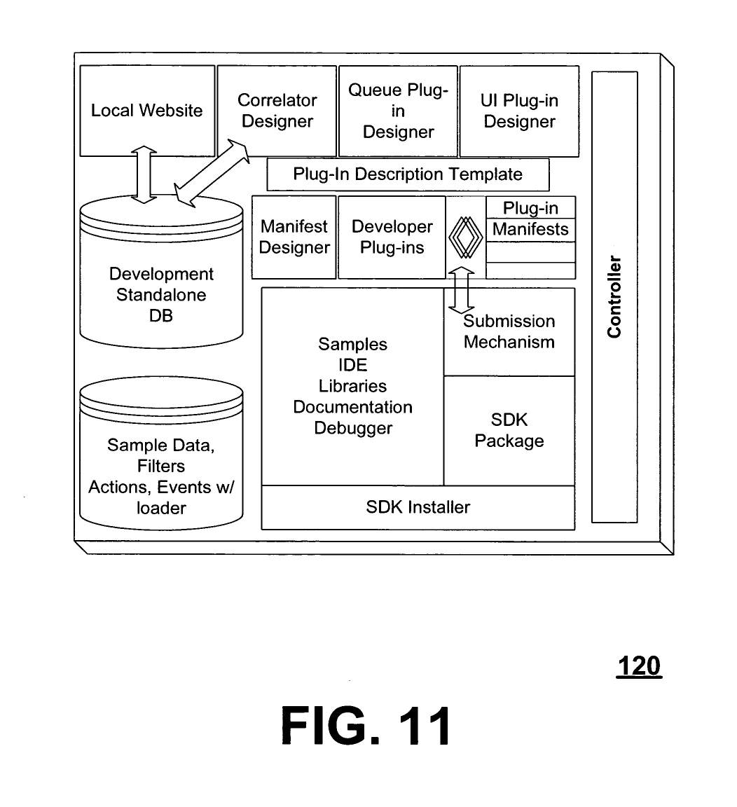

FIG. 11 is a block diagram of the plug-in developer kit 120 shown in FIG. 1, according to one embodiment of the invention. The PLUG-IN DEVELOPER KIT (PDK), in conjunction with the Developer Component provides developers with the facilities required to design, implement, test, and submit Plug-ins for certification. Optionally included with the kit are: sample code (including data, filter, actions and events); IDE (to enable rapid development of plug-ins); core software libraries; developer documentation; software debugger (used to provide a facility to test and debug software); a submission mechanism (which enables the developer to submit software to the Developer Exchange that the programmer is registered with); manifest designer, which allows the developer to customize the contents and format of the manifest file used to authorize the operation of plug-ins; a local website (which provides the facility to view those plug-ins which are management console oriented); correlator designer (which provides the tools necessary to build complex correlation rules for the plug-in); queue plug-in designer; and a UI plug-in designer (which provides the developer the tools needed to build a GUI plug-in which conforms to the management console specs).

A CONTROLLER is installed on the PDK both for use as a test mechanism for plug-in development, but also to receive and install software updates. This CONTROLLER has special facilities to enable debugging.

Administration and Security—Application Role Based Access Control and User Management

The organizations within the Infrastructure system community are reporting information about themselves to others, and this information, if released without review, if released to the wrong organizations, or if not released to the proper organizations at the proper time, will likely cause detriment to the organization. For this reason, organizations are structured into administrative (managerial), structural (control, response, or reporting), or review groupings within Infrastructure. This provides organizations with rights of access based upon the relationships which they have with other organizations.

Users in Infrastructure should be members of organizations. They may possibly be general members of the public (considered so when not otherwise authorized access), reporting users, reviewing users, administrators or analysis group members, depending upon the roles they have been assigned within their organization(s).

Machines or Devices are also roles in Infrastructure. These roles are not usually the same as the roles provided for users, but the roles operate in a similar manner.

The Infrastructure User Administration function allows an administrator to manage organizations, users, memberships of users in organizations, and other administrators and all of their associated roles and privileges. It also manages user registration, and allows secure access by registered users who may also update their own details.

The Infrastructure Device Administration function allows an administrator to manage licenses, subscriptions, device sanctioning, device functionality and description of devices in organizations and all of their associated roles and privileges. It also manages initial device registration, and allows secure access by registered devices.

The Security Component of the Infrastructure may provide:
For Users
   Registration with pre and post approval, and password specification (not assignment).
   Update user details—users can update their own details and set their own passwords.
   Logon—username and password authentication
   Lost password reset
For Administrators
   Manage user accounts—can manage registration function including organizational role assignment.
   Registration verification—ensure users provide a valid email address
   Audit trail of user activities (limited to last change recording? Or all change recording?)
   Management of roles—can associate privileges with any role
   Primed for Future:
   Preferences—any number of user preferences may be created
   Flexible Role Model, supporting two types of user role or group;
   ‘Members Only’ group—standard user group members where users are added or removed to/from a predefined user group
   ‘Common Interest’ group—users are grouped together by a shared common user attribute, e.g. preferences and/or categories.
For Devices
   Registration with pre and post approval, and device ID and password assignment.
   Update device location.
   Logon—Device ID and Device password authentication
   License based permissioning
   Function deprivation for unlicensed devices
Benefits
   Secure authorization mechanism for administrators and users
   Easy to use browser based interface for users and administrators
   Single Sign on—single sign on and single point of access to all site functions.
   Primed for Future:
   Very flexible group or role handling facility you can personalize communications to users or enable communication within special interest groups
   Support for permission based marketing—by using users preferences to support personalization

All of the content management and workflow functions depend on flexible mechanisms for user authentication and authorization.

### SUMMARY

The invention described above thus overcomes the disadvantages of known systems by enabling a customer to select policies for automatic distribution, installation, and configuration management onto the customer's network, and by improving the way that security events are collected, analyzed, and responded to.

While this invention has been described in various explanatory embodiments, other embodiments and variations can be effected by a person of ordinary skill in the art without departing from the scope of the invention.

We claim:

1. A method for implementing policy objectives, comprising:
developing a policy implementer;
registering at least one system component; and
selling the policy implementer, the policy implementer enabling the policy objectives to be instantiated in the network.

2. The method of claim 1, wherein the developing includes:
registering a developer;
providing a developer with access to a software development kit;
receiving the policy implementer from the developer; and
certifying the policy implementer based on predetermined criteria.

3. The method of claim 2, further comprising warehousing the certified policy implementer prior to the selling.

4. The method of claim 1, wherein the registering includes:
deploying controller code to the at least one system component;
sending system component registration information from the controller code to a distribution engine;
preparing a configuration manifest in the distribution engine; and
providing the configuration manifest to the controller code.

5. The method of claim 1, wherein the selling includes:
presenting a policy implementer catalog to a user, the catalog organized by policy objectives;
receiving a policy implementer selection from the user based on the presented catalog;
presenting a list of named network portions to the user; and
receiving a selected set of named network portions from the user based on the presented list of named network portions.

6. The method of claim 5, further including calculating an applicability map to associate the policy implementer selection with corresponding ones of a plurality of framework components needed to protect the selected set of named network portions, the applicability map listing a set of policy implementer component/framework component pairs, the plurality of framework components residing on the at least one system component.

7. The method of claim 6, further including distributing each of a plurality of policy implementer components to corresponding ones of the plurality of framework components based on the applicability map.

8. The method of claim 7, the distributing having:
receiving a notification in a controller code, the controller code associated with one of the at least one of the system components;
requesting one of the plurality of policy implementer components from a distribution engine;
receiving the one of the plurality of policy implementer components using the controller code;
receiving a configuration for the one of the plurality of policy implementer components using the controller code; and
installing the one of the plurality of policy implementer components using the controller code.

9. The method of claim 8, the distributing further having sending a notification of installation from the controller code to the distribution engine.

10. The method of claim 8, wherein the receiving the notification includes receiving one of an installation notification, an update notification, and a notification of a change to the configuration for the one of the plurality of policy implementer components.

11. The method of claim 8, the distributing further having invoking the one of the plurality of policy implementer components.

12. The method of claim 1, wherein the policy implementer code includes at least one of an agent, a plug-in, a rule, a query, and a data item.

13. The method of claim 1, further comprising selling a framework component after the registering and before the selling of the policy component.

14. The method of claim 13, the selling of the framework component including:
presenting a framework component list to a user;
receiving a framework component selection from the user;
reading a selection of the at least one system component; and
customizing the framework component based on the receiving and the reading.

15. The method of claim 14, further including distributing the framework component to the at least one system component.

16. The method of claim 15, the distributing having:
receiving a framework component update notification in a controller code, the controller code associated with the at least one system component;
requesting framework component updates from the distribution engine;
receiving the framework component using the controller code;
receiving a configuration for the framework component using the controller code; and
installing the framework component using the controller code.

17. The method of claim 16, wherein the receiving the framework component notification includes receiving one of an installation notification, an update notification, and a notification of a change to the configuration of the framework component.

18. The method of claim 16, the distributing further having invoking the framework component.

19. The method of claim 1, wherein the policy implementer is associated with one of security administration policy, technical safeguards policy, asset management policy and connectivity requirements policy.

20. A method for rapid development of a policy implementer, comprising:
planning an implementation of a policy;
describing the implementation;
coding the implementation into the policy implementer; and
certifying the policy implementer.

21. The method of claim 20, wherein the planning, the describing, the coding, and the certifying are executed collaboratively.

22. A method for planning development of a policy implementer, comprising:
registering as a user on a developer Web site;
planning the development; and
accessing a plan submission tool from the developer Web site, the plan submission tool enabling the user to submit the plan to a repository.

23. A method for describing development of a policy implementer, comprising:
registering as a user on a developer Web site;
describing the development to produce a description; and
accessing a description submission tool from the developer Web site, the description submission tool enabling the user to submit the description to a repository.

24. A method for coding a policy implementer, comprising:
registering as a user on a developer Web site;
coding the policy implementer; and
accessing a code submission tool from the developer Web site, the code submission tool enabling the user to submit the code to a repository.

25. A method for policy-based accrediting of a system, comprising:
registering as a user on a Web site;
accrediting to produce an accreditation; and
accessing an accreditation submission tool from the Web site, the accreditation submission tool enabling the user to submit the accreditation to a repository.

26. A method for policy-based auditing of a system, comprising:
registering as a user on a Web site;
auditing to produce an audit; and
accessing an audit submission tool from the Web site, the audit submission tool enabling the user to submit the audit to a repository.

27. A system configured to instantiate policy objectives, the system comprising a framework, the framework configured to distribute a policy implementer and to collect data from the network.

28. The system of claim 27 wherein the framework includes:
an interface to at least one client subsystem; and
at least one distribution subsystem coupled to the interface, the at least one distribution subsystem configured to distribute controller code to the interface, the at least one distribution subsystem further configured to distribute at least one portion of the policy implementer to the controller code, the controller code configured to install the at least one portion of the policy implementer on the client subsystem.

29. The system of claim 27, wherein the policy implementer includes at least one of an agent, a plug-in, and a rule.

30. The system of claim 27, wherein the policy implementer is associated with one of security administration policy, technical safeguards policy, asset management policy and connectivity requirements policy.

31. The system of claim 28, wherein the at least one distribution subsystem includes:
a developer Web portal;
a code submission tool coupled to the developer Web portal; and
a code repository coupled to the developer Web portal; wherein the developer Web portal is configured to provide access to the distribution subsystem by a developer, the code submission tool is configured to receive the policy implementer code from the developer, and the code repository is configured to store the policy implementer code.

32. The system of claim 31, wherein the at least one distribution subsystem further includes a policy implementer certification tool coupled to the Web portal, the policy implementer certification tool configured to certify the policy implementer code in response to a request from the developer.

33. The system of claim 31, wherein the at least one distribution subsystem further includes a developer e-commerce engine coupled to the Web portal, developer e-commerce engine configured to enable the sale of the policy implementer code by the developer.

34. The system of claim 28, wherein the at least one distribution subsystem includes:
a user Web portal;
a user-registration module coupled to the user Web portal; and
a user e-commerce engine coupled to the user Web portal, the user e-commerce engine configured to enable the sale of the policy implementer code to the user.

35. The system of claim 34, the user e-commerce engine configured to receive a policy implementer code selection from a user.

36. The system of claim 34, the user e-commerce engine configured to receive applicability information from the user, the applicability information indicating where portions of the policy implementer code will be placed within the client subsystem.

37. A method for managing a policy management lifecycle, comprising:
storing information content;
implementing a policy associated with the content; and
distributing the content.

38. The method of claim 37, wherein storing information content includes:
discovering a security requirement;
initiating a protection paradigm hypothesis;
organizing for protection and duty of care assignment; and
developing the policy.

39. The method of claim 37, wherein implementing a policy includes:
developing a policy implementer associated with the content; and
certifying the policy implementer.

40. The method of claim 37, wherein distributing the content includes:
selling a policy implementer;
distributing the policy implementer;
customizing the policy implementer;
configuring the policy implementer; and
operating the policy implementer.

41. A system for providing protection services, the system comprising a framework, wherein the framework is configured to perform at least one of analysis of data, collection of data, distribution, administration, and display of data based on a policy implementer construct.

42. The system of claim 41 wherein the framework is configured to perform analysis using pre-correlation, the pre-correlation having a focused filed-of-view to reduce the processing of data during a correlation.

43. The system of claim 41, the framework including a distribution system, the distribution system including at least one of a policy implementer component, license information, and data.

44. The system of claim 41, the framework including a distribution system, the distribution system including:
a parent distribution component; and
a child distribution component coupled to the parent distribution component, the child distribution component configured to receive one of a policy implementer component, license information, and data from the parent distribution component.

45. A method for developing policy-based protection services, comprising:
describing a policy requirement;
defining a generic policy implementer to address the policy requirement;
representing at least one of an asset, network, system, procedure, and a component with a named abstraction;
defining a required scope of protection for the named abstraction target; and
developing a specific policy implementer to collect a metric regarding the named abstraction.

46. The method of claim 45, further comprising:
naming a specific real element of at least one of a real asset, network, system, procedure, and component;
associating a named specific real element of at least one of a real asset, network, system, procedure, and component with the named abstraction; and
protecting the specific real element of at least one of a real asset, network, system, procedure, and component using the specific policy implementer.

47. The method of claim 46 further comprising:
initiating the protecting the specific real element of at least one of a real asset, network, system, procedure, and component by selecting the generic policy implementer for use; and
protecting the specific real element of at least one of a real asset, network, system, procedure, and component using the specific policy implementer.

48. The method of claim 46 further comprising:
developing a specific policy implementer to detect a policy breach for a named abstraction; and
protecting the specific real element of at least one of a real asset, network, system, procedure, and component using the specific policy implementer.

49. The method of claim 46 further comprising:
developing a specific policy implementer to configure a named abstraction; and
protecting the specific real element of at least one of a real asset, network, system, procedure, and component using the specific policy implementer.

50. The method of claim 46 further comprising:
developing a specific policy implementer to manage a named abstraction; and
protecting the specific real element of at least one of a real asset, network, system, procedure, and component using the specific policy implementer.

51. The method of claim 46 further comprising:
developing a specific policy implementer to detect a vulnerability of a named abstraction; and
protecting the specific real element of at least one of a real asset, network, system, procedure, and component using the specific policy implementer.

52. A method for providing policy-based protection services to a customer, comprising:
providing a framework; and
providing at least one policy implementer, the at least one policy implementer associated with security policy, the framework configured to distribute and manage the at least one policy implementer.

53. The method of claim 52, the providing the framework including providing a license to the customer to use a framework component external to a customer network.

54. The method of claim 52, the providing the framework including providing remote management of a customer network.

55. The method of claim 52, the providing the framework including providing a framework component to the customer for use under a license on a customer network.

56. The method of claim 52, the providing the framework including providing an automatic update to the framework based on a term of a license for a component of the framework.

57. The method of claim 52, the providing the at least one policy implementer including providing a plurality of the least one policy implementer in a group to the customer, the group being associated with a predetermined price.

58. The method of claim 52, the providing the at least one policy implementer including providing an automatic update to the at least one policy implementer based on a term of a license for the at least one policy implementer.

59. The method of claim 52, the providing the at least one policy implementer including providing the at least one policy implementer to the customer, each of the at least one policy implementer being individually priced.

60. The method of claim 52, wherein providing the at least one policy implementer is based on a customer-selected set of policy elements and a customer-selected resource, the resource to be protected according to the customer-selected set of policy elements.

61. The method of claim 60, further comprising providing an insurance component to the customer.

62. A method for sharing policy-based analysis, comprising:
identifying at least one of a threat, a vulnerability, and a deficiency in a policy to produce a policy requirement;
analyzing the policy requirement to produce at least one of a new policy element and revised policy element; and
sharing the at least one of a new policy element and revised policy element.

63. The method of claim 62, further comprising sharing the analysis of the policy requirement.

64. The method of claim 62, further comprising sharing the policy requirement.

65. The method of claim 62, wherein at least one of the identifying, the analyzing, and the sharing are motivated by an incentive plan.

66. A system configured to share policy-based analysis, comprising:
a policy library configured to contain policy descriptions and policy element descriptions; and
a policy implementer catalog linked to the policy library, the policy implementer catalog containing protections for the policy elements described in the policy library.

67. The system of claim 66, further comprising a user interface, the user interface coupled to the policy library and the policy implementer, the user-interface being configured to provide role-based access control.

68. A method for managing a collaborative development process, comprising:
providing a developer exchange Website;
registering a developer on the exchange Website; and
providing a policy implementer submission tool via the exchange Website.

69. The method of claim 68 wherein providing the policy implementer submission tool includes providing a workflow manager.

70. The method of claim 68 further comprising providing a user account for compensating a developer of a policy implementer.

71. A developer exchange Website, comprising:
a registration module configured to register at least one of a policy implementer planner, a policy implementer describer, a policy implementer developer, and a policy implementer certifier;
a policy implementer submission module; and
a workflow module configured to manage the development of a policy implementer.

72. The Website of claim 71, further comprising an accounting module configured to manage a compensation account for the at least one of the policy implementer planner, the policy implementer describer, the policy implementer developer, and the policy implementer certifier.

73. The Website of claim 71, further comprising a tool download utility, the tool download utility configured to download at least one of an agent developer kit, a plug-in developer kit, and a policy implementer developer kit.

74. The Website of claim 71, further comprising a requirement module configured to inform the at least one of the policy implementer planner, the policy implementer describer, the policy implementer developer, and the policy implementer certifier regarding requirements for a new policy implementer.

75. The Website of claim 71, further comprising a feedback module configured to inform the at least one of the policy implementer planner, the policy implementer describer, the policy implementer developer, and the policy implementer certifier regarding changes that are needed to an existing policy implementer.

76. A method for protection procurement, comprising:
viewing a list of policy implementers for a selected policy element; and
selecting for purchase at least one policy implementer from the list of policy implementers.

77. The method of claim 76, further comprising:
prior to viewing the list of policy implementers, viewing a list of policies;
selecting a policy from the list of policies;
viewing a list of policy elements associated with the selected policy; and
selecting the policy element from the list of policy elements.

78. The method of claim 76, further comprising distributing the at least one policy implementer automatically to initiate protection.

79. A system configured to manage a procurement process, comprising:
a procurement module configured to present a list of policy implementers to a buyer, the procurement module further configured to receive from a buyer a selection of a policy implementer from the list of policy implementers;
a distribution module coupled to the procurement module, the distribution module configured to install the selected policy implementer.

80. The system of claim 79, the distribution module configured to distribute at least one of a policy implementer component, a license information, and configuration data.

81. The system of claim 80, the distribution module configured to distribute at least one of a policy implementer component, a license information, and configuration data to a selected portion of a framework.

82. The system of claim 79, wherein the distribution is configured to customize the selected policy implementer, configure the selected policy implementer, and initiate the operation of the selected policy implementer.

83. A method for maintaining protection components, comprising:
providing an incentive program for developing a new policy implementer;
providing a rapid development process to produce the new policy implementer; and
distributing the new policy implementer to a target system.

84. The method of claim 83, further comprising communicating feedback associated with the new policy implementer to a developer.

85. The method of claim 83, further comprising communicating a list of functional requirements to a developer.

86. The method of claim 83, wherein the new policy implementer is a revision of an old policy implementer.

87. A method for managing an assurance process, comprising: for each component of a target system, automatically preparing a report of status, a level of protection, and a currency metric by policy element and by policy in response to a user request.

88. An assurance system, comprising:
a database configured to store at least one policy implementer association for each protected component of a protected system, the database further configured to store a description of each of the at least one policy implementer, the database further configured to associate each of the at least one policy implementer with a policy element; and
a report generation module coupled to the database, the report generation module configured to report a status, level of protection and currency in a format acceptable for at least one of policy management, enforcement, auditing and accreditation.

89. The assurance system of claim 88, further comprising a Website, the Website configured to provide roles-based access to the assurance system to at least one of a auditor, an accreditor, and a user executive.

90. A method for improving a policy, comprising:
providing a community-based incentive program for improving the policy;
providing a policy description system
providing a policy element description system;
providing a policy implementer requirement description system; and
providing community access to the policy description system and the policy element description system, and the policy implementer requirement description system.

91. The method of claim 90, wherein the policy is one of an asset management policy, a configuration management policy, a network management policy, a security policy, a service level policy, and a quality policy.

92. A system configured to provide policy-based protection services to a customer, comprising:
a distribution engine;
an event manager coupled to the distribution engine;
and an interface to a customer system, the interface coupled to the distribution engine and the event manager, the distribution engine configured to distribute a framework component and a policy implementer component, the interface configured to collect data from the customer system, the event manager configured to store and aggregate the collected data.

93. The system of claim 92, the system configured to analyze the collected data.

94. The system of claim 92, the system configured to identify breaches of a policy element.

95. The system of claim 92, the system configured to issue a command to a controller based on the need for an update of at least one of the framework component and the policy implementer component.

96. The system of claim 92, the system configured to issue a command to a controller to, the command indicating what type of data to collect.

97. The system of claim 92, the system configured to issue a command to a controller to, the command indicating what data to report.

98. The system of claim 92, the system configured to issue a command to a controller to, the command indicating how to analyze the collected data.

99. The system of claim 92, the system configured to issue a command to a controller to, the command indicating when to collect data.

100. The system of claim 92, the system configured to issue a command to a controller to, the command indicating how to adjust a topology of the framework.

101. A method for implementing policy-based objectives in a target system, comprising:
distributing a first policy implementer in the target system; and
later distributing a second policy implementer in the target system.

102. The method of claim 101, wherein the first policy implementer is associated with a first policy element and the second policy implementer is associated with a second policy element.

103. The method of claim 101, wherein the first policy implementer is associated with a first policy element and the second policy implementer is associated with the first policy element, the second policy implementer being an improved version of the first policy implementer, the second policy implementer based on at least one of a new requirement in the first policy element, additional policy implementer development resources, protecting component of the protection system, and target component of the target system.

104. The method of claim 103, further comprising developing the second policy implementer before the distributing of the second policy implementer, the developing including:
constraining the developing such that the second policy implementer is marginally different from the first policy implementer;
reusing the first policy implementer to develop the second policy implementer to limit at least one of development cost, cost of sales, a buyer's procurement cost, and a buyer's adoption cost; and
utilizing a disciplined development methodology; and
exploiting a billet associated with the first policy implementer to reduce distribution cost.

105. The method of claim 104, wherein the distributing the second policy implementer includes utilizing a billet associated with the first policy implementer to reduce a configuration and an administration cost.

106. A method for alerting in a protection system, comprising:
receiving data indicating a breach of policy from at least one of a first target system, a first protection system, and a third-party; and
reporting the breach of policy according to a predetermined role-based responsibility associated with at least one of the first target system, a second target system, the first protection system, and a second protection system.

107. A method for alerting in a protection system, comprising:
receiving results from one of a certification review, an audit review, and an accreditation review; and
assigning the results according to a predetermined role-based responsibility associated with at least one of the target system, the protection system, and a developer community.

108. The method of claim 107, further comprising storing the results in a library after the receiving of the results.

109. A method for policy-based certification of a system, comprising:
registering a certifier as a user on a Web site;
certifying a policy implementer to produce a certification report; and
accessing a certification submission tool from the Web site, the certification submission tool enabling the user to submit the certification report to a repository.

110. A method for providing policy-based protection, comprising:
receiving data;
categorizing the data to associate the data with one of a predetermined plurality of categories;
responding to the data based on the one of the predetermined plurality of categories, the data including at least one of event data and policy breach data; and
reporting based on the categorizing.

111. The method of claim 110, the categorizing according to at least one of policy, policy element, policy implementer, event source, event reporter, framework part, framework tier, event manager, breach type, vulnerability, organization, responsibility, timeframe, asset, asset group, response status, and criticality.
